(19) United States
(12) Patent Application Publication
(10) Pub. No.: US 2024/0385858 A1
(43) Pub. Date: Nov. 21, 2024

(54) METHODS FOR DISPLAYING MIXED REALITY CONTENT IN A THREE-DIMENSIONAL ENVIRONMENT

(71) Applicant: Apple Inc., Cupertino, CA (US)

(72) Inventors: Christopher D. MCKENZIE, Burlingame, CA (US); Benjamin HYLAK, San Francisco, CA (US); Karen EL ASMAR, San Francisco, CA (US); Nathan GITTER, Cupertino, CA (US); Wesley M. HOLDER, Union City, CA (US); Zoey C. TAYLOR, San Francisco, CA (US)

(21) Appl. No.: 18/668,036

(22) Filed: May 17, 2024

Related U.S. Application Data
(60) Provisional application No. 63/506,081, filed on Jun. 3, 2023.
(60) Provisional application No. 63/502,816, filed on May 17, 2023.

(51) Int. Cl. G06F 9/451; G06F 3/0482; G06T 19/00

(52) U.S. Cl. CPC G06F 9/451; G06F 3/0482; G06T 19/006

(57) ABSTRACT

In some embodiments, a computer system changing a visual appearance of immersive mixed reality (MR) content in a three-dimensional environment in accordance with a respective type of input in accordance with some embodiments of the disclosure. In some embodiments, a computer system facilitates display of immersive MR content in a three-dimensional environment. In some embodiments, a computer system displays content of a respective application in a first mode of operation that includes spatially distributing the content throughout an available display area of a three-dimensional environment and displays an option to cease display of the content in the first mode of operation in accordance with some embodiments of the disclosure.

### CROSS REFERENCE TO RELATED APPLICATIONS

This application claims the benefit of U.S. Provisional Application No. 63/506,081, filed Jun. 3, 2023, and U.S. Provisional Application No. 63/502,816, filed May 17, 2023, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system changes a visual appearance of immersive mixed reality (MR) content in a three-dimensional environment in accordance with a respective type of input in accordance with some embodiments of the disclosure. In some embodiments, a computer system facilitates display of immersive MR content in a three-dimensional environment. In some embodiments, a computer system displays content of a respective application in a first mode of operation that includes spatially distributing the content throughout an available display area of a three-dimensional environment and displays an option to cease display of the content in the first mode of operation in accordance with some embodiments of the disclosure.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the FIGS.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7L illustrate examples of a computer system changing a visual appearance of immersive mixed reality (MR) content in a three-dimensional environment in accordance with a respective type of input in accordance with some embodiments.

FIGS. 8A-8G is a flowchart illustrating a method for changing a visual appearance of immersive mixed reality (MR) content in a three-dimensional environment in accordance with a respective type of input in accordance with some embodiments.

FIGS. 9A-9I illustrate examples of a computer system facilitating display of immersive mixed reality (MR) content in a three-dimensional environment in accordance with some embodiments

FIGS. 10A-10J is a flowchart illustrating a method of facilitating display of immersive mixed reality (MR) content in a three-dimensional environment in accordance with some embodiments.

FIGS. 11A-11G illustrate examples of a computer system displaying content of a respective application in a first mode of operation that includes spatially distributing content throughout an available display area of a three-dimensional environment and ceasing display of the content in the first mode of operation in accordance with some embodiments.

FIGS. 12A-12E is a flowchart illustrating a method for displaying content of a respective application in a first mode of operation that includes spatially distributing content throughout an available display area of a three-dimensional environment and ceasing display of the content in the first mode of operation in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays content from a first application presented in accordance with a first mode of operation in a three-dimensional environment, where the first mode of operation is a mode in which the first application is permitted to display content that is spatially distributed throughout an available display area of the three-dimensional environment. In some embodiments, while displaying the content from the first application presented in accordance with the first mode of operation, the computer system detects a first user input of a first type. In some embodiments, in response to detecting the first user input of the first type, the computer system changes a visual appearance of the content from the first application in a first manner. In some embodiments, after changing the visual appearance of the content from the first application in the first manner, the computer system displays content from a second application presented in accordance with the first mode of operation in the three-dimensional environment, where the first mode of operation is a mode in which the second application is permitted to display content that is spatially distributed throughout the available display area of the three-dimensional environment. In some embodiments, while displaying the content from the second application presented in accordance with the first mode of operation, the computer system detects a second user input of the first type. In some embodiments, in response to detecting the second user input of the first type, the computer system changes a visual appearance of the content from the second application in the first manner.

In some embodiments, a computer system displays a three-dimensional environment that includes application content associated with different applications running on the electronic device that are displayed in a first mode of operation. In some embodiments, content that is displayed in the first mode of operation is restricted to being displayed in one or more application containers that are spatial distributed throughout the three-dimensional environment based on prior user inputs directed to the application containers independently of interaction with the corresponding containers. In some embodiments, in response to detecting a first input corresponding to a request to display additional content for a respective application, if the request is to display the additional content in a second mode of operation, different form the first mode of operation, the computer system displays the application content for the respective application in the second mode of operation in the three-dimensional environment and ceases display of the plurality of application containers including the application content from the different applications. In some embodiments, if the request is to display the additional application content in the first mode of operation, the computer system displays a respective object associated with the respective application in the three-dimensional environment concurrently with the plurality of application containers in the first mode of operation.

In some embodiments, a computer system displays content of a first application in a three-dimensional environment. In some embodiments, while displaying the content of the first application in the three-dimensional environment, the computer system detects a first input corresponding to a request to display a system user interface for controlling one or more functionalities of the computer system. In some embodiments, in response to detecting the first input, the computer system displays the system user interface in the three-dimensional environment. In some embodiments, in accordance with a determination that the first application is configured to display content in a first mode of operation, wherein the first mode of operation is a mode in which the first application is permitted to display content that is spatially distributed through an available display area of the three-dimensional environment, the computer system displays, in the system user interface, a first selectable option that is selectable to cease display of the content of the first application in the first mode of operation. In some embodiments, while displaying the system user interface that includes the first selectable option, the computer system detects, via the one or more input devices, a second input corresponding to selection of the first selectable option. In some embodiments, in response to detecting the second input, the computer system ceases to display the content in the first mode of operation.

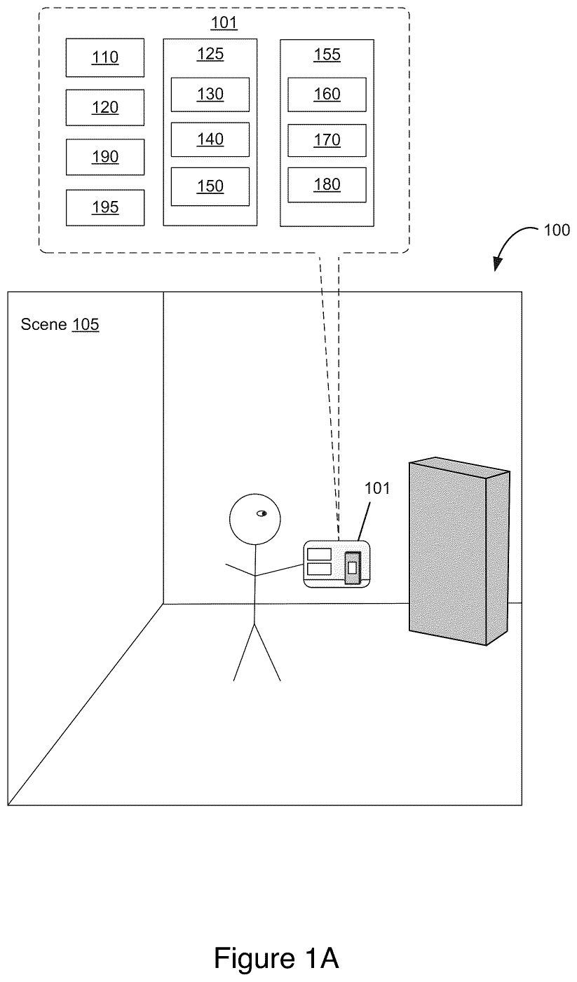

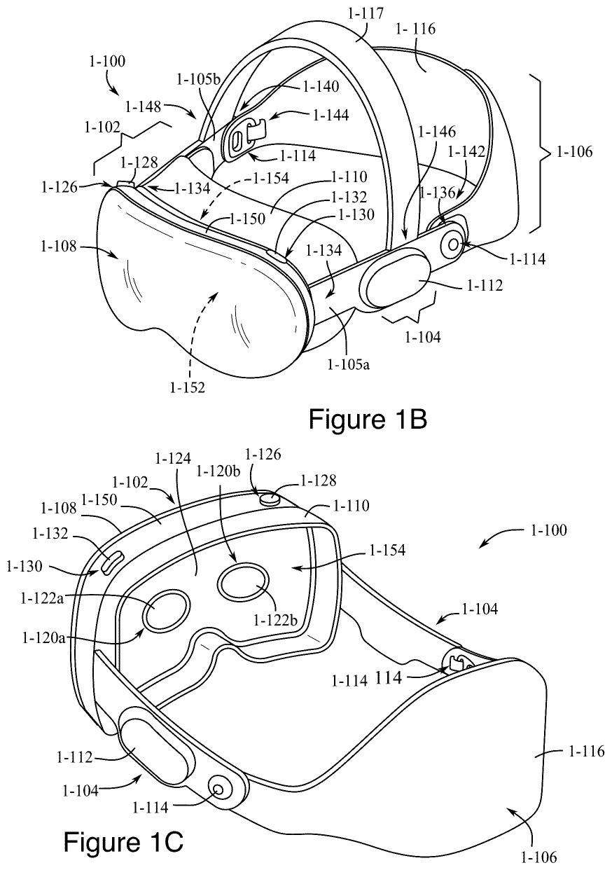

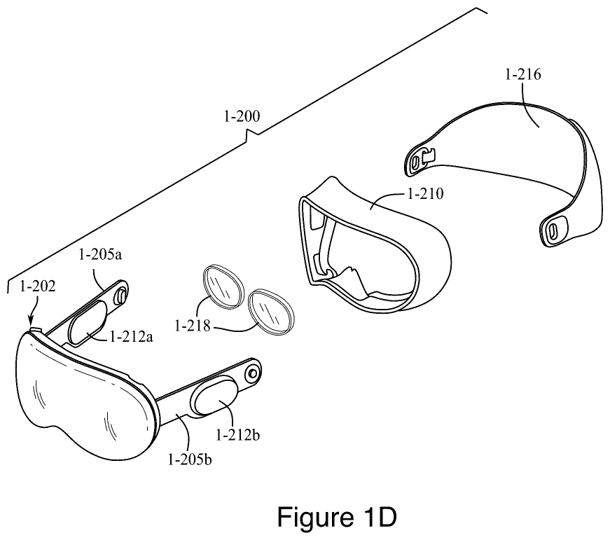

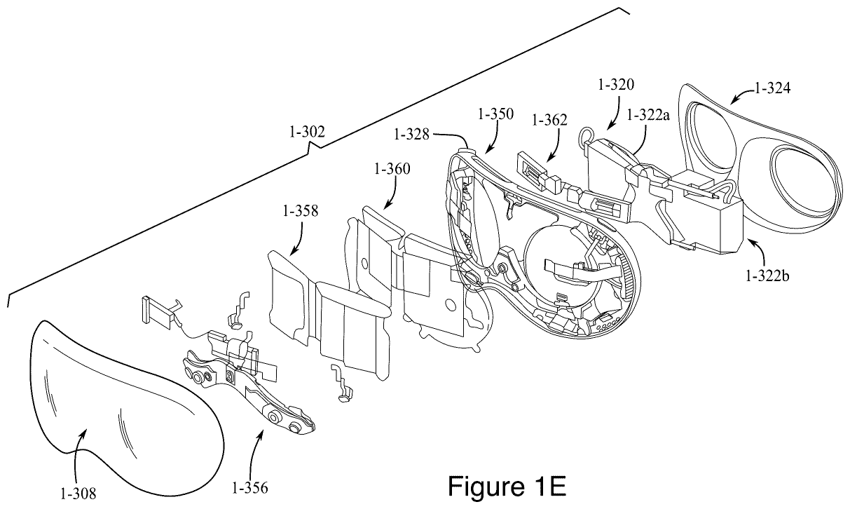

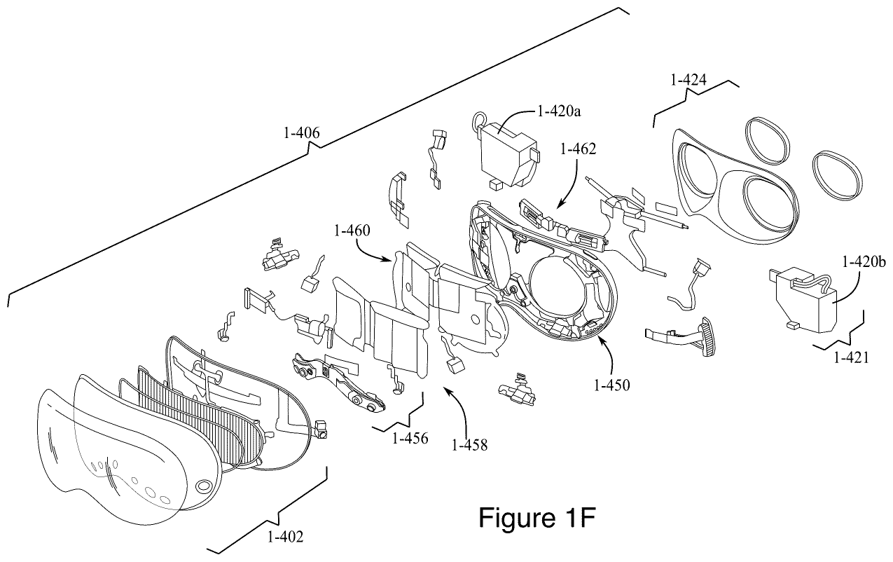

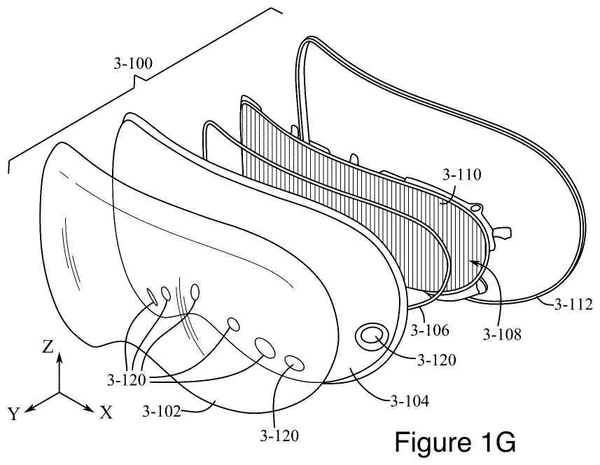

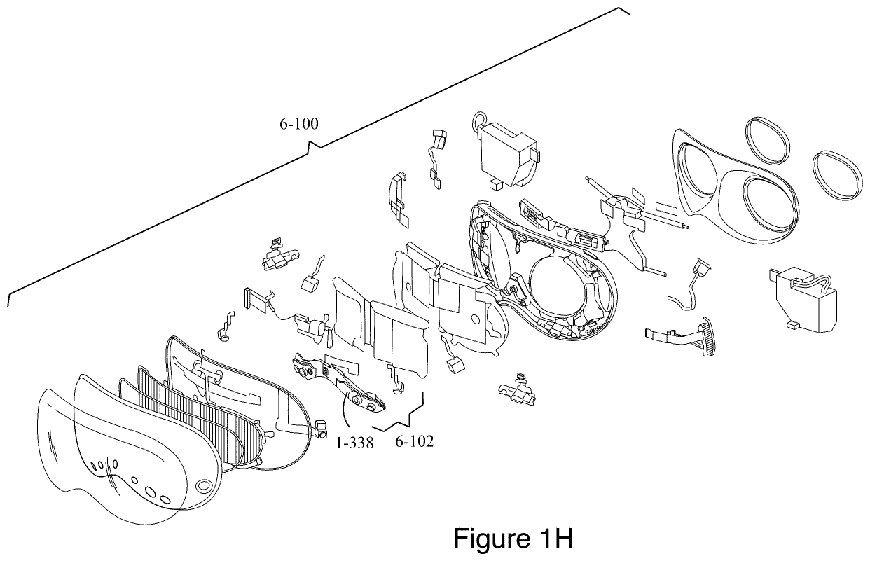

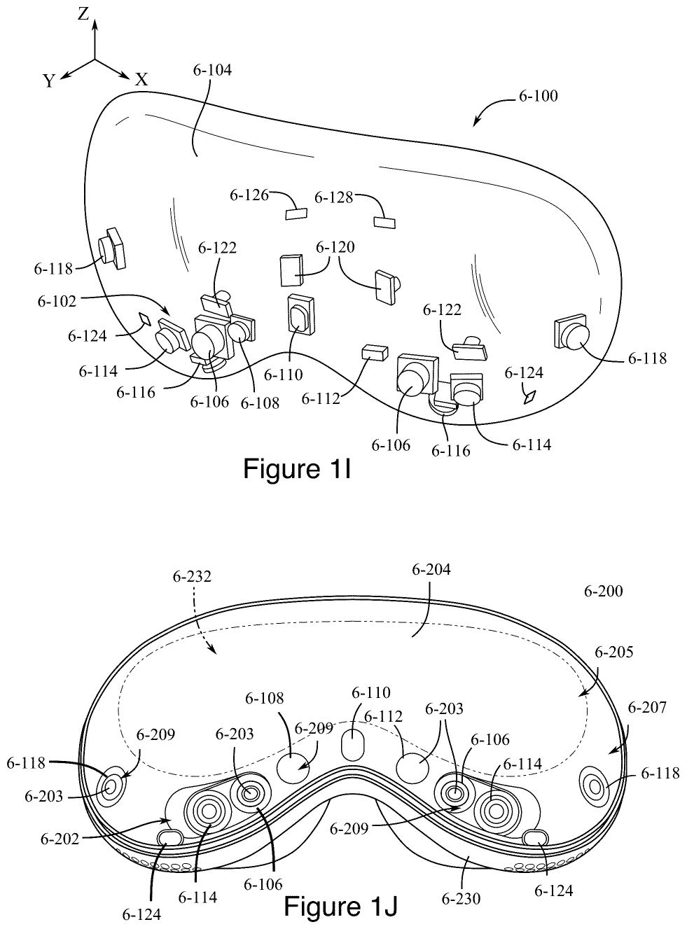

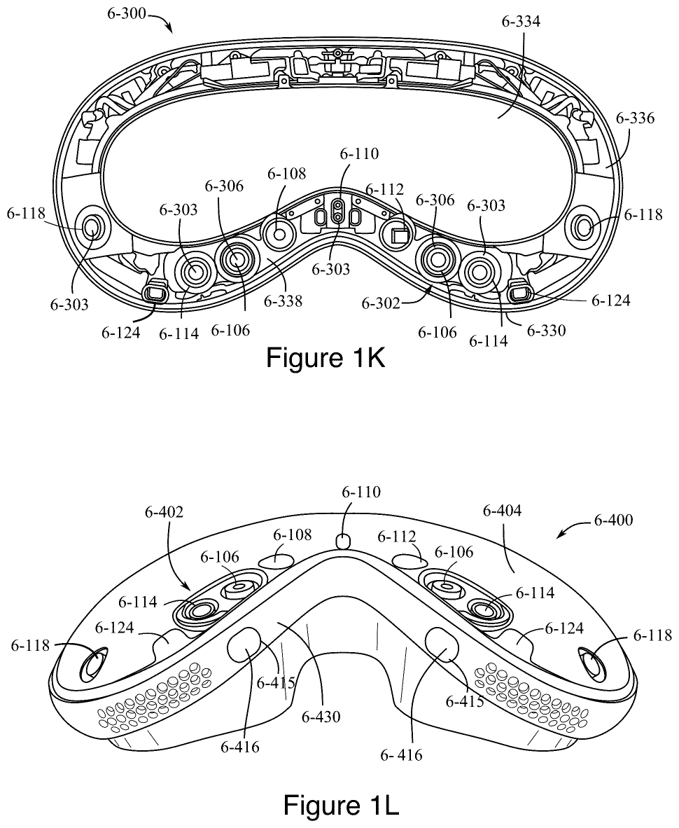

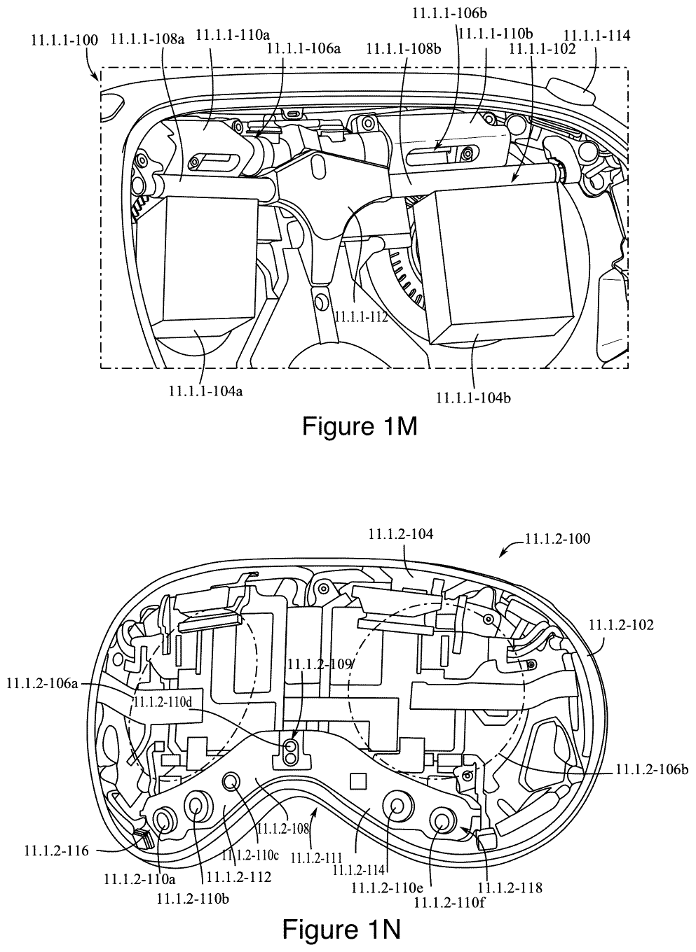

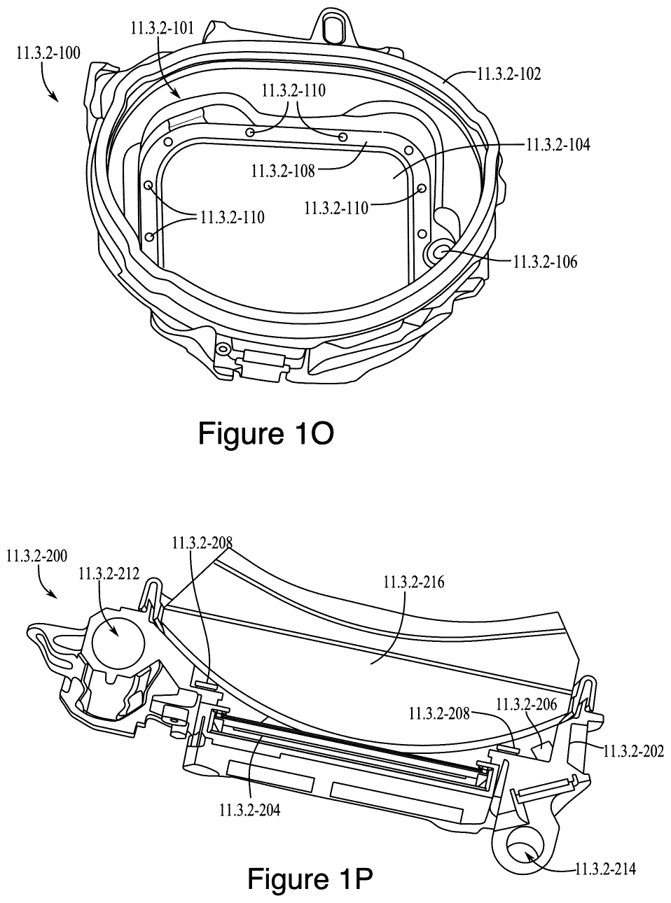

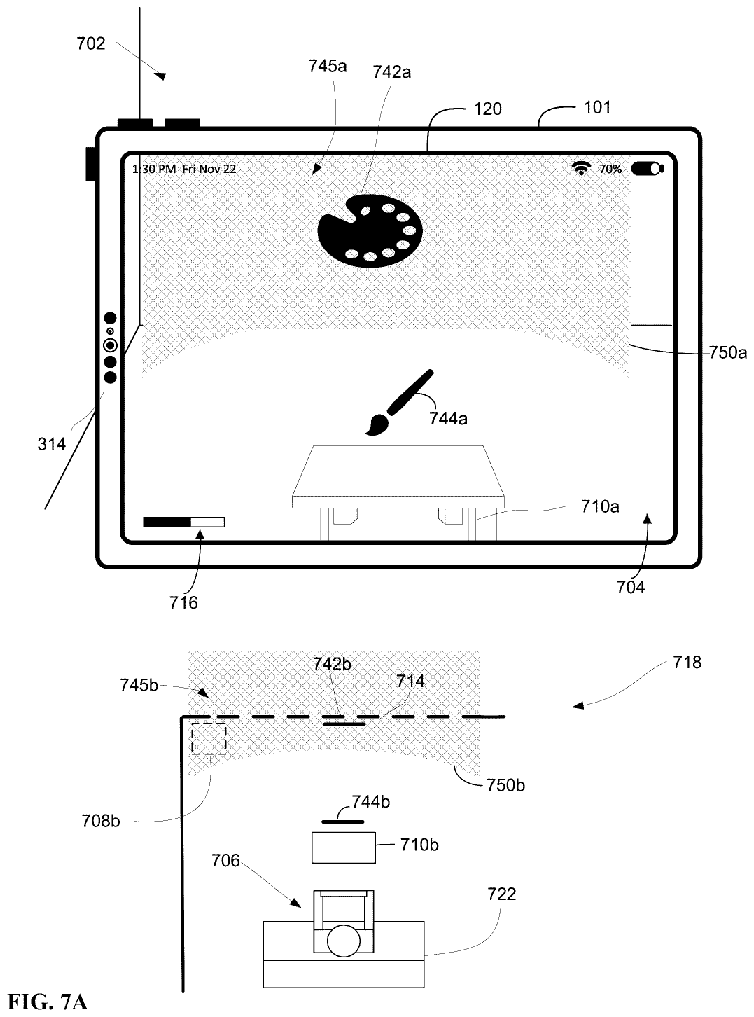

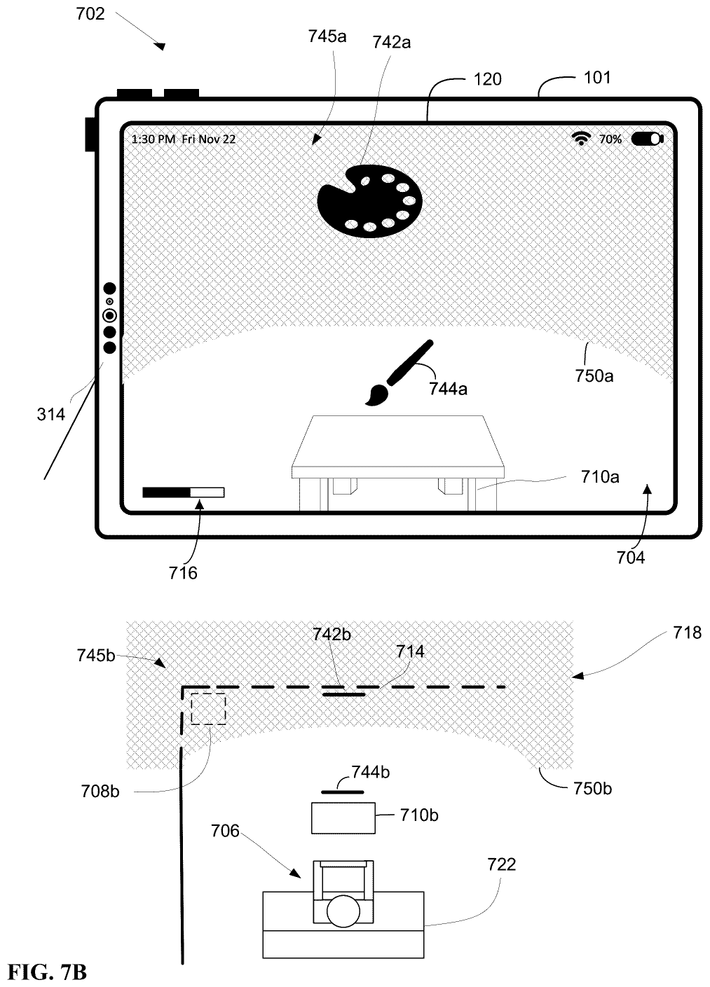

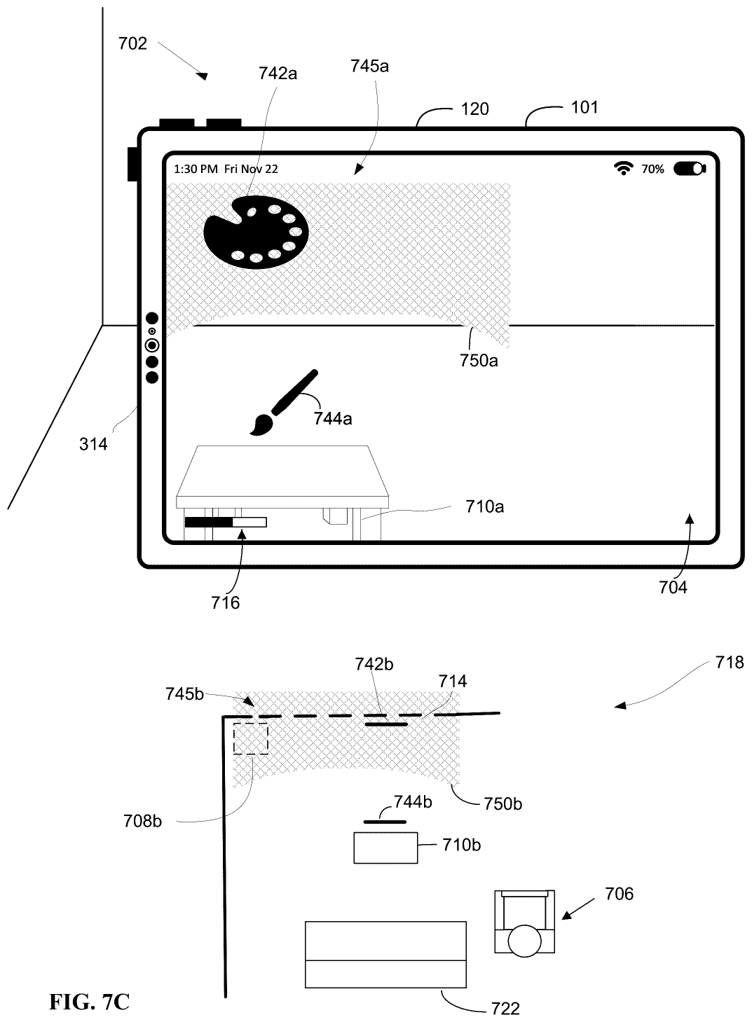

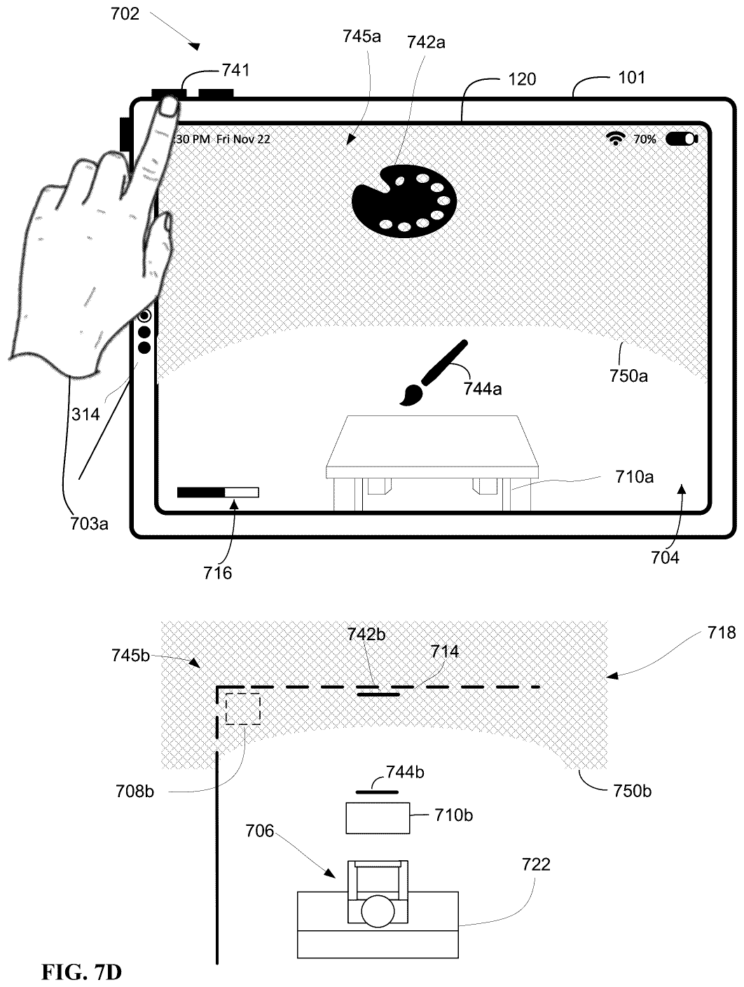

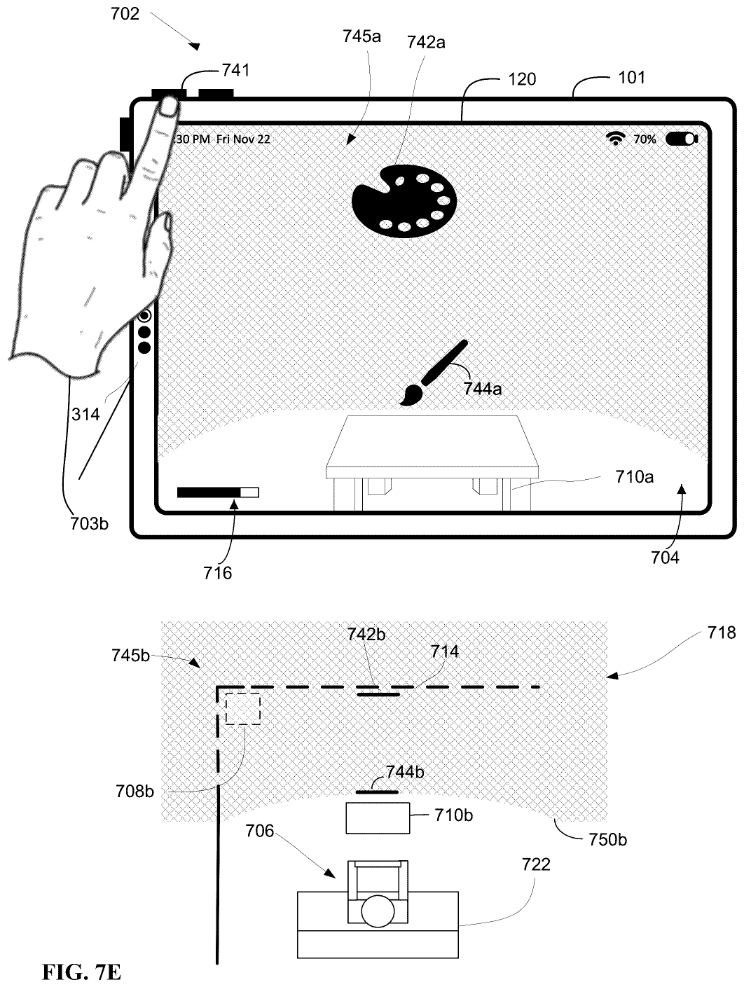

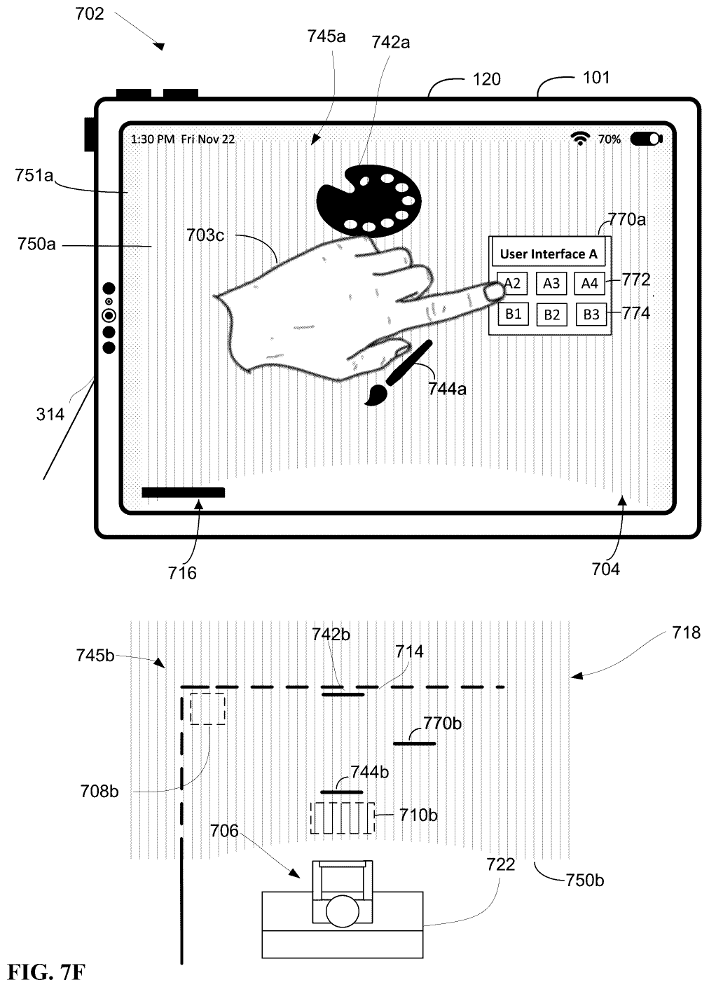

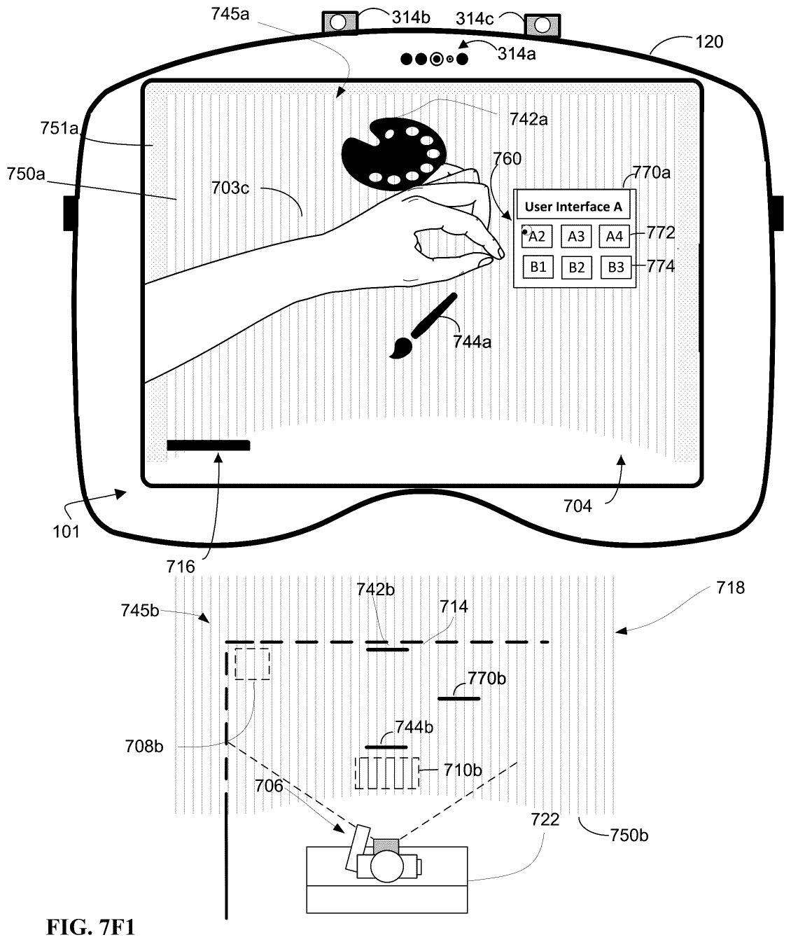

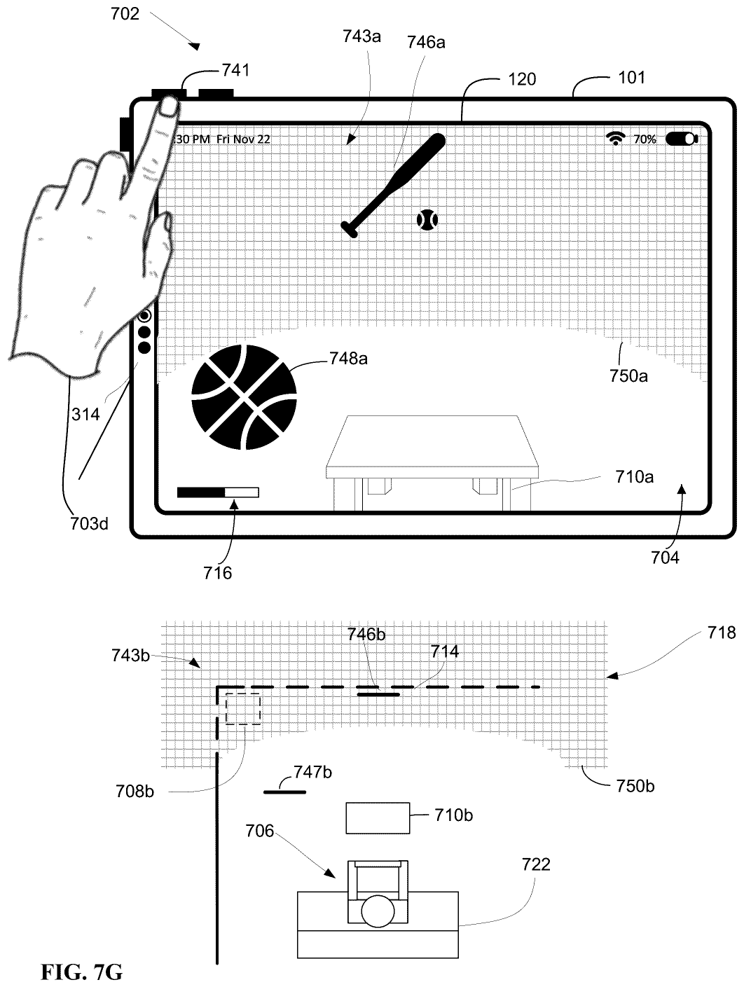

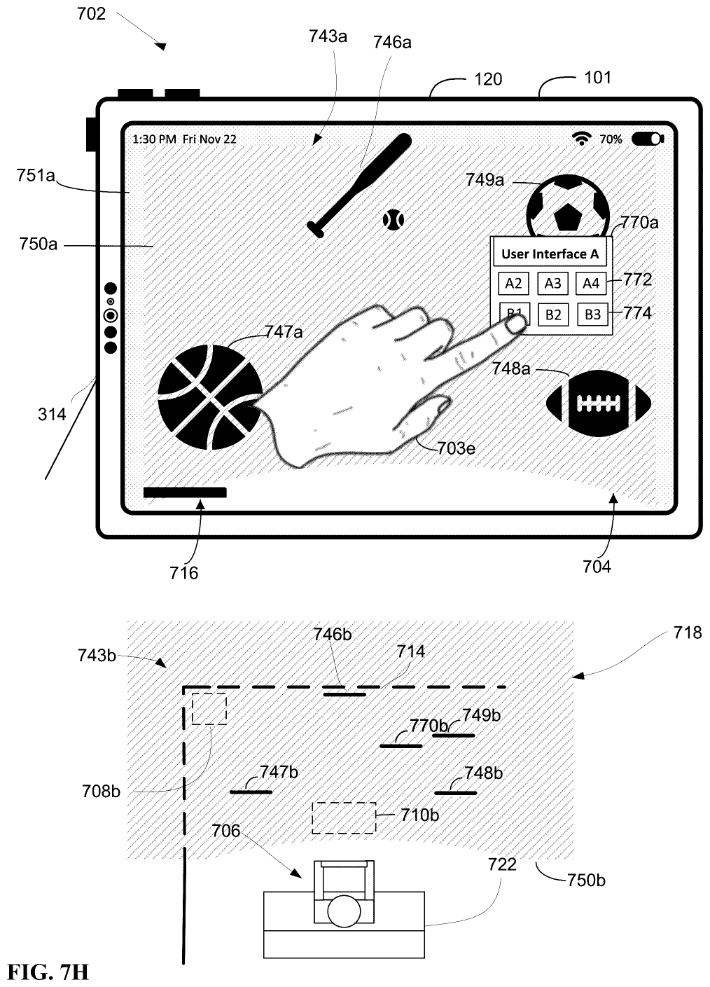

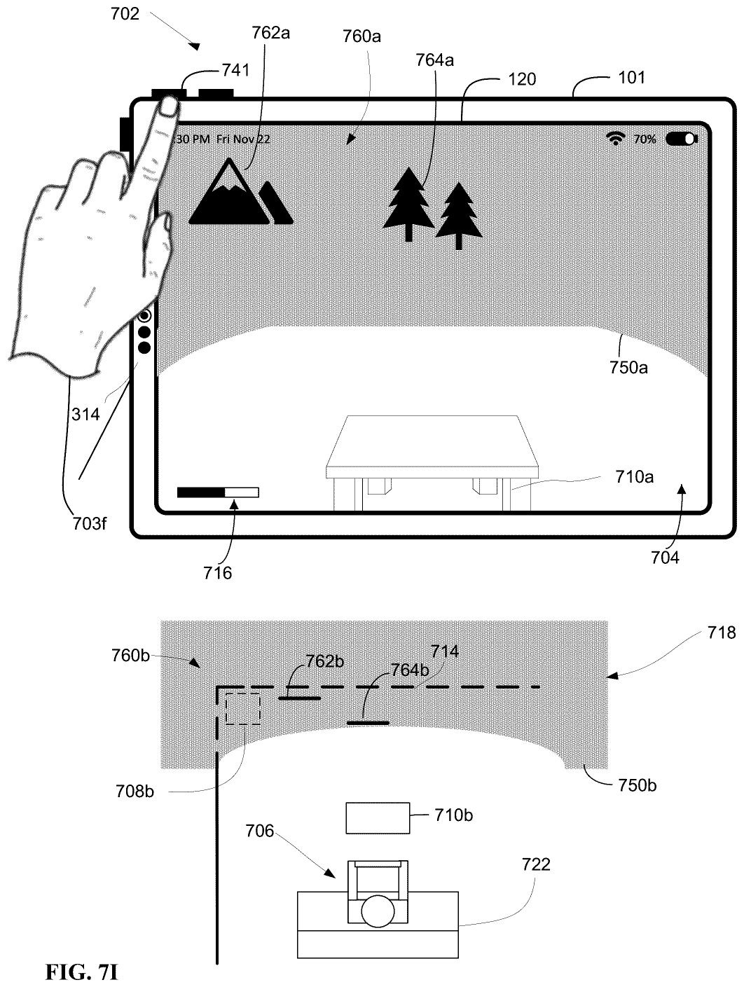

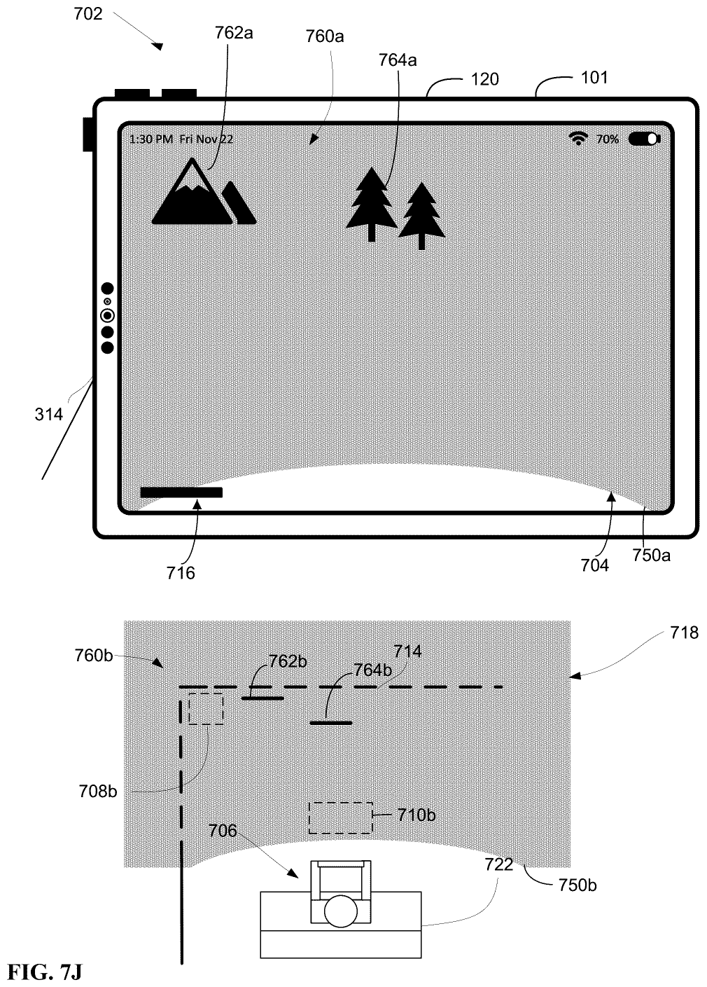

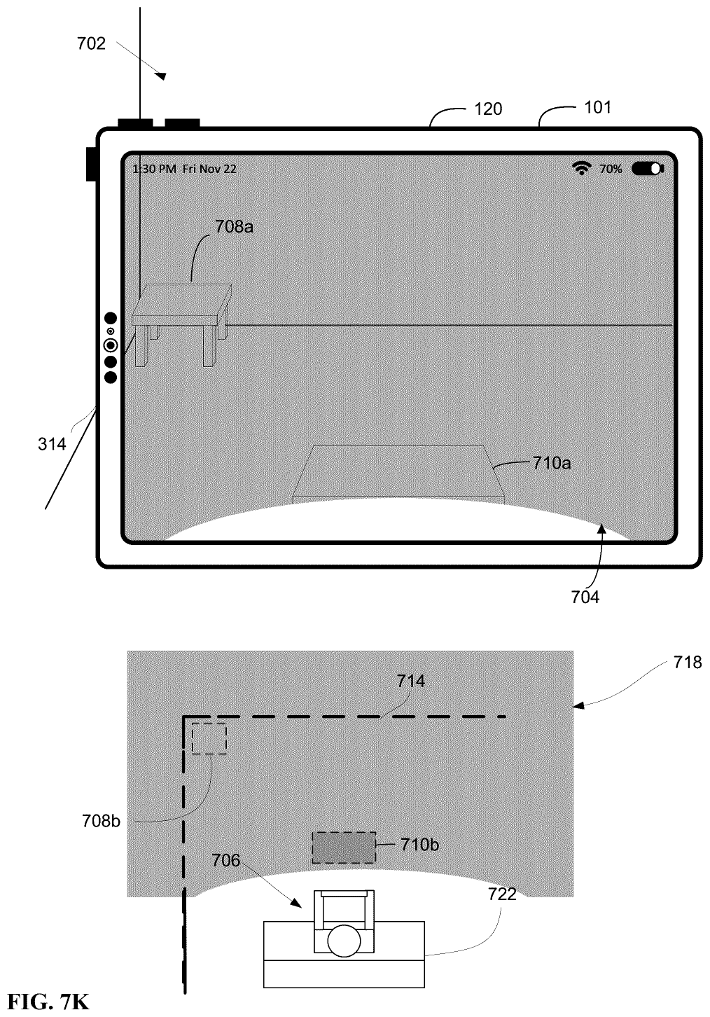

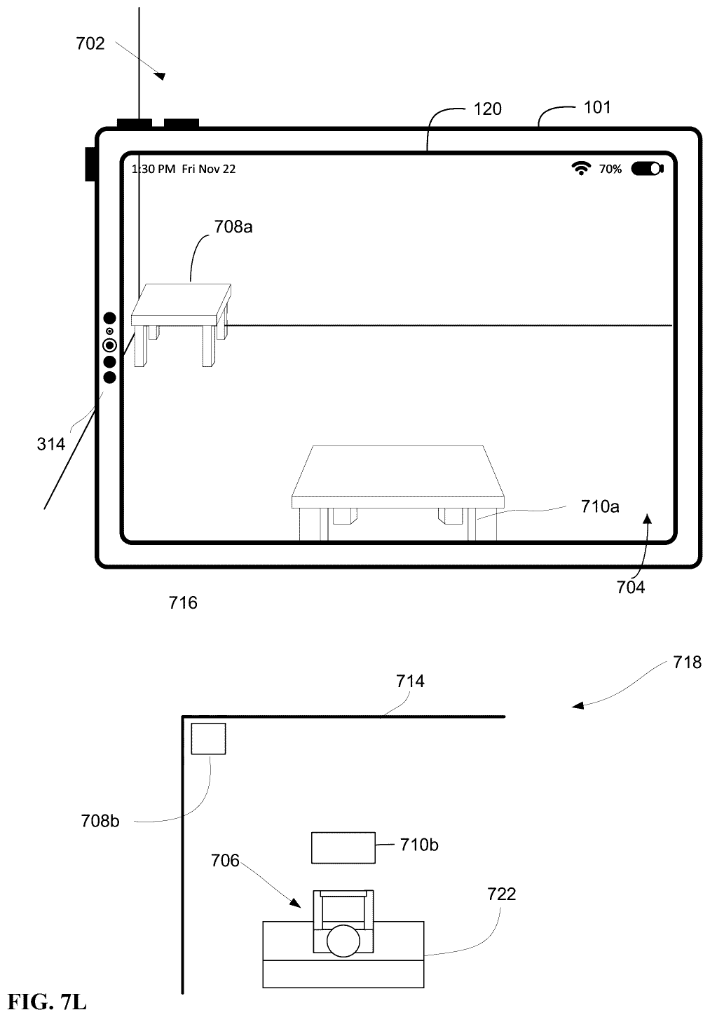

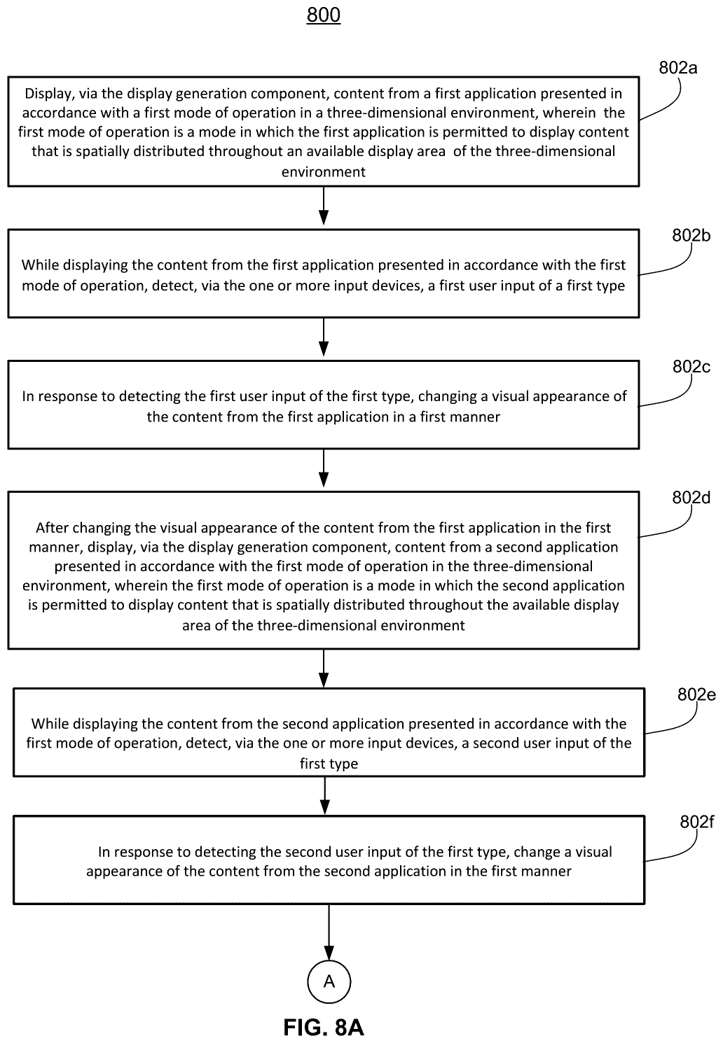

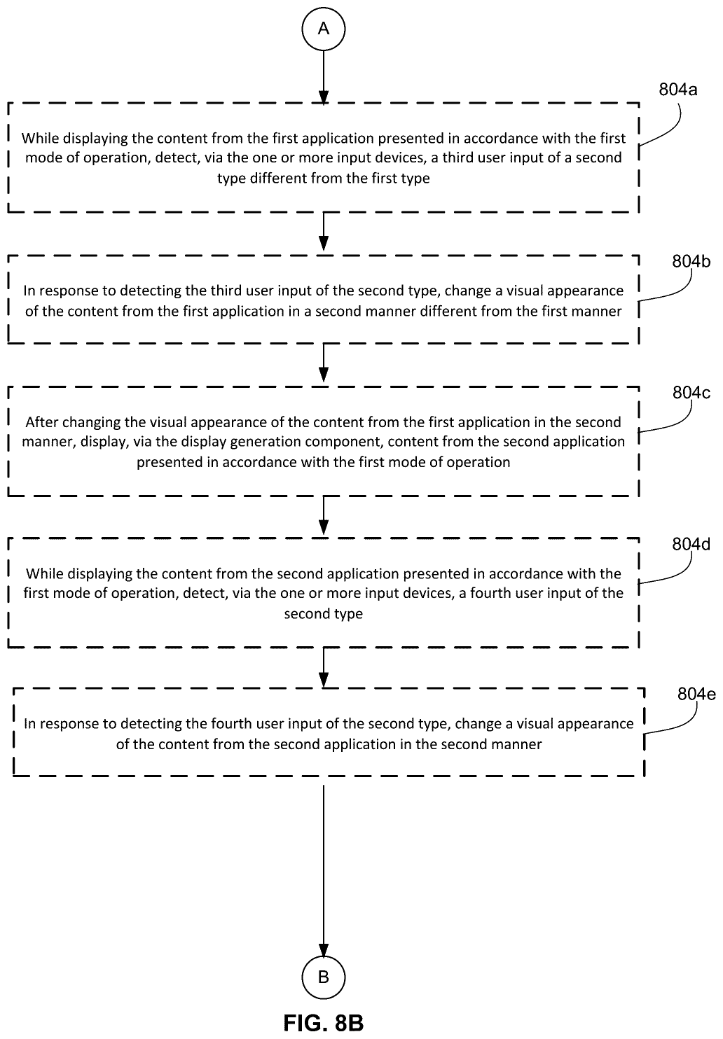

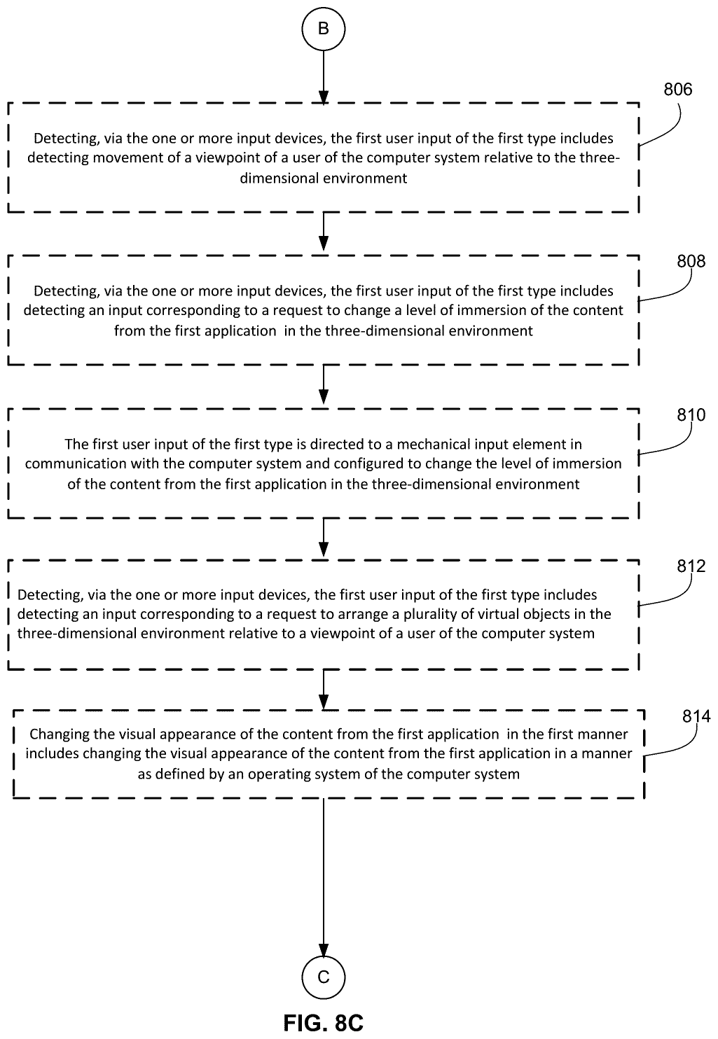

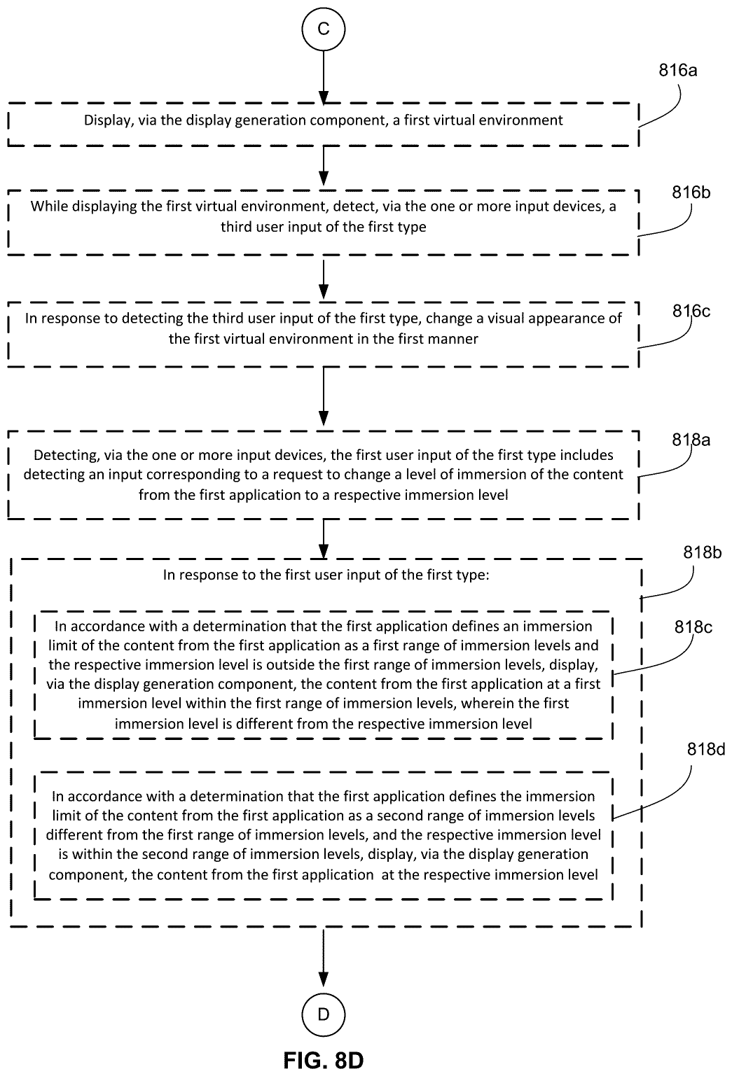

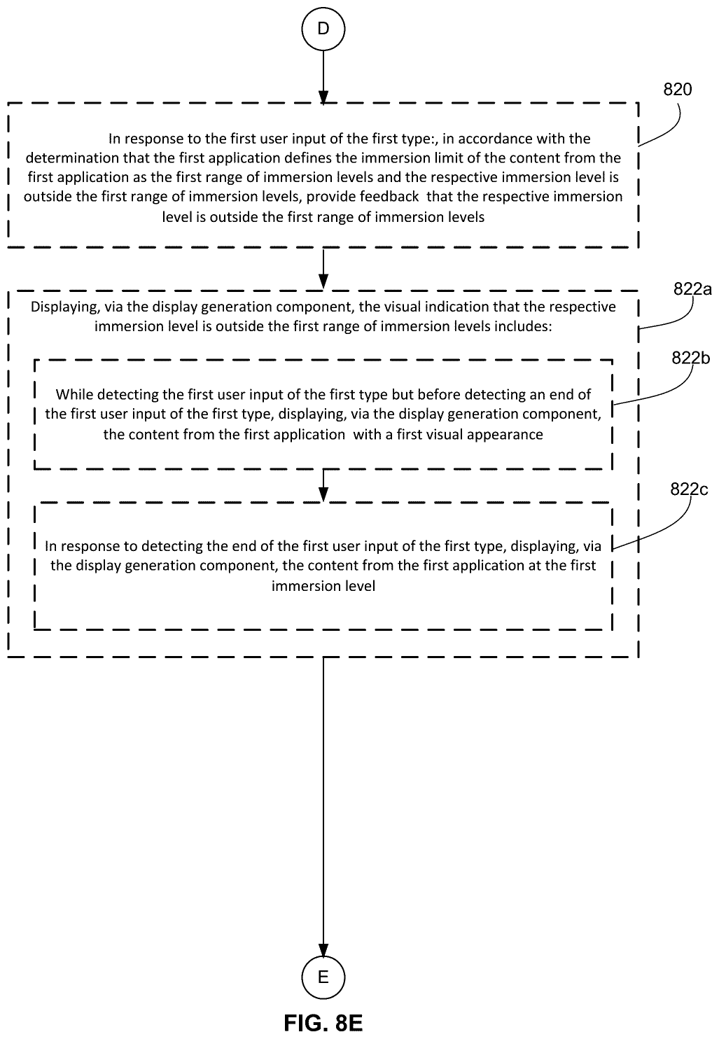

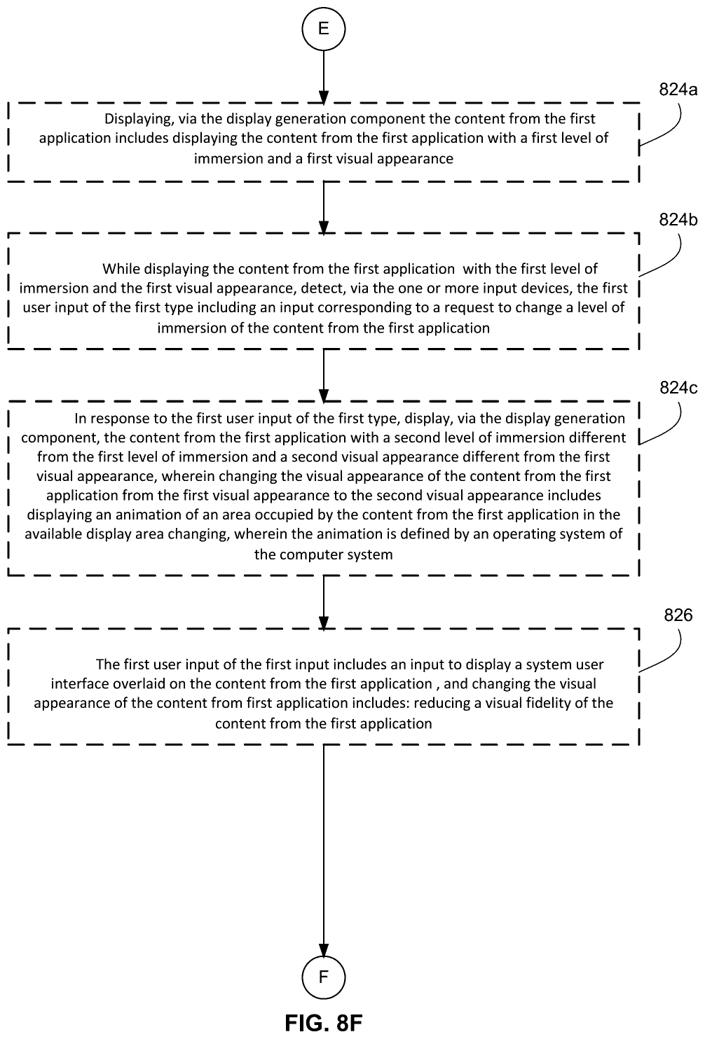

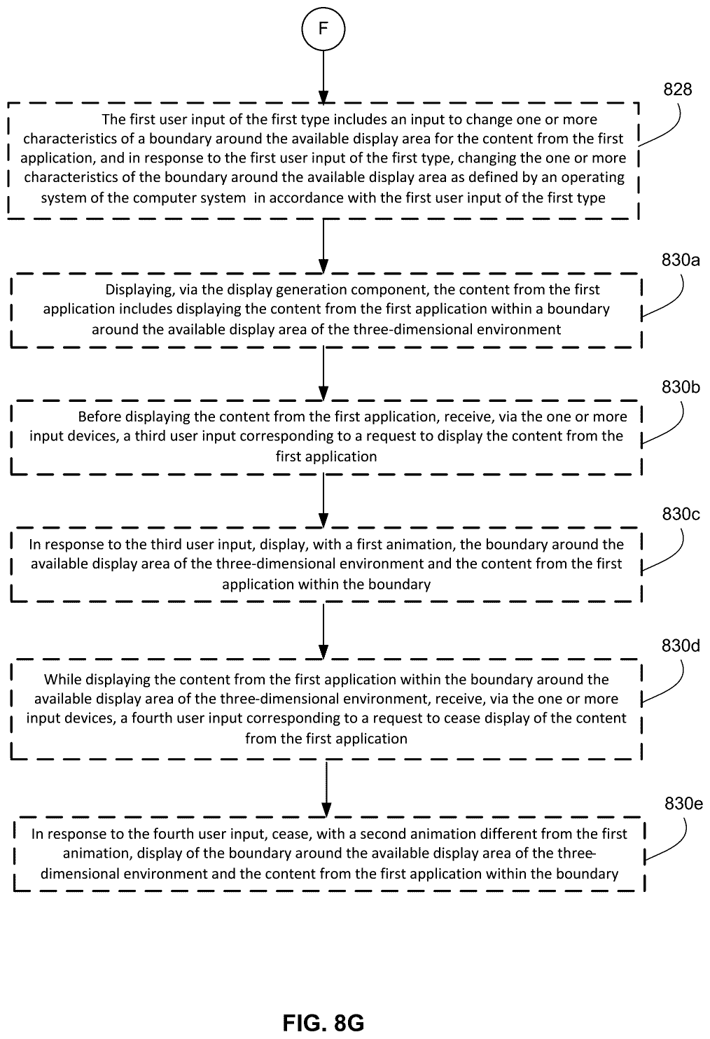

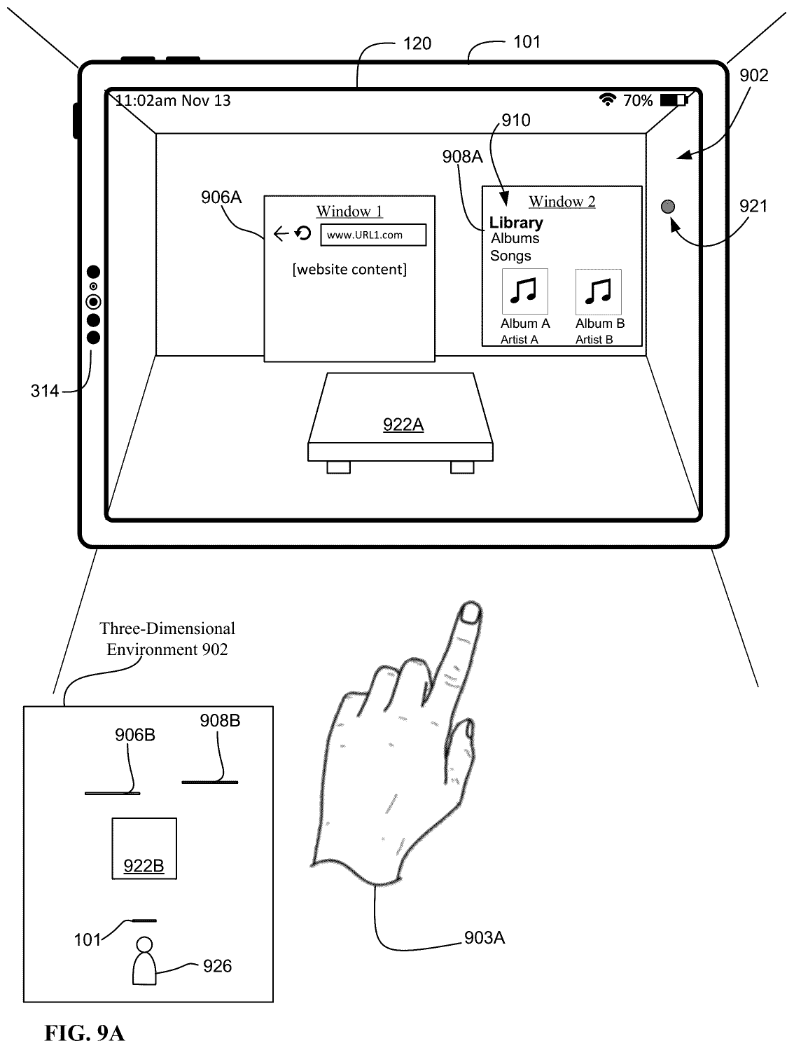

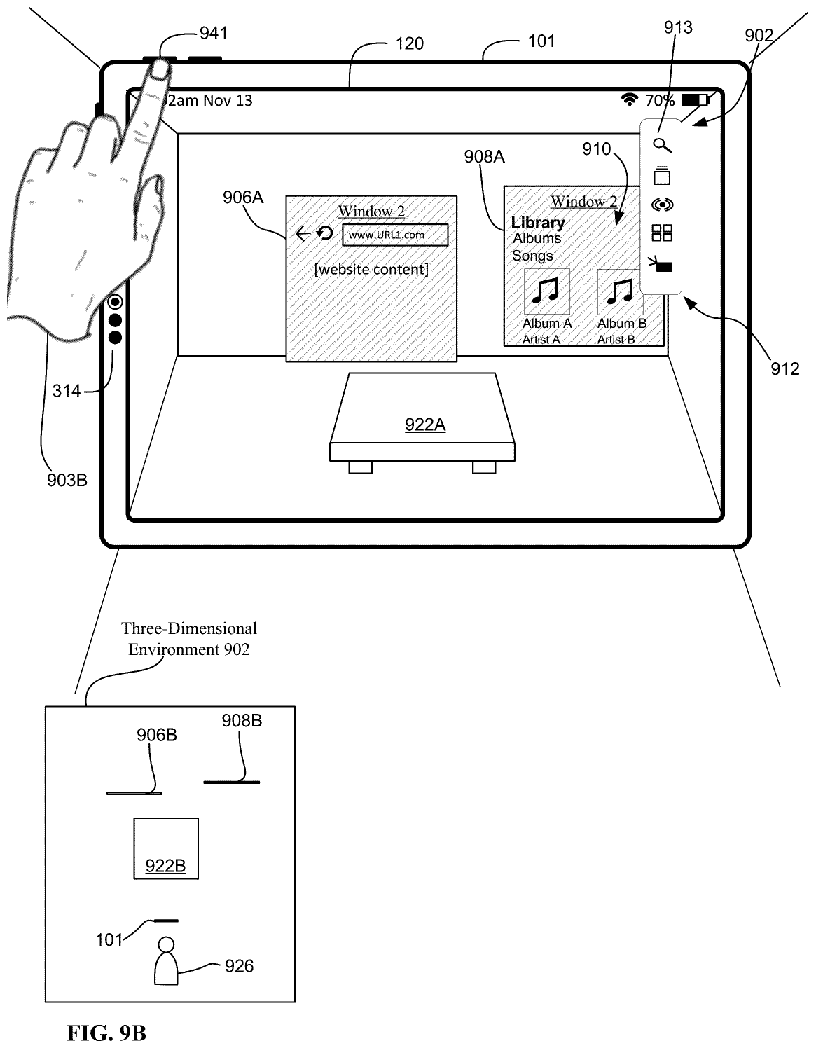

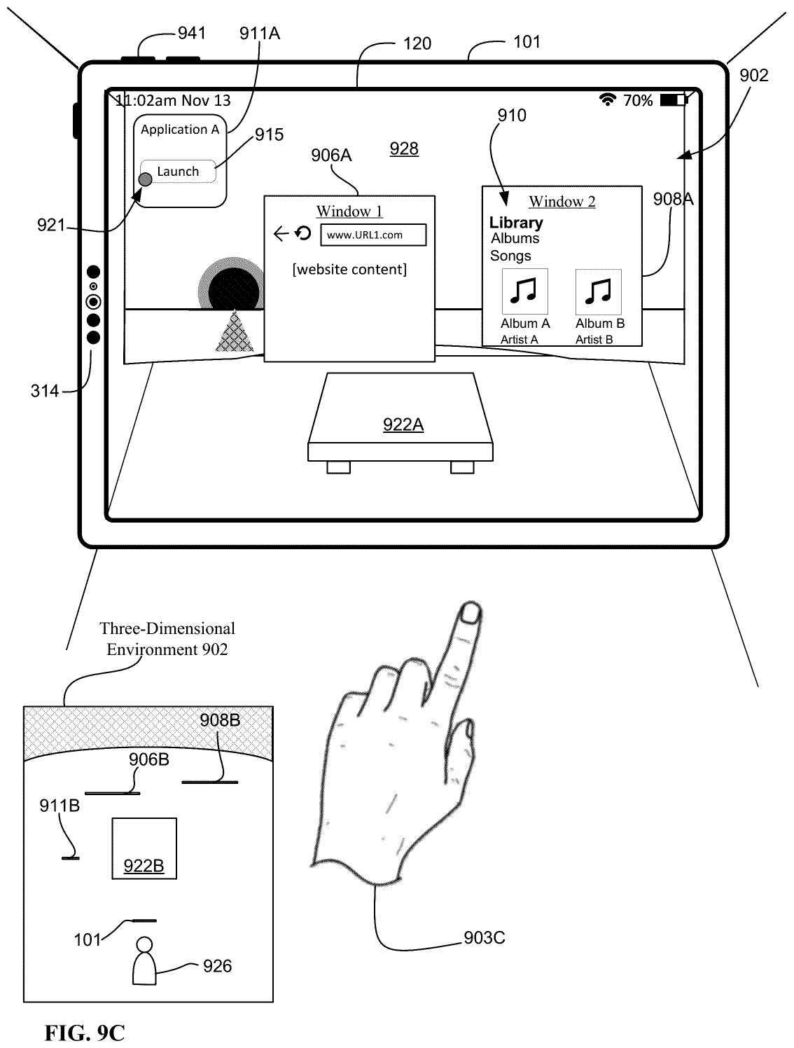

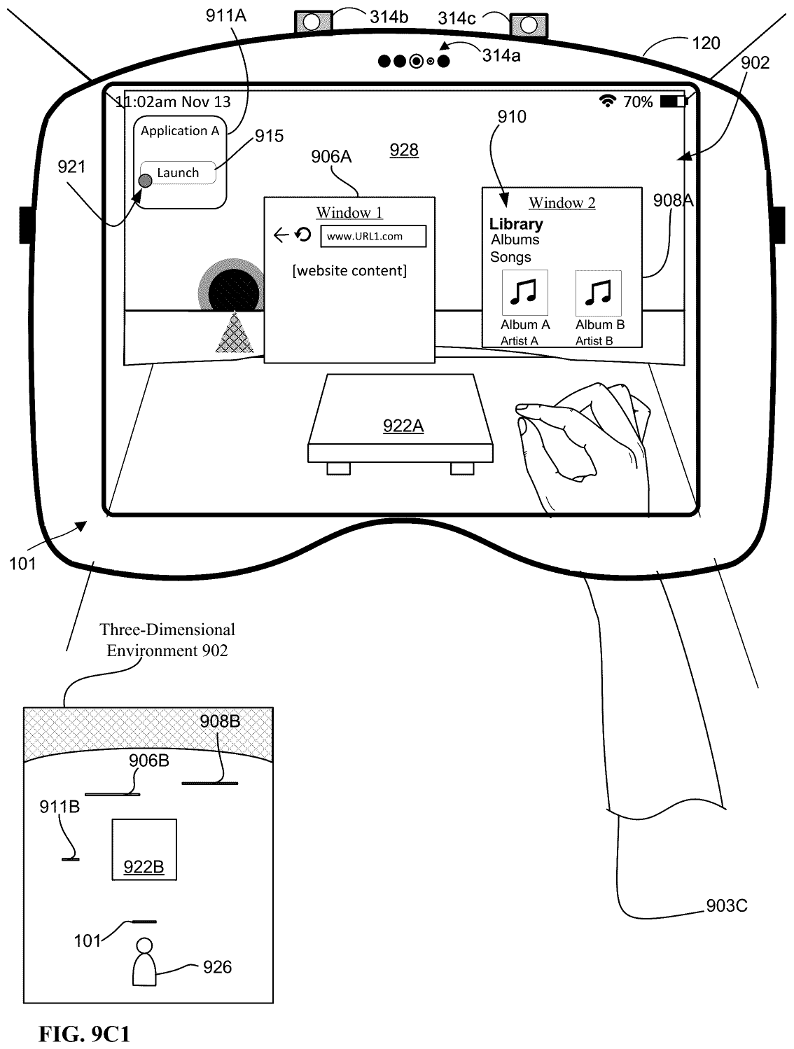

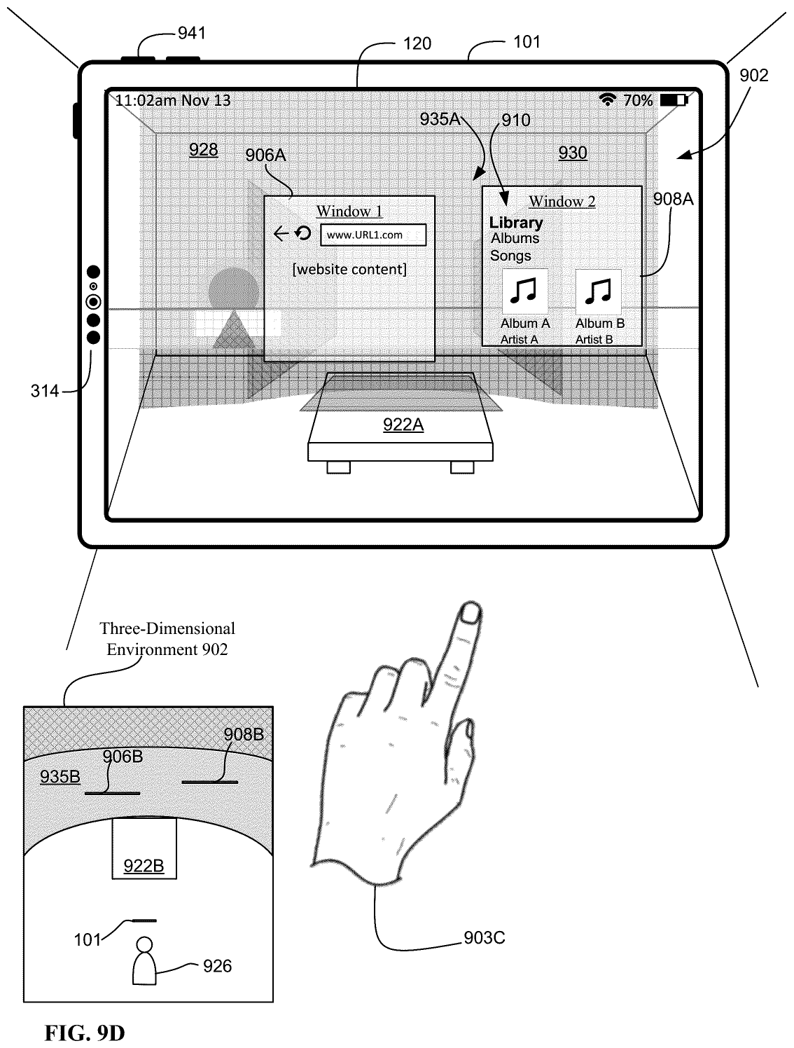

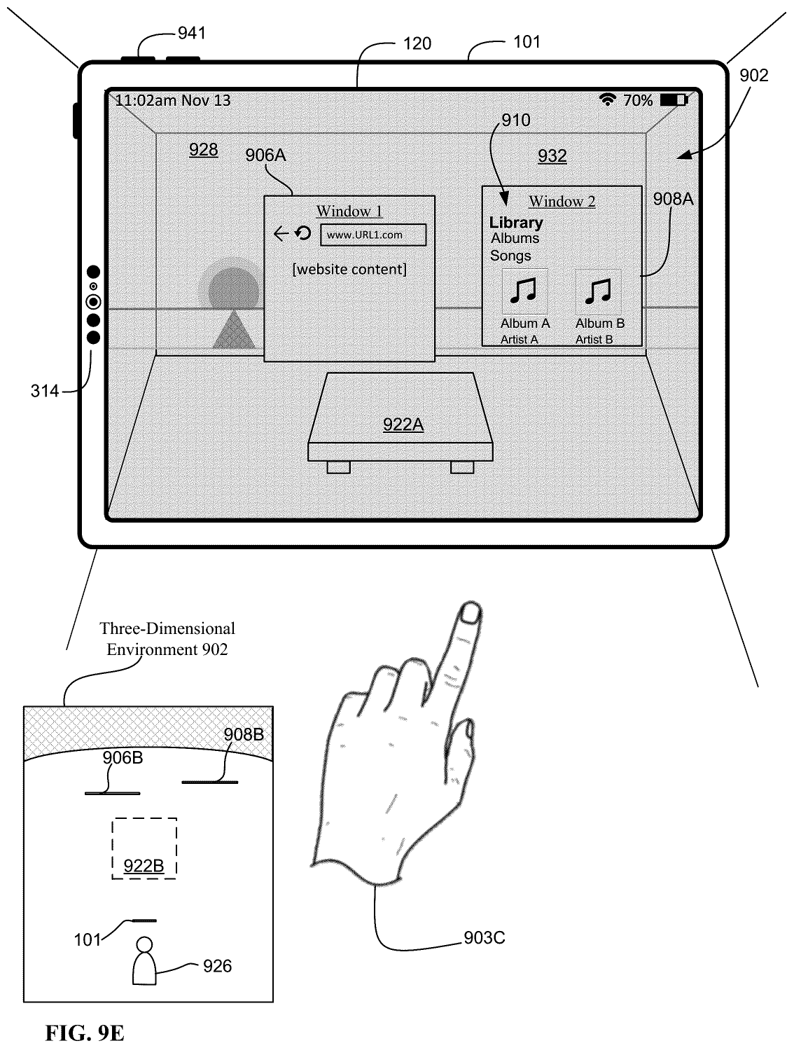

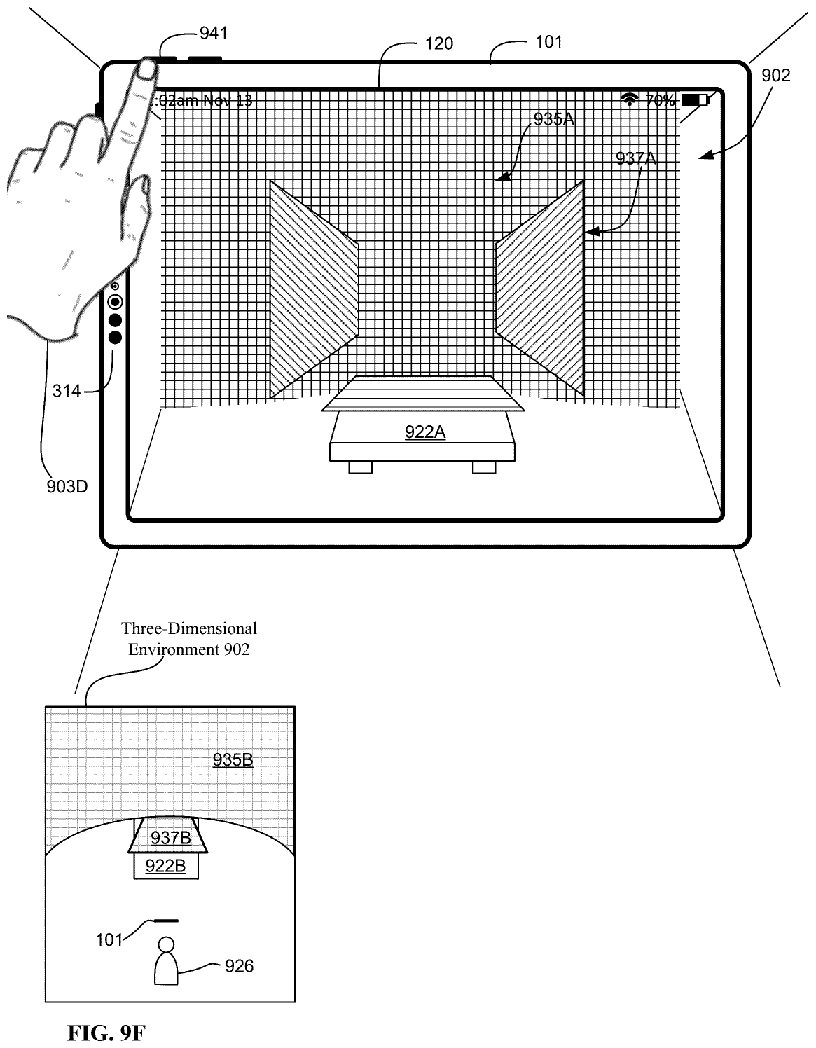

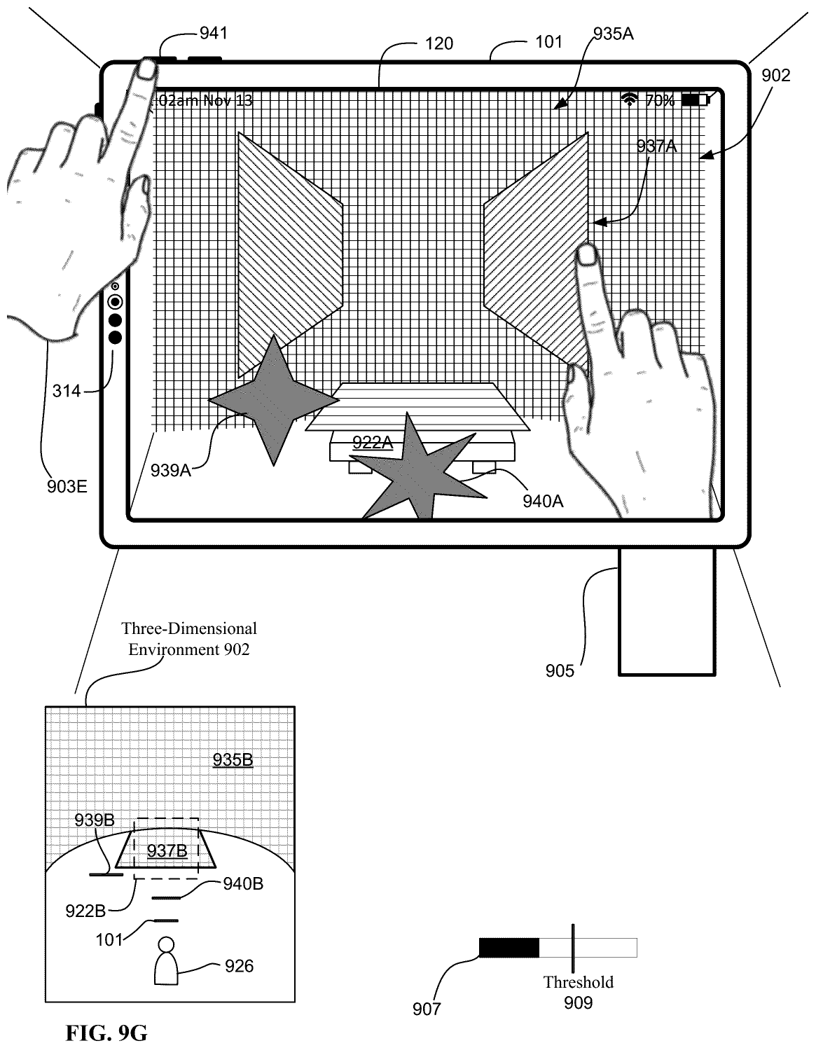

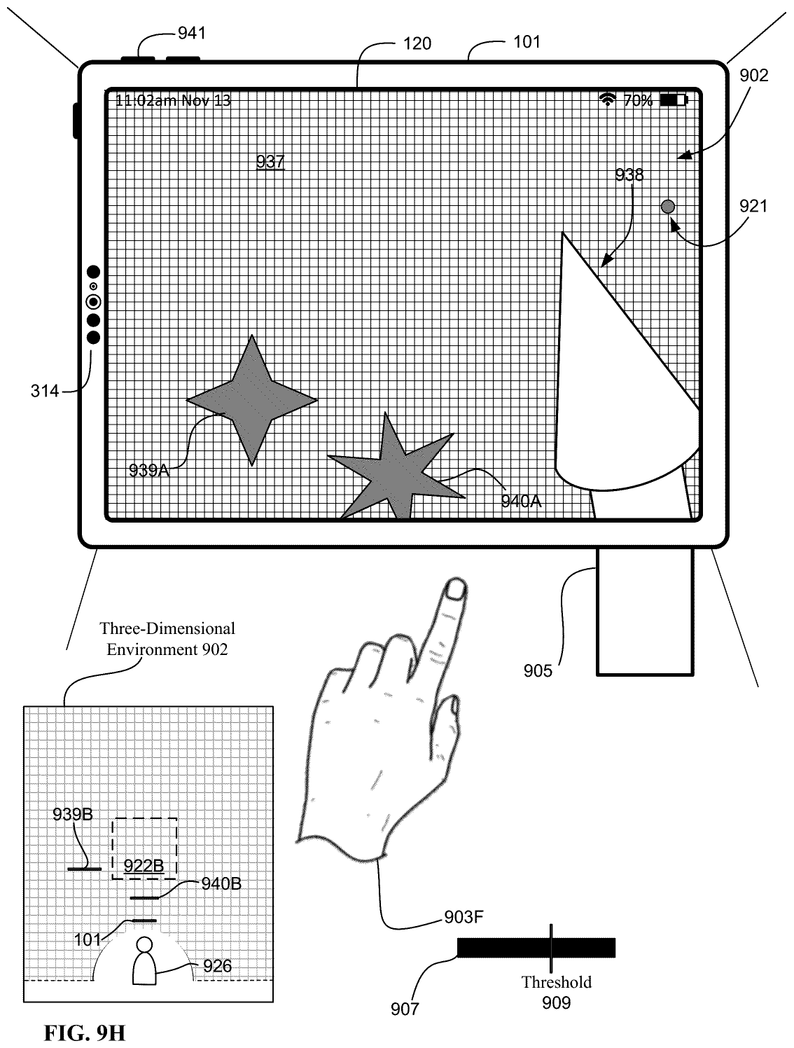

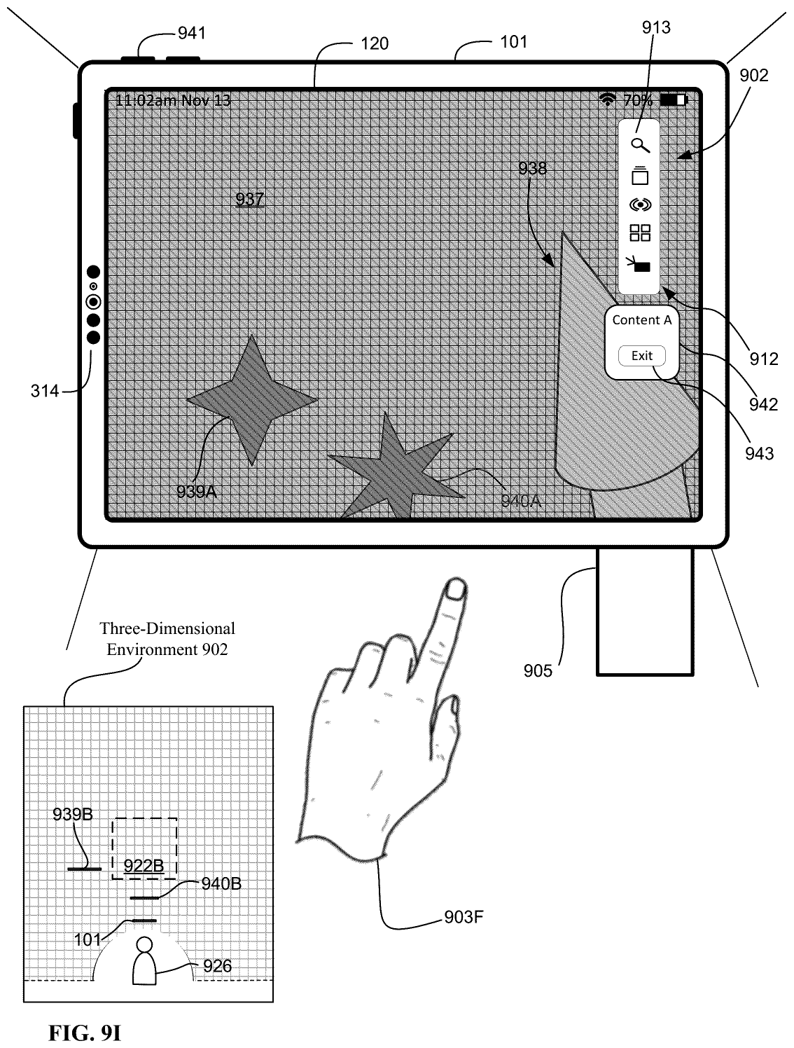

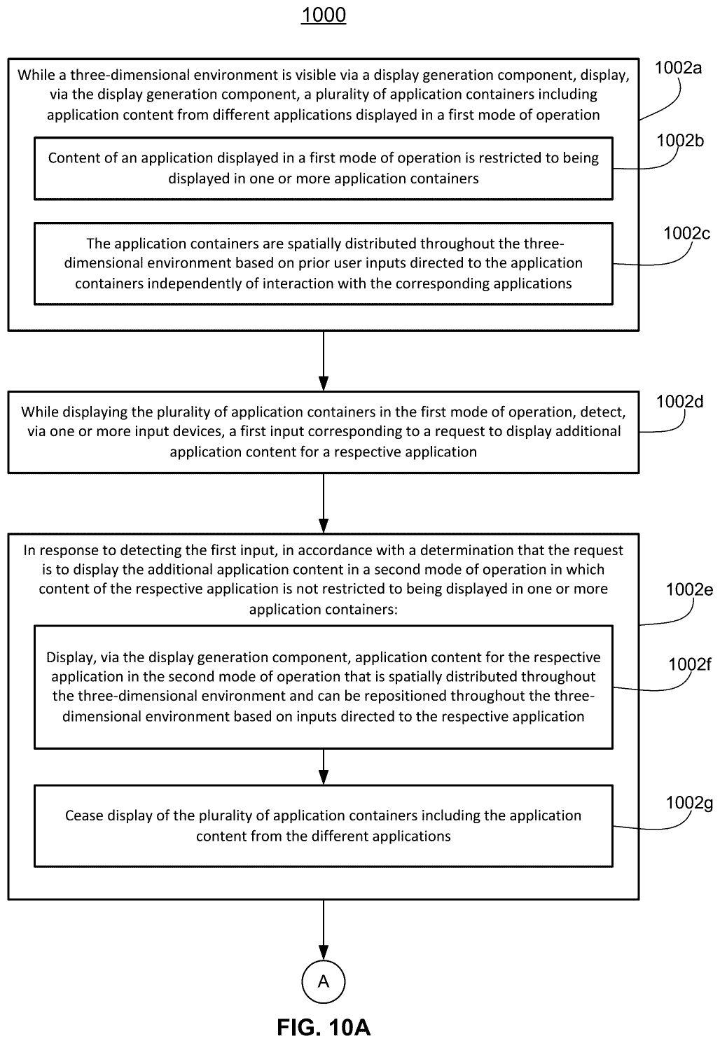

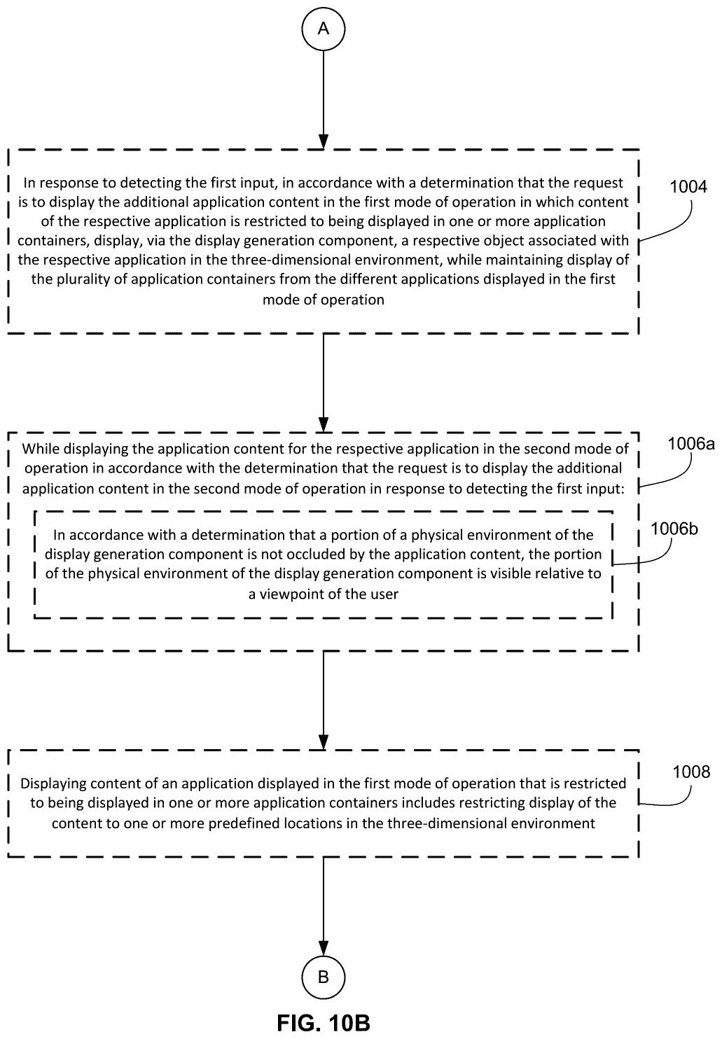

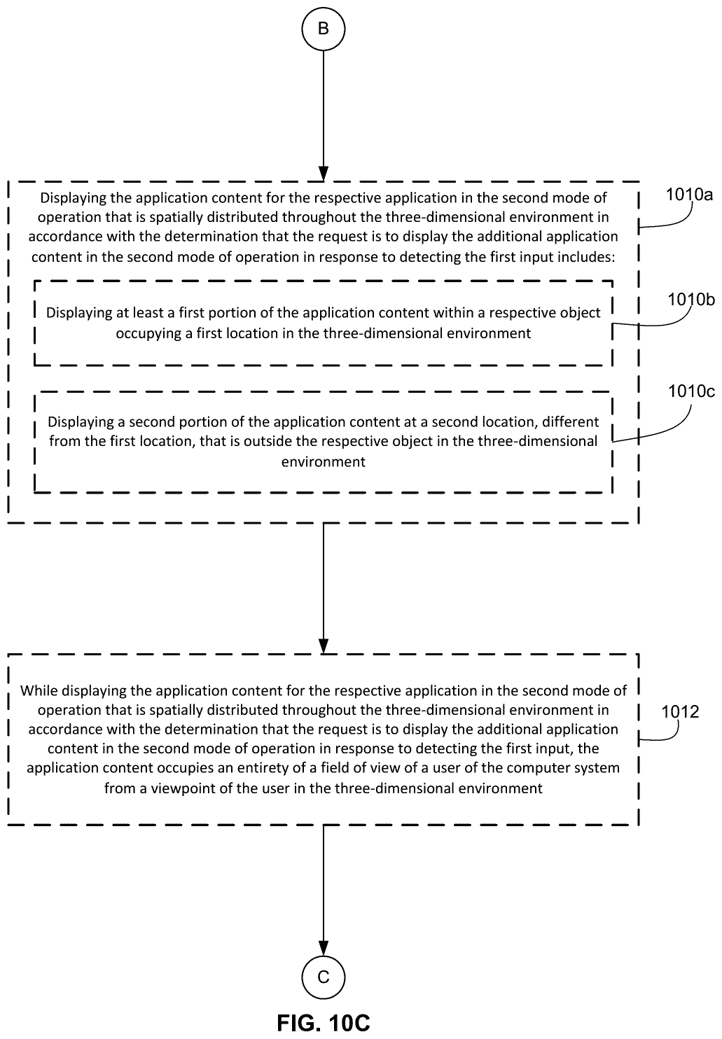

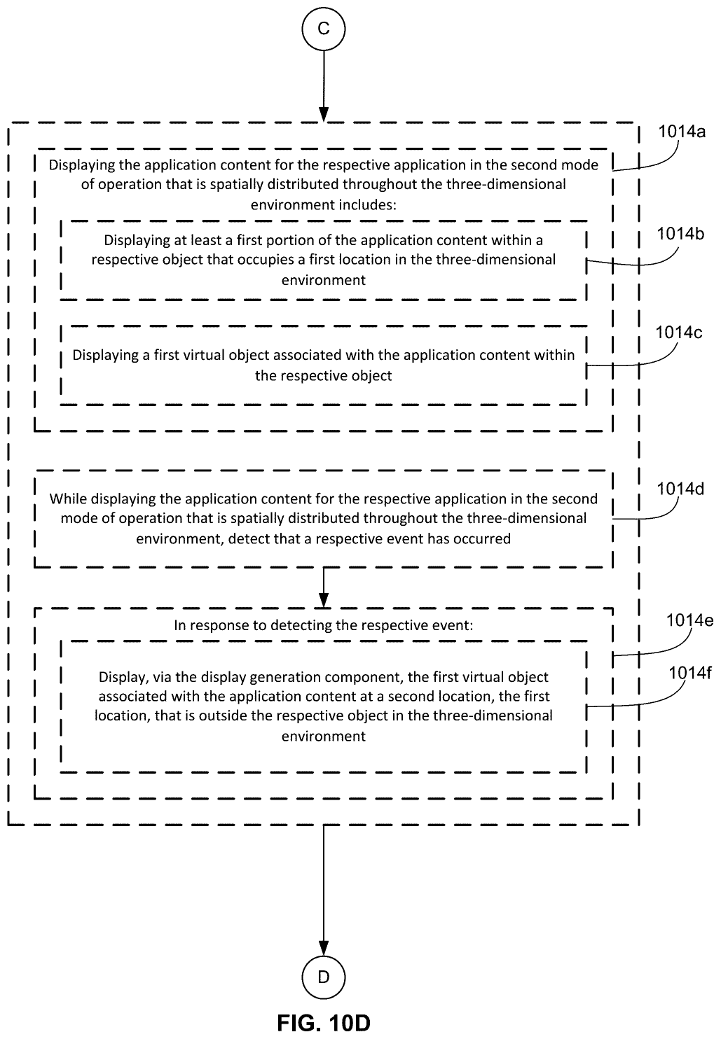

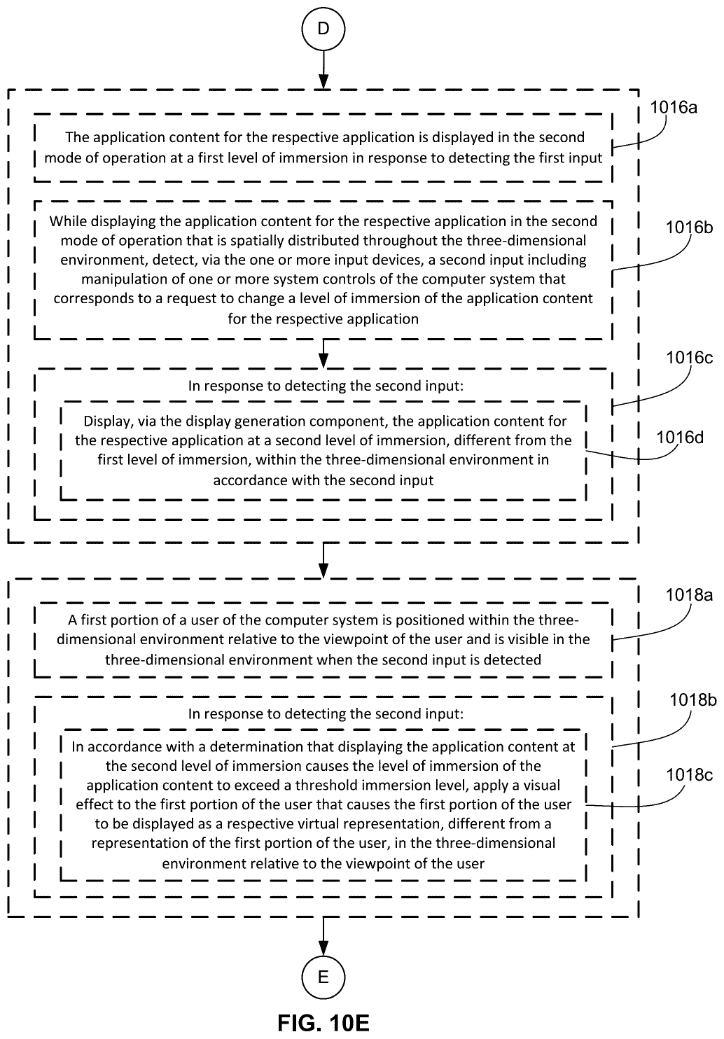

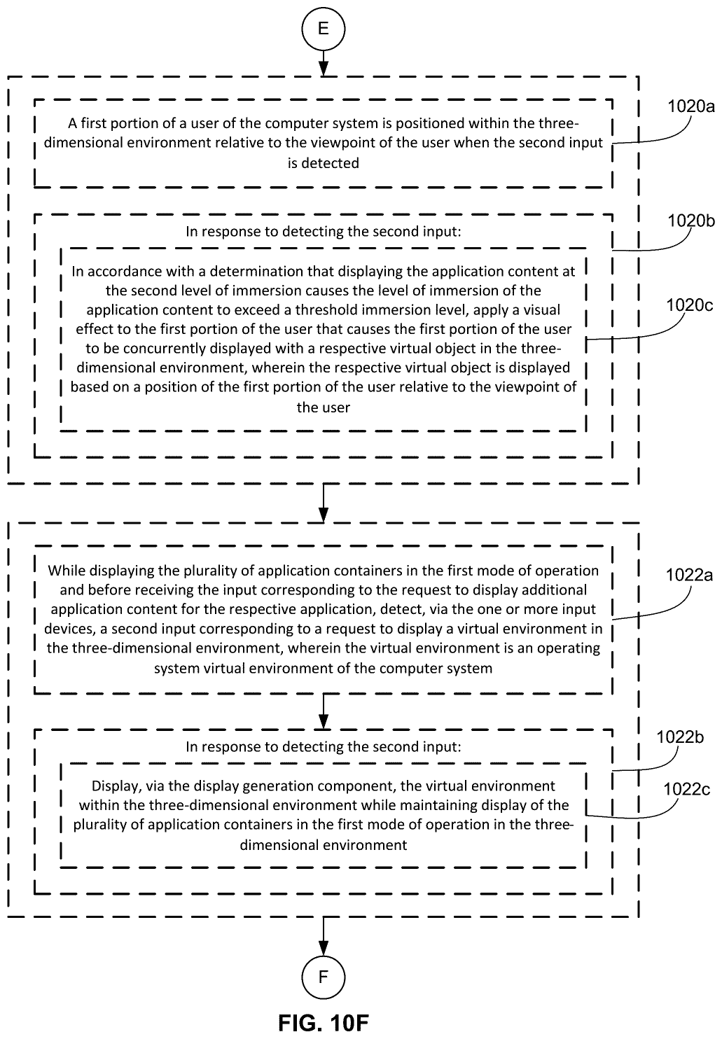

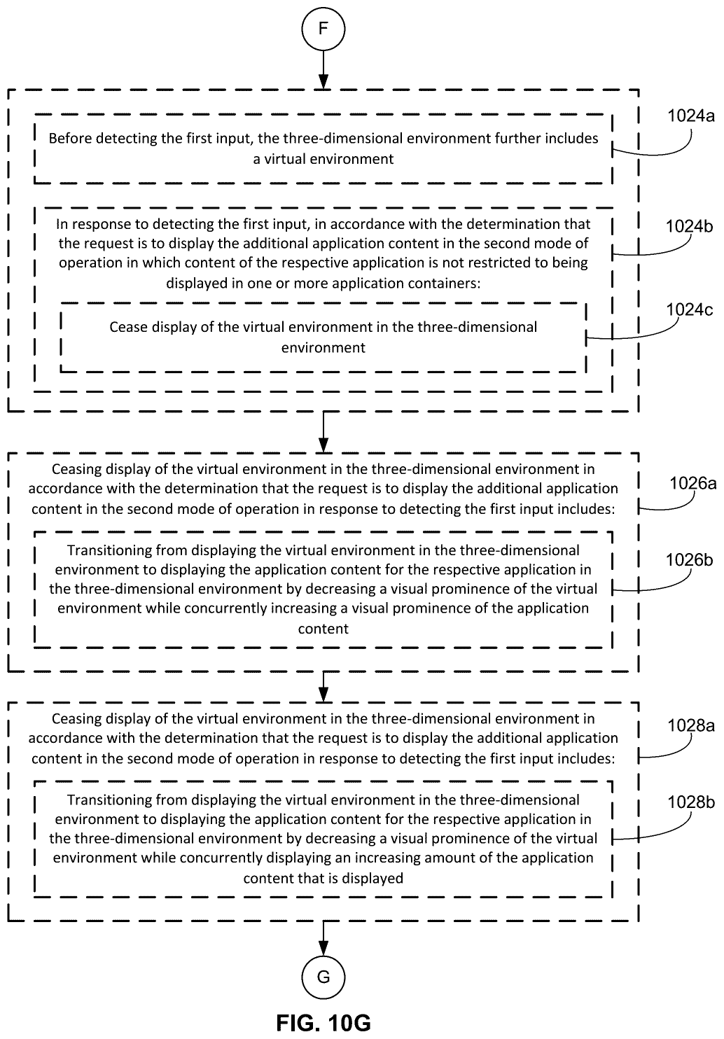

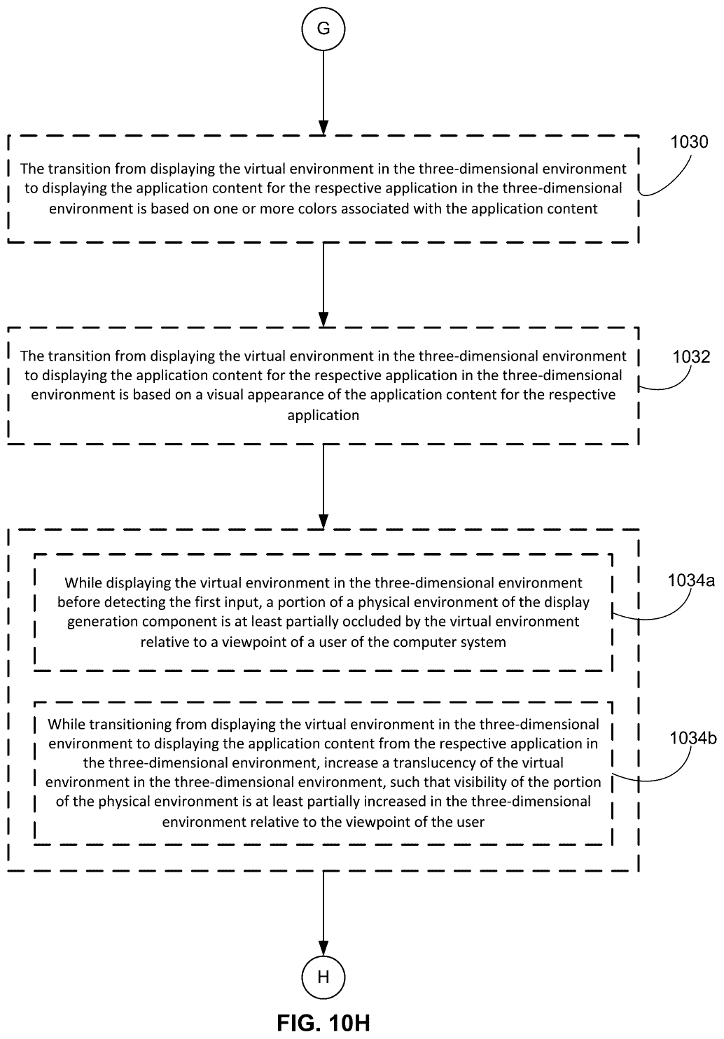

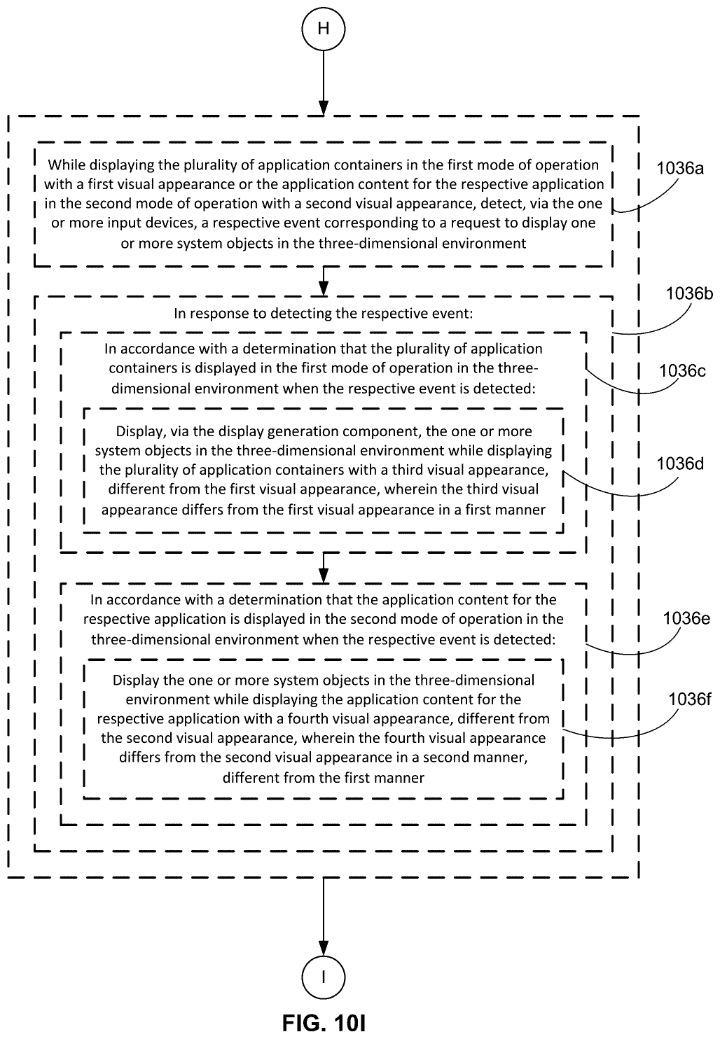

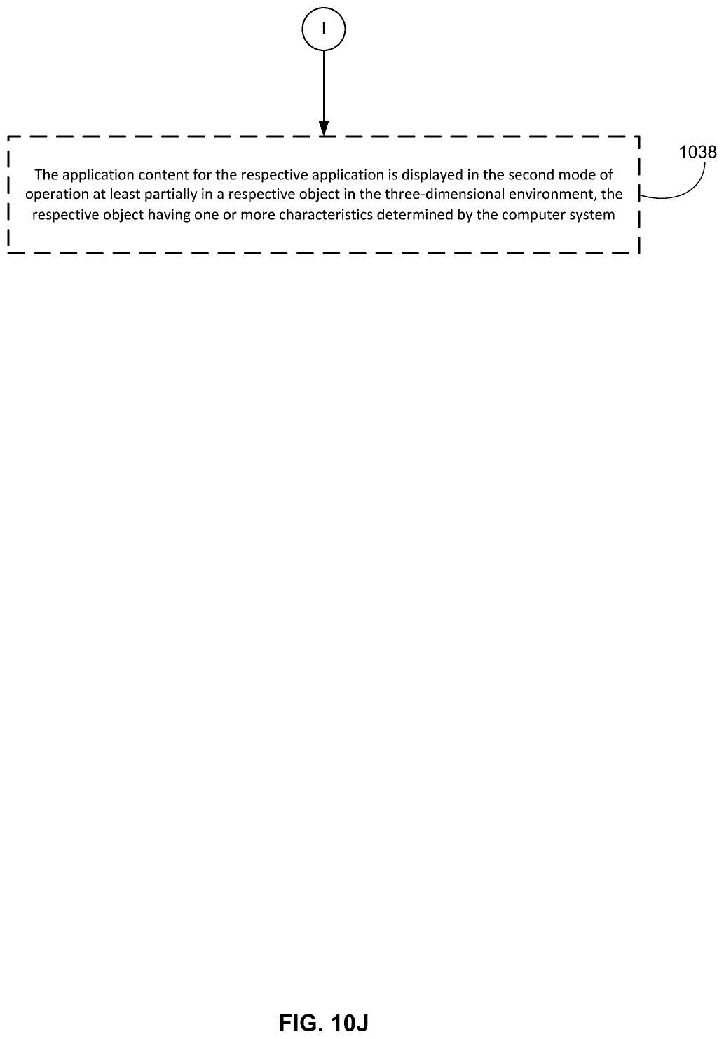

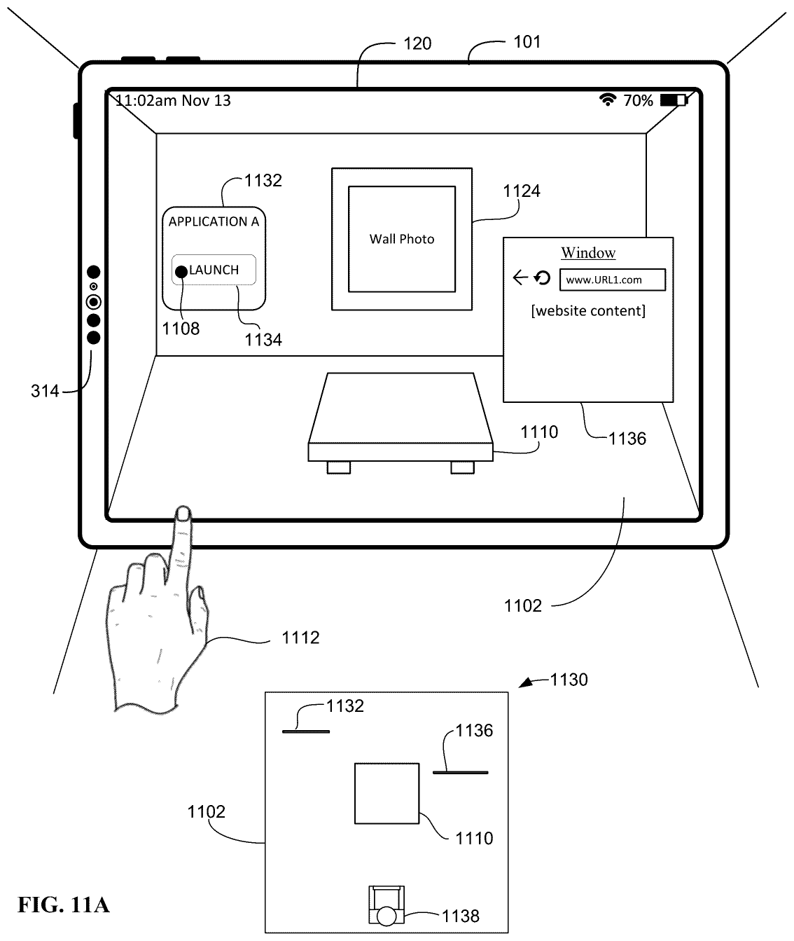

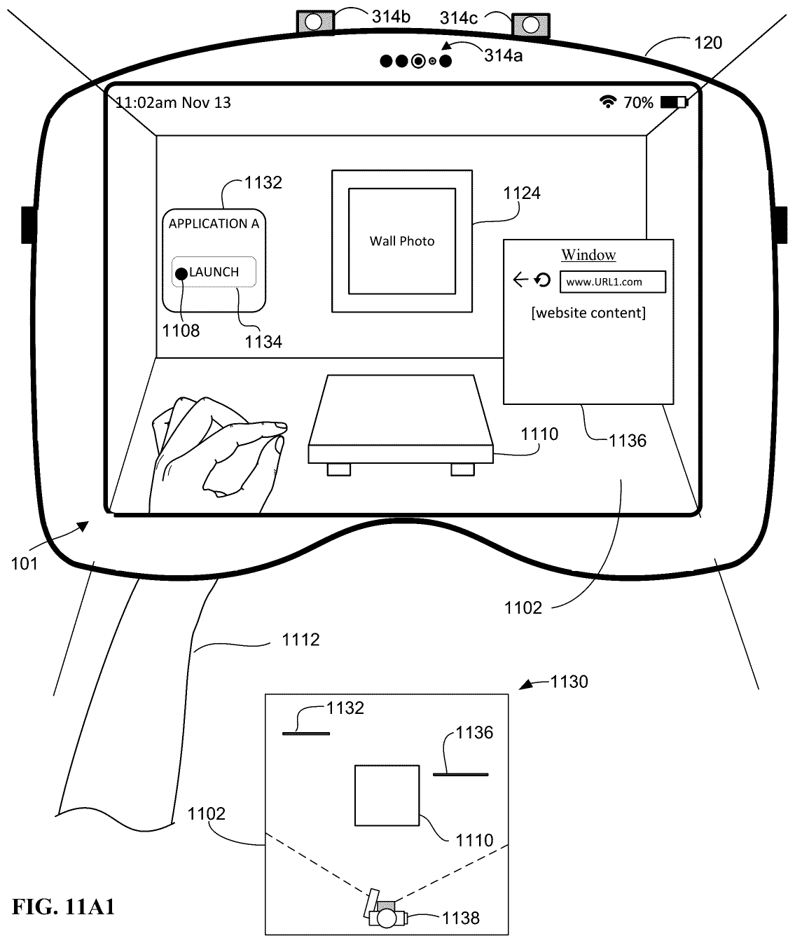

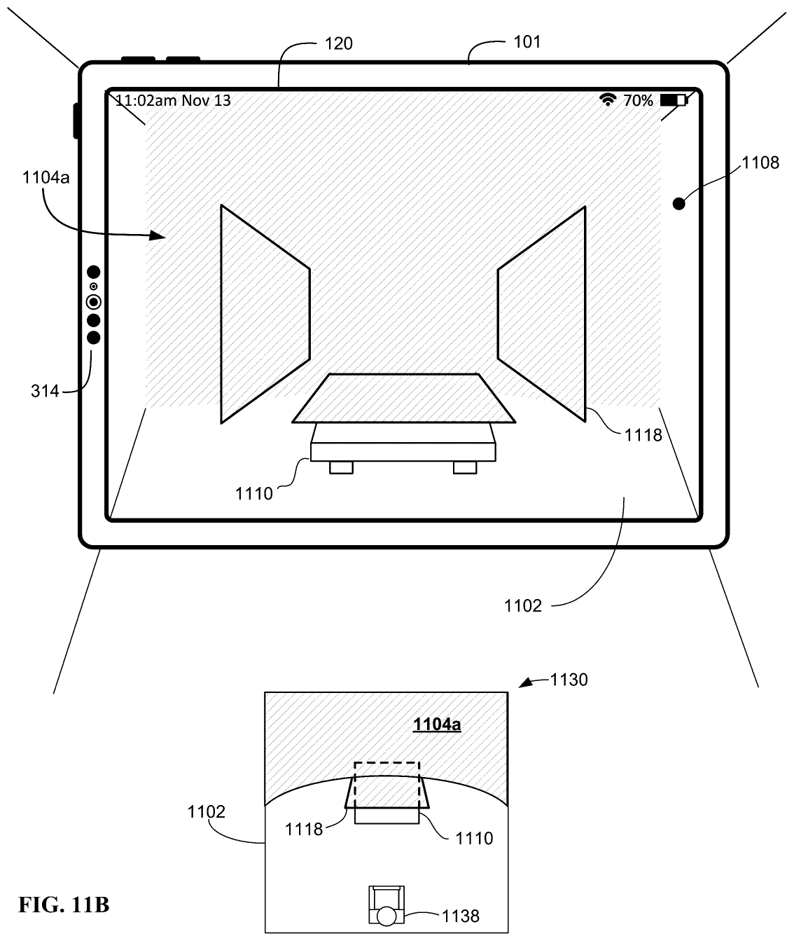

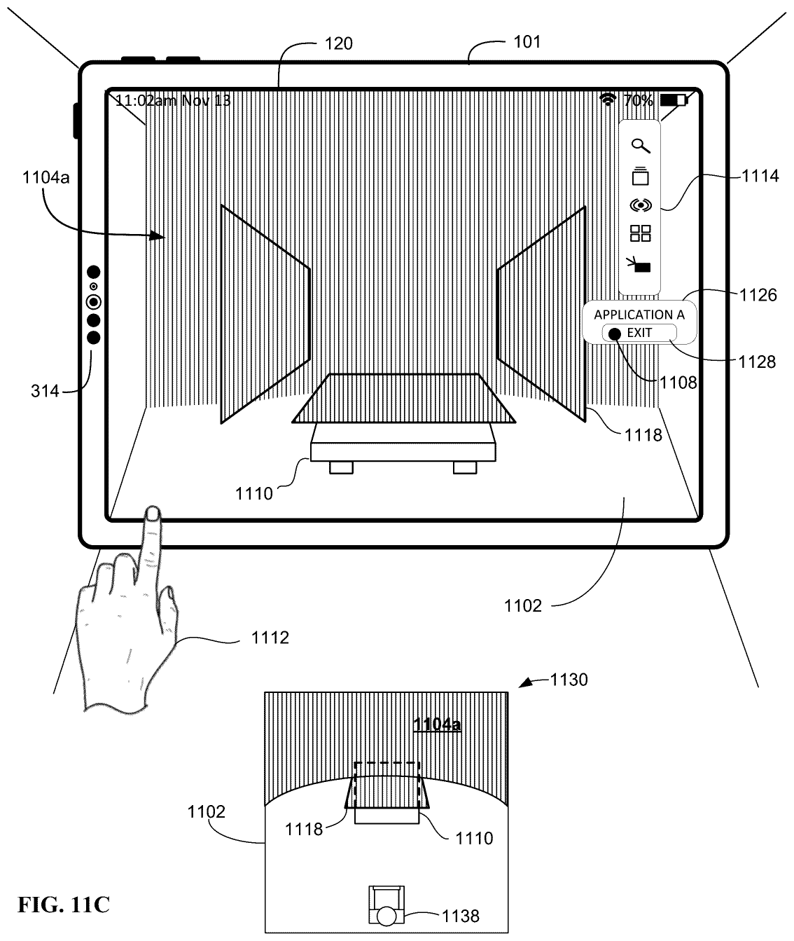

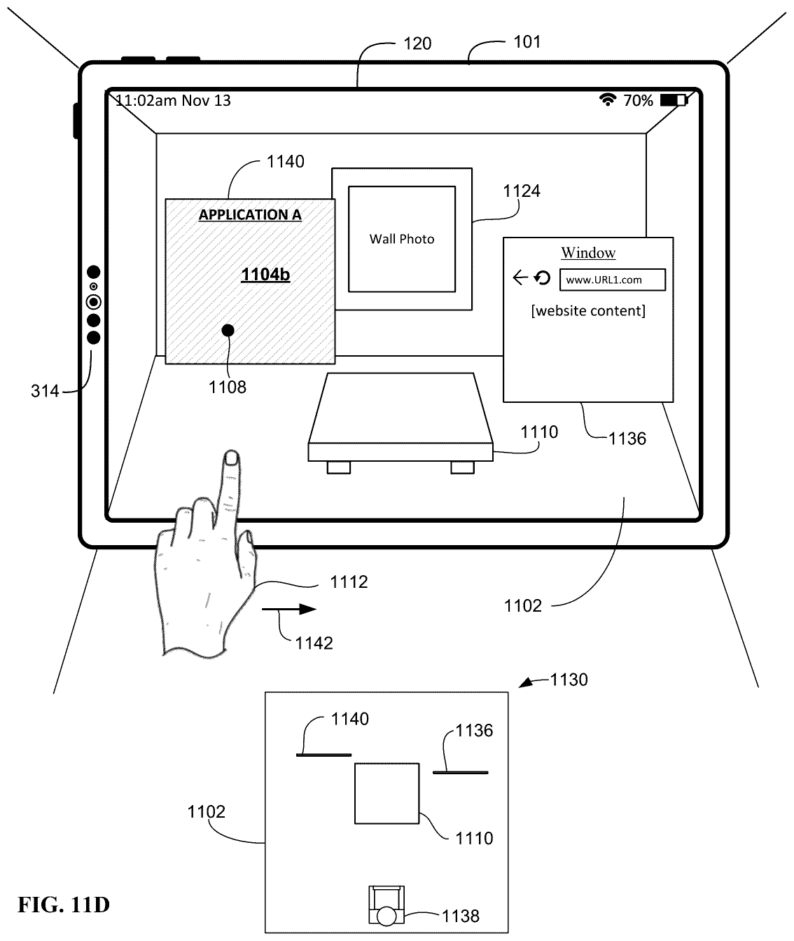

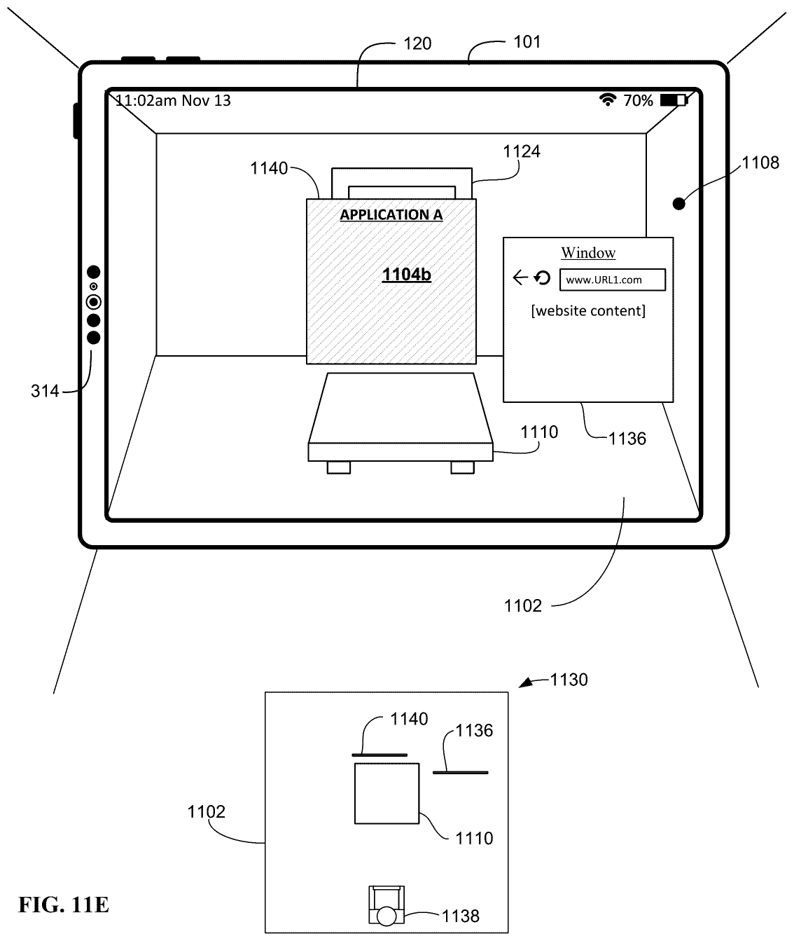

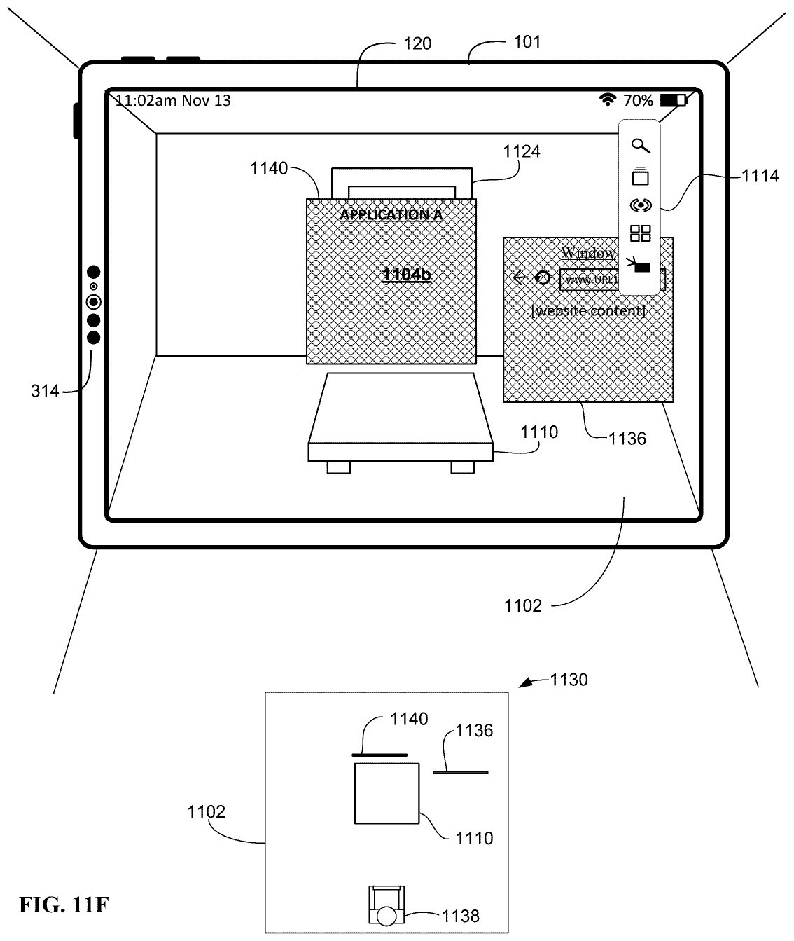

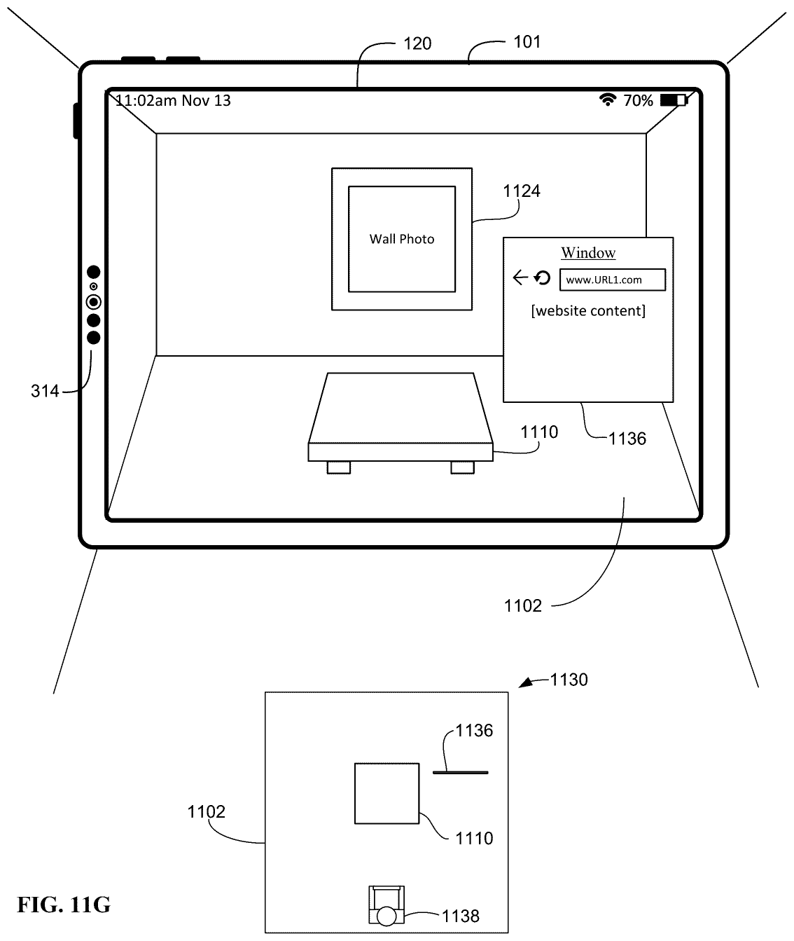

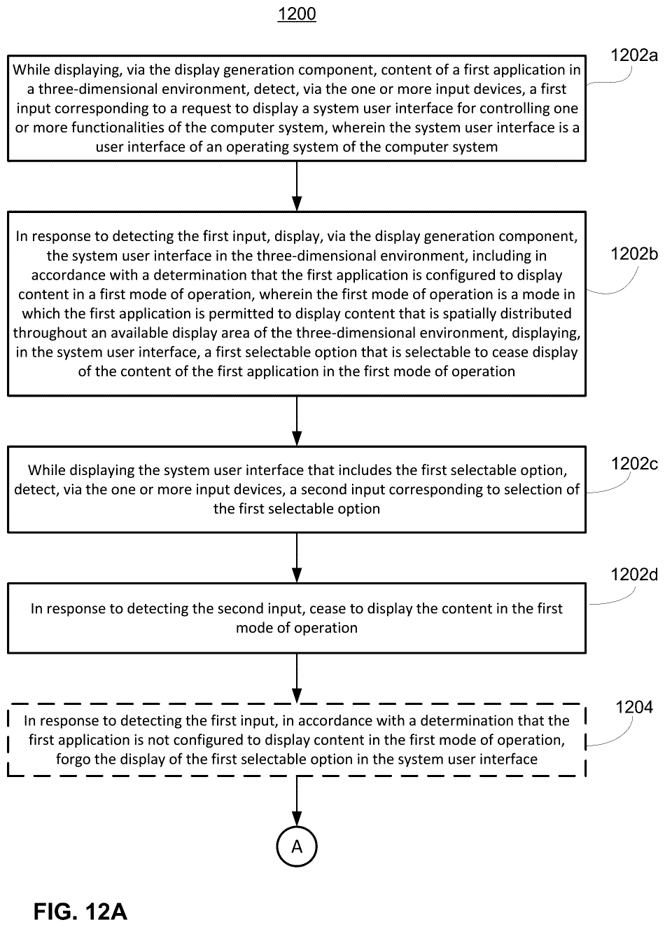

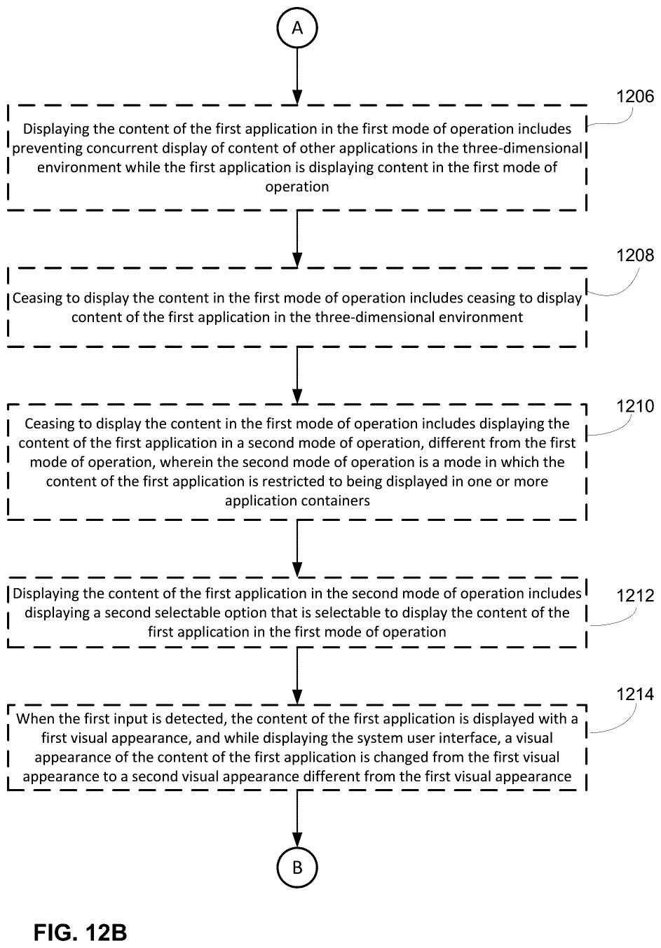

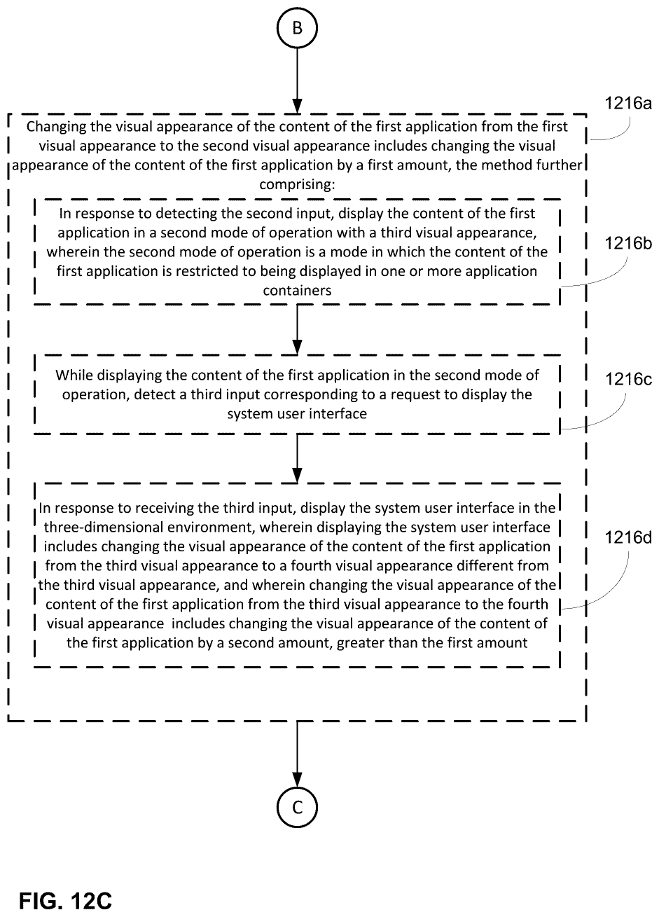

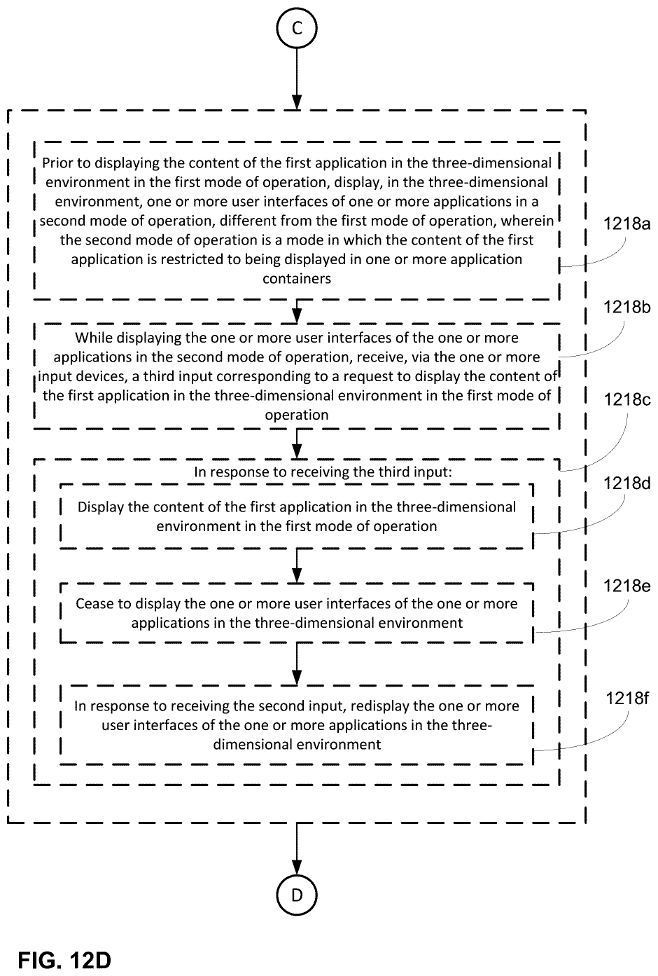

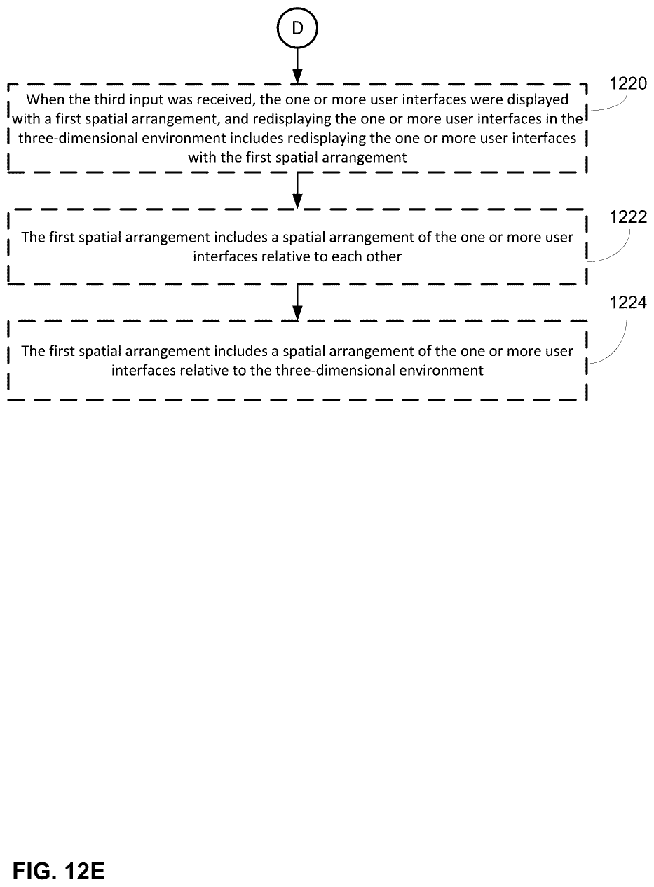

FIGS. 1A-6 provide a description of example computer systems for providing XR experiences to users (such as described below with respect to methods 800, 1000, and/or 1200). FIGS. 7A-7L illustrate examples of a computer system changing a visual appearance of immersive mixed reality (MR) content in a three-dimensional environment in accordance with a respective type of input in accordance with some embodiments of the disclosure. FIGS. 8A-8G is a flowchart of a method for changing a visual appearance of immersive mixed reality (MR) content in a three-dimensional environment in accordance with a respective type of input in accordance with some embodiments of the disclosure. The user interfaces of FIGS. 7A-7L are used to illustrate the processes in FIGS. 8A-8G. FIGS. 9A-9I illustrate examples of a computer system facilitating display of immersive mixed reality (MR) content in a three-dimensional environment in accordance with some embodiments of the disclosure. FIGS. 10A-10J is a flowchart of a method of facilitating display of immersive mixed reality (MR) content in a three-dimensional environment in accordance with some embodiments. The user interfaces of FIGS. 9A-9I are used to illustrate the processes in FIGS. 10A-10J. FIGS. 11A-11G illustrate examples of a computer system displaying content of a respective application in a first mode of operation that includes spatially distributing content throughout an available display area of a three-dimensional environment and ceasing display of the content in the first mode of operation in accordance with some embodiments. FIGS. 12A-12E is a flowchart illustrating a method for displaying content of a respective application in a first mode of operation that includes spatially distributing content throughout an available display area of a three-dimensional environment and ceasing display of the content in the first mode of operation in accordance with some embodiments. The user interfaces of FIGS. 11A-11G are used to illustrate the processes in FIGS. 12A-12E.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objets such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environement or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movment of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

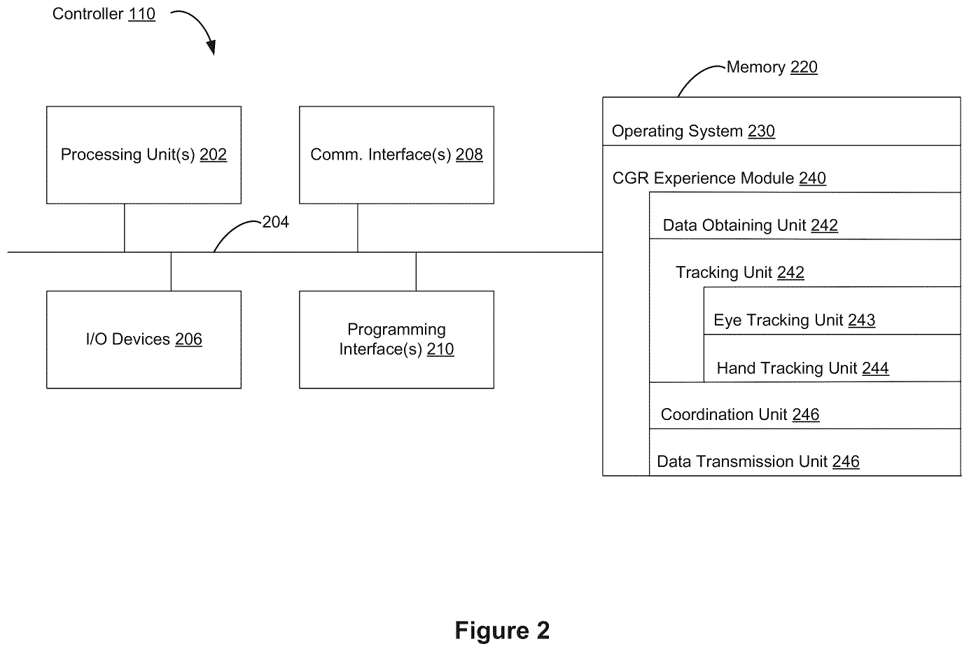

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

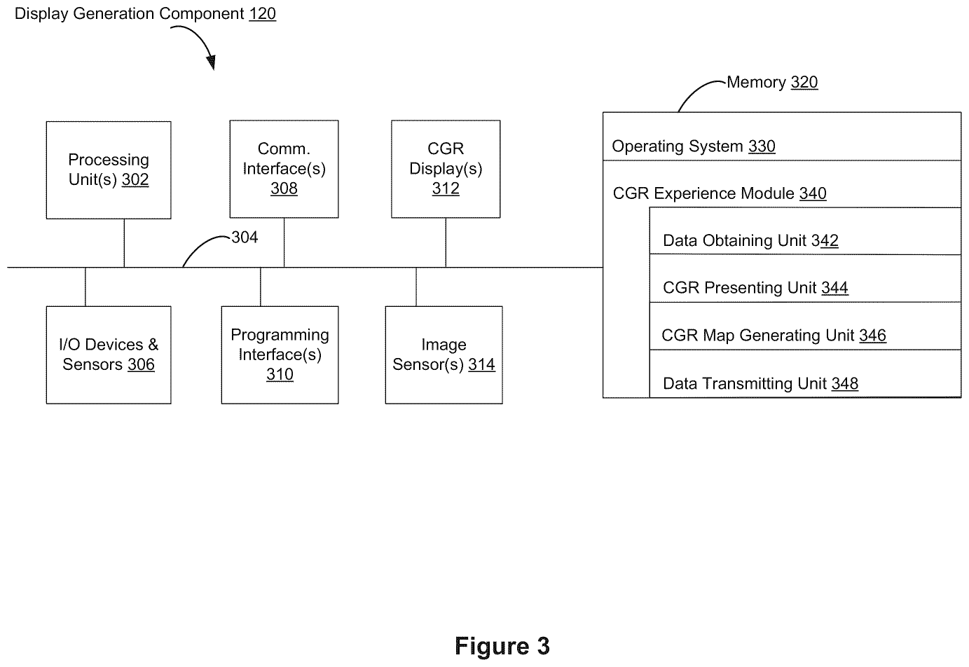

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be clastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-IF and described herein. Likewise, any of the features, components, and/or parts, including the arrangements and configurations thereof shown and described with reference to FIGS. 1D-IF can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, cither alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, cither alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, cither alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, cither alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

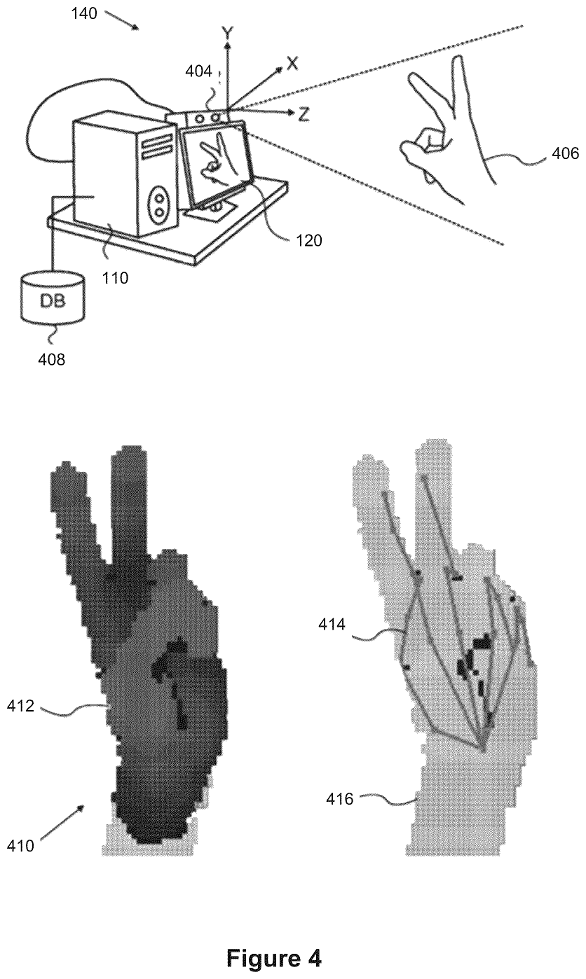

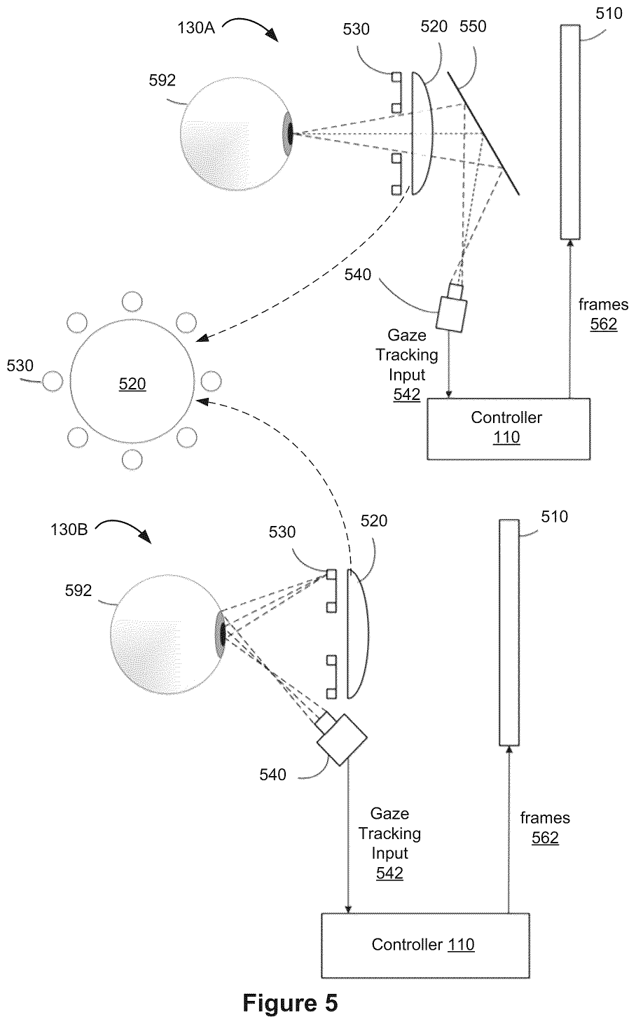

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

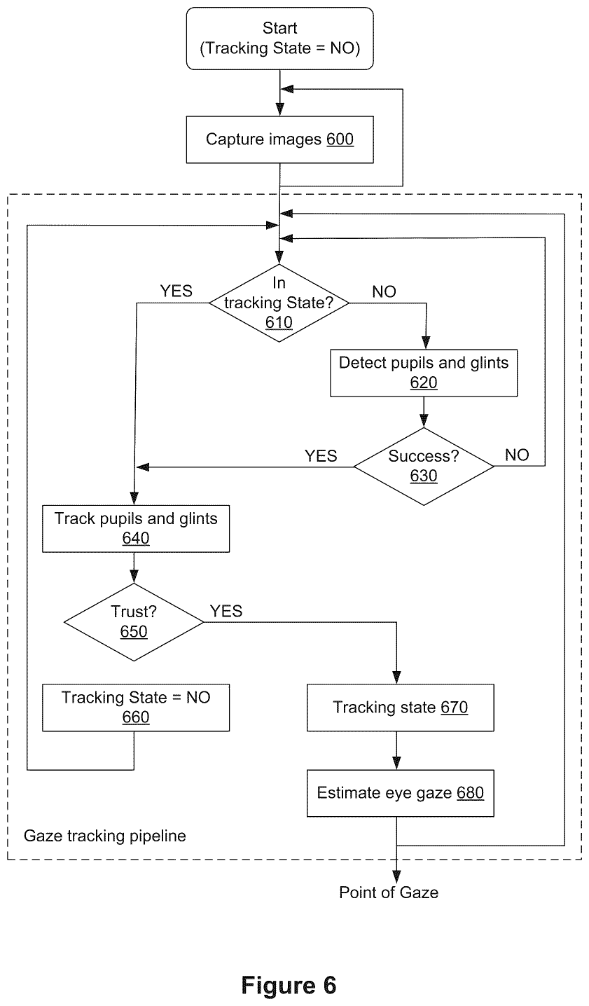

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7L illustrate examples of a computer system changing a visual appearance of immersive mixed reality (MR) content in a three-dimensional environment in accordance with a respective type of input accordance with some embodiments.

FIG. 7A illustrates a computer system 101 (e.g., an electronic device) displaying, via a display generation component (e.g., display generation component 120 of FIG. 1), a three-dimensional environment 704 from a viewpoint of a user 706 (e.g., facing the back wall of the physical environment in which computer system 101 is located, as shown in the overhead view). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user).

As shown in FIG. 7A, computer system 101 captures one or more images of the physical environment 702 around computer system 101 (e.g., operating environment 100), including one or more objects in the physical environment around computer system 101. In some embodiments, computer system 101 displays representations of the physical environment 702 in three-dimensional environment 704 and/or physical environment 702 is visible via display generation component 120. For example, three-dimensional environment 704 includes table 710a (e.g., corresponding to table 710b in the overhead view 718) and portions of the floor in the physical environment 702.

In FIG. 7A, the three-dimensional environment 704 also includes content from a first application, such as virtual environment 745a and virtual elements (e.g., virtual palette 742a and virtual paintbrush 744a). The virtual environment 745a includes one or more characteristics of the virtual environment described with reference to methods 800, 1000, and/or 1200.

As illustrated in the overhead view 718 in FIG. 7A, the user 706 is seated on a couch 722 in the physical environment 702 while interacting with the computer system 101. In the overhead view 718, table 710b is a real-world object in the physical environment 902, which has been captured by the one or more sensors of computer system 101, and representation of table 710b is included in the three-dimensional environment 704 (e.g., photorealistic representation, simplified representation, cartoon, or caricature), or table 710b is visible via passive passthrough via display generation component 120. Further, in the overhead view 718, the corner table 708b from the physical environment 702 is represented as dashed lines because the corner table 708b is not visible in the three-dimensional environment 704. That is, the portion of the physical environment 702 which includes the corner table 708b is not visible to the user 706 because content from the first application, such as the virtual environment 745a, has replaced the portion of the physical environment 702 that includes the corner table 708b.

In FIG. 7A, the computer system 101 is displaying an immersion level indicator 716. In some embodiments, the immersion level indicator 716 indicates the current level of immersion (e.g., out of a maximum number of levels of immersion) with which computer system 101 is displaying the three-dimensional environment 704 and/or virtual environment 745a. In some embodiments, a level of immersion includes an amount of view of the physical environment that is obscured (e.g., replaced) by content from a respective application, such as a virtual environment. In some embodiments, the level of immersion includes one or more characteristics of immersion described with reference to methods 800, 1000, and/or 1200. In FIG. 7A, the immersion level indicator 716 indicates partial immersion.

In FIG. 7A, the content from the first application is presented in accordance with a first mode of operation in a three-dimensional environment 704, where the first mode of operation is a mode in which the first application (e.g., the active application) is permitted to display content that is spatially distributed throughout an available display area (e.g., a volume or region that is optionally constrained by a portal or other boundary) of the three-dimensional environment 704. In FIG. 7A, portal 750a is a portal through which content from the first application (e.g., virtual environment 745a) is visible; portal 750a optionally has one or more characteristics of portals described with reference to methods 800, 1000 and/or 1200. In some embodiments, the content from the first application is visible from the viewpoint of the user 706 via the portal 750a. As shown in FIG. 7A, the first application is presented in the first mode of operation; thus, the content presented by the first application in the three-dimensional environment 704 is located within the portal 750a and located outside the portal 750a. For example, as shown in FIG. 7A, the virtual environment 745a and the virtual palette 742a are displayed within the portal 750a. Meanwhile, as shown in FIG. 7A, the virtual paintbrush 744a is displayed outside the portal 750a in three-dimensional environment 704.

In some embodiments, the computer system 101 initially displays the portal 750a including the content from the first application with a first animation (e.g., depth-based animation). Displaying the portal 750a with the first animation optionally includes gradually expanding the portal 750a and/or moving the portal 750a closer to the viewpoint of the user 706 such that more of the content from the first application is displayed within the portal 750a and/or more of the physical environment 702 is obscured by the content from the first application. For example, the portal 750a moving closer to the viewpoint of the user 706 optionally increases the proportion of the field of view visible via the display generation component 120 that is occupied by the content from the first application. Accordingly, from FIG. 7A to 7B, the portal 750a moves closer to the viewpoint of the user 706, the portal 750a appears expanded, and more of the content from the first application, such as more of the virtual environment 745a is within the portal 750a.

From FIG. 7B to FIG. 7C, while interacting with the computer system 101, the user 706 has moved from the couch 722 to a position right of the couch 722. As shown in FIG. 7C, because the user 706 has moved right relative to the three-dimensional environment 704, the content from the first application (e.g., such as virtual palette 742 and virtual paintbrush 744a) and/or physical objects (e.g., table 710a) from the three-dimensional environment 704 appear towards the left side of the three-dimensional environment 704 visible from the viewpoint of the user 706. In some embodiments, based on the user moving relative to the three-dimensional environment 704 and/or portal 750a, the portal 750a shrinks or appears farther away from the viewpoint of the user 706. For example, because the user has moved from the couch 722 in FIG. 7B to a different location in FIG. 7C in the three-dimensional environment 704, the portal 750a is moved away (e.g., retracted) from the viewpoint of the user 706 in FIG. 7C such that a greater portion of the physical environment 702 is viewable and not obscured by the content from the first application. In some embodiments, the computer system 101 moves the portal 750a away (e.g., retracts) from the viewpoint of the user 706 only when the user has moved more than threshold distance (e.g., 0.1, 0.5, 1, or 10 m) from an initial location. In FIG. 7C, because the portal 750a has shrunk and/or retracted from the viewpoint of the user 750, less of the content from the first application (e.g., less of the virtual environment 745a) is displayed within the portal 750a compared to FIG. 7B. Despite the portal 750a having shrunk in FIG. 7C, the virtual environment 745a and the virtual palette 742a are displayed within the portal 750a. Meanwhile, as shown in FIG. 7C, the virtual paintbrush 744a is displayed outside the portal 750a in three-dimensional environment 704 (and optionally has not moved or changed in response to the retraction of portal 750a).

From FIG. 7C to FIG. 7D, while interacting with the computer system 101, the user 706 has moved back to the couch 722 (e.g., same location as in FIG. 7B). In FIG. 7D, because the user 706 is seated again on the couch 722, the appearance and relative position of the portal 750a from the viewpoint of the user 706a is the same as in FIG. 7B. Further, the immersion level in FIG. 7D is the same as in FIG. 7B. Moreover, in FIG. 7D, the computer system 101 receives input from hand 703a directed to physical button 741, knob, or other rotatable input mechanism (e.g., a depressible and rotatable input mechanism) of computer system 101. In some embodiments, an amount by which the immersion level is changed in the three-dimensional environment 704 is based on (e.g., is equal to or is proportional to an amount of rotation of the knob or other rotatable input mechanism discussed above. In some embodiments, whether the immersion level is increased or decreased in the three-dimensional environment 704 is based on a direction of the rotation of the knob or other rotatable input mechanism discussed above. For example, if the input detected by the computer system 101 includes rotation of the knob or other rotatable input mechanism in a first direction, the computer system 101 increases the immersion level of content. In some embodiments, if the input detected by the computer system 101 includes rotation of the knob or other rotatable input mechanism in a second direction, opposite the first direction, the computer system 101 decreases the immersion level of the content. In some embodiments, when depressed, the physical button 741 causes an increase in an immersion level of the content from the first application, such as the virtual environment 745a.

In response to receiving the input for the increase in the immersion level of the content from the first application in FIG. 7D, the computer system 101 increases the immersion level of the content from the first application in FIG. 7E (as indicated by the immersion level indicator 716). As shown in FIG. 7E and described in detail with reference to method 800, because the level of immersion has increased, the portal 750a expands and/or moves closer the viewpoint of the user 706, such that more of the content from the first application (e.g., more of the virtual environment 745a and the virtual palette 744a) is displayed within the portal 750a compared to FIG. 7D.

As shown in the overhead view 718, at the immersion level for virtual environment 745b displayed in FIG. 7E, the virtual environment 745b optionally extends from the portal 750b (e.g., closer to the viewpoint of the user 706 compared to the portal 750b in FIG. 7D) to a far wall 714 in three-dimensional environment 704. In FIG. 7E, the computer system 101 receives input from hand 703b directed to the physical button 741, knob, or other rotatable input mechanism (e.g., a depressible and rotatable input mechanism). In some embodiments, when depressed again, the physical button 741 causes a further increase in an immersion level of content from the first application

In response to receiving the input for the increase in the immersion level of the content from the first application to a maximum level in FIG. 7E, the computer system 101 increases the immersion level of the content from the first application to a maximum immersion limit in FIG. 7F (e.g., full immersion as indicated by the immersion level indicator 716). At full immersion in FIG. 7F, the computer displays a maximum level of the content from the first application (e.g., including the virtual paintbrush 744a) within the portal 750a (and optionally does not change the display of virtual paintbrush 744a in the three-dimensional environment). As described with reference to method 800, in some embodiments, the immersion limit of the content from a respective application is defined by the respective application. Thus, in FIG. 7F, the first application defines the maximum and/or minimum immersion limits for displaying content from the first application. As shown in FIG. 7F, the increased immersion level of the content from the first application in accordance with the input from FIG. 7E exceeds the maximum immersion limit defined by the first application. In FIG. 7F, the computer system 101 displays content from the first application at the maximum immersion limit despite the user input from FIG. 7E corresponding to a request to display the content from the first application at an increased immersion level that exceeds the maximum immersion limit defined by the first application. In some embodiments, when a user input includes a request for changing the immersion level to a respective immersion level that is outside the first range of immersion levels as described with reference to method 800, the computer system 101 displays the content from the respective application with a transient immersion level (e.g., as shown by the vertical pattern in FIG. 7F because the increase in immersion level corresponding to the input of FIG. 7E exceeds the maximum immersion limit defined by the first application). In some embodiments, when the respective immersion level is outside the range of immersion levels, the computer system 101 displays content from the respective application with a visual appearance that includes blurring edges, darkening edges, and/or increasing transparency of edges of content from the respective application constrained by the portal 750a (e.g., as shown by the dotted pattern in FIG. 7F because the increase in immersion level corresponding to the input of FIG. 7E exceeds the maximum immersion limit defined by the first application).

As shown in the overhead view 718, the table 710b and the corner table 708b from the physical environment 702 are represented as dashed lines because the table 710b and the corner table 708b are no longer visible in the three-dimensional environment 704 at the full immersion level. As shown in the overhead view 718, at the immersion level for content from the first application (e.g., virtual environment 745b) displayed in FIG. 7F, the virtual environment 745b optionally extends from the portal 750b (e.g., closer to the viewpoint of the user 706 compared to portal 750a in FIG. 7E) to the far wall 714 in three-dimensional environment 704. In FIG. 7F, the computer system 101 displays user interface 770a (e.g., user interface A). In some embodiments, the computer system 101 displays the user interface 770a (e.g., user interface A) in FIG. 7F in response to receiving an input (e.g., attention and/or input from a hand of the user 706) directed to a selectable option from a control user interface that, when selected, causes the computer system 101 to display the user interface 770a in the three-dimensional environment 704. In some embodiments, the user interface 770a includes a first set of options 772 for displaying immersive mixed reality content, such as content from respective applications (e.g., content from a second application (A2), content from a third application (A3), or content from a fourth application (A4)). In some embodiments, the user interface 770a includes a second set of options 774 for displaying virtual environments (e.g., Background 1 (B1), Background 2 (B2), or Background 3 (B3)). In FIG. 7F, the computer system 101 receives input from hand 703c corresponding to displaying content from a different application, such as a second application (e.g., A2 in options 772 in user interface 770a) (e.g., an air pinch gesture from hand 703c while attention of the user is directed to A2 in options 772 of user interface 770a or air tapping option A2).

FIG. 7F1 illustrates similar and/or the same concepts as those shown in FIG. 7F (with many of the same reference numbers). It is understood that unless indicated below, elements shown in FIG. 7F1 that have the same reference numbers as elements shown in FIGS. 7A-7J have one or more or all of the same characteristics. FIG. 7F1 includes computer system 101, which includes (or is the same as) display generation component 120. In some embodiments, computer system 101 and display generation component 120 have one or more of the characteristics of computer system 101 shown in FIGS. 7F and 7A-7J and display generation component 120 shown in FIGS. 1 and 3, respectively, and in some embodiments, computer system 101 and display generation component 120 shown in FIGS. 7A-7J have one or more of the characteristics of computer system 101 and display generation component 120 shown in FIG. 7F1.

In FIG. 7F1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 7A-7J.

In FIG. 7F1, display generation component 120 is illustrated as displaying content that optionally corresponds to the content that is described as being displayed and/or visible via display generation component 120 with reference to FIGS. 7A-7J. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 7F1.

Display generation component 120 has a field of view (e.g., a field of view captured by external image sensors 314b and 314c and/or visible to the user via display generation component 120, indicated by dashed lines in the overhead view) that corresponds to the content shown in FIG. 7F1. Because display generation component 120 is optionally a head-mounted device, the field of view of display generation component 120 is optionally the same as or similar to the field of view of the user.

In FIG. 7F1, the user is depicted as performing an air pinch gesture (e.g., with hand 703c) while attention of the user is directed to option A2 (e.g., indicated by gaze point 760) to provide an input to content displayed by computer system 101. Such depiction is intended to be exemplary rather than limiting; the user optionally provides user inputs using different air gestures and/or using other forms of input as described with reference to FIGS. 7A-7J.

In some embodiments, computer system 101 responds to user inputs as described with reference to FIGS. 7A-7J.

In the example of FIG. 7F1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 7A-7J and/or described with reference to the corresponding method(s) are optionally implemented on computer system 101 and display generation unit 120 in a manner similar or analogous to that shown in FIG. 7F1.

In response to receiving the input for displaying content from a different application, such as a second application (A2) in FIG. 7F, the computer system 101 ceases display of content from the first application and instead displays content from the second application (A2) in FIG. 7G. As shown in FIG. 7G, the immersion level is the same as the immersion level in FIGS. 7B and 7D. As shown in FIG. 7G, the computer system 101 presents the second application in the first mode of operation; thus, the content presented by the second application in the three-dimensional environment 704 is located within the portal 750a and located outside the portal 750a. For example, as shown in FIG. 7G, the virtual environment 743a and the virtual baseball bat 746a are displayed within the portal 750a. Meanwhile, as shown in FIG. 7G, the virtual basketball 748a is displayed outside the portal 750a. The appearance and relative position of the portal 750a from the viewpoint of the user 706a is the same as in FIGS. 7B and 7D. In FIG. 7G, the computer system 101 receives input from hand 703d directed to the physical button 741, knob, or other rotatable input mechanism (e.g., a depressible and rotatable input mechanism). In some embodiments, when depressed, the physical button 741 causes an increase in an immersion level of content from the second application.

In response to receiving the input for the increase in the immersion level of the content from the second application to a maximum level in FIG. 7G, the computer system 101 increases the immersion level of the content from the second application to a maximum immersion limit in FIG. 7H (e.g., full immersion as indicated by the immersion level indicator 716). As shown in FIG. 7H, the increased immersion level of the content from the second application in accordance with the input from FIG. 7G exceeds the maximum immersion limit defined by the second application. Accordingly, in FIG. 7H, the computer system 101 displays content from the second application at the maximum immersion limit despite the user input from FIG. 7G corresponding to a request to display the content from the second application at an increased immersion level that exceeds the maximum immersion limit defined by the second application. In FIG. 7H, the computer system 101 displays the content from the second application with a transient immersion level (e.g., as shown by the diagonal pattern in FIG. 7H) because the increase in immersion level corresponding to the input of FIG. 7G exceeds the maximum immersion limit defined by the second application. Further, in FIG. 7H, the computer system 101 displays content from the second application with a visual appearance that includes blurring edges, darkening edges, and/or increasing transparency of edges of content from the second application constrained by the portal 750a (e.g., as shown by the dotted pattern in FIG. 7H) because the increase in immersion level corresponding to the input of FIG. 7G exceeds the maximum immersion limit defined by the second application. As described with reference to method 800, a visual appearance of the content from the second application is modified in the same manner as the content from the first application in accordance with the same type of input. In FIG. 7H, the computer system 101 displays user interface 770a (e.g., user interface A) as described with reference to FIG. 7F. In FIG. 7H, the computer system 101 receives input from hand 703e corresponding to displaying a virtual environment (e.g., B1 in options 774 in user interface 770a) (e.g., an air pinch gesture from hand 703e while attention of the user is directed to B1 in options 774 of user interface 770a or air tapping option B1).

In response to receiving the input for displaying Background 1 in FIG. 7H, the computer system 101 ceases display of content from the second application and instead displays virtual environment 760a (Background 1) and virtual elements, such as virtual mountains 762a and virtual trees 764a in FIG. 7I. As shown in FIG. 7I, the immersion level is the same as the immersion level in FIG. 7G. As shown in FIG. 7I, in some embodiments, unlike content from the first or second applications, no virtual content is displayed outside the portal 750a when displaying the virtual environment 760a and corresponding virtual elements (e.g., virtual mountains 762a and virtual trees 764a) In some embodiments, the virtual environment 760a is presented in a different mode of operation (e.g., a second mode of operation) from the first mode of the operation. In accordance with the different mode of operation (e.g., a second mode of operation), content associated with the virtual environment 760a is optionally limited to being displayed at locations within the portal. In FIG. 7I, the computer system 101 receives input from hand 703f directed to the physical button 741, knob, or other rotatable input mechanism (e.g., a depressible and rotatable input mechanism). In some embodiments, when depressed, the physical button 741 causes an increase in an immersion level of the virtual environment 760a (e.g., optionally to a maximum level).

In response to receiving the input for the increase in the immersion level of the virtual environment 760a to a maximum level in FIG. 7I, the computer system 101 increases the immersion level of the virtual environment 760a to a maximum level in FIG. 7J (e.g., full immersion as indicated by the immersion level indicator 716). As shown in the overhead view 718, the table 710b and the corner table 708b from the physical environment 702 are represented as dashed lines because the table 710b and the corner table 708b are no longer visible in the three-dimensional environment 704 at full immersion. Further, as shown in the overhead view 718 in FIG. 7J, at the immersion level for virtual environment 760a displayed in FIG. 7J, the virtual environment 760b optionally extends from the portal 750b (e.g., closer to the viewpoint of the user 706 compared to the portal 750b in FIG. 7I) to the far wall 714 in three-dimensional environment 704. As shown in FIG. 7J, the virtual environment 760a content at full immersion is displayed differently than content from the first and/or second application (e.g., immersive mixed reality (MR) content) at full immersion described above. In FIG. 7J, even at full immersion, all virtual content corresponding to the virtual environment 760a is displayed within the portal 750a. In FIG. 7J, the computer system 101 optionally receives user input corresponding to a request to cease display of the virtual environment 760a and/or the portal 750a.

From FIG. 7J to 7K, the computer system 101 gradually ceases display of the virtual environment 760a and/or the portal 750a in response to receiving the user input corresponding to a request to cease display of the virtual environment 760a and/or the portal 750a. As shown in FIG. 7K and as described with reference to method 800, the computer system 101 ceases display of the portal 750a with a second animation (not depth-based) by gradually fading out the portal 750a and/or the virtual environment 760a until the portal 750b and/or the virtual environment 760a are no longer visible (e.g., without retracting the portal 750a from the viewpoint of the user 706). Thus, in FIG. 7K, the computer system 101 gradually ceased display of the portal 750a and/or the virtual environment 760a, such that the virtual mountain 762a and virtual trees 764a from FIG. 7J are no longer displayed. FIG. 7K depicts gradual fading of the virtual environment 760a, where the computer system 101 fully ceases display of certain virtual content and/or reduces a visual prominence (e.g., blurrier, less bright, and/or more transparent) of certain virtual content.

From FIG. 7K to FIG. 7L, the computer system 101 has fully ceased display of the portal 750a and the virtual environment 760a. Accordingly, the three-dimensional environment 704 includes the table 710a the corner table 708a, and portions of the floor in the physical environment 702. As shown in the overhead view 718 of FIG. 7L, the table 710a and the corner table 708a are real-world objects in the physical environment 702 as described above in FIG. 7A.

FIGS. 8A-8G is a flowchart illustrating an exemplary method 800 of changing a visual appearance of immersive mixed reality (MR) content in a three-dimensional environment in accordance with a respective type of input in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector,) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, the method 800 is performed at a computer system, such as computer system 101 in FIG. 1, in communication with a display generation component and one or more input devices. For example, a mobile device (e.g., a tablet, a smartphone, a media player, or a wearable device), or a computer or other computer system. In some embodiments, the display generation component is a display integrated with the computer system (optionally a touch screen display), external display such as a monitor, projector, television, or a hardware component (optionally integrated or external) for projecting a user interface or causing a user interface to be visible to one or more users. In some embodiments, the one or more input devices include a computer system or component capable of receiving a user input (e.g., capturing a user input and/or detecting a user input) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device, and/or a motion sensor (e.g., a hand tracking device, a hand motion sensor). In some embodiments, the computer system is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the computer system displays (802a), via the display generation component, content from a first application presented in accordance with a first mode of operation in a three-dimensional environment, such as displaying content from a first application in accordance with a first mode of operation in FIG. 7C, wherein the first mode of operation is a mode in which the first application (e.g., the active application) is permitted to display content that is spatially distributed throughout an available display area (e.g., a volume or region that is optionally constrained by a portal or other boundary) of the three-dimensional environment. For example, the three-dimensional environment is generated, displayed, or otherwise caused to be viewable by the computer system (e.g., an extended reality (XR) environment such as a virtual reality (VR) environment, a mixed reality (MR) environment, or an augmented reality (AR) environment). In some embodiments, a physical environment surrounding the display generation component is visible through a transparent portion of the display generation component (e.g., true or real passthrough). In some embodiments, the three-dimensional environment has one or more characteristics of the environments described with reference to methods 1000 and/or 1200. In some embodiments, the content that is spatially distributed throughout the available display area includes one of a window of a web browsing application displaying content (e.g., text, images, or video), a window displaying a photograph or video clip, a media player window for controlling playback of content items on the computer system, a contact card in a contacts application displaying contact information (e.g., phone number email address, and/or birthday) and/or a virtual boardgame of a gaming application. In some embodiments, the portal or other boundary (e.g., in which the content is displayed) has one or more characteristics of objects described with reference to methods 1000 and/or 1200. In some embodiments, the portal or other boundary is a portal into content associated with and/or provided by the first application (e.g., similar to the herein described portals into simulated and/or virtual environments). Accordingly, the content is visible from the viewpoint of the user via the portal. In some embodiments, if the first application is presented in the first mode of operation, the content presented by the first application in the three-dimensional environment is capable of being located within the portal and/or located outside the portal. Accordingly, in some embodiments, the computer system displays the content presented by the first application within the portal and outside the portal. For example, if the first application includes a media player application, a portion of the content provided by the media player application (e.g., images, video (e.g., movies, television episodes, and/or other video clips), text, and/or three-dimensional objects (e.g., shapes, models, and/or other renderings)) can be displayed within (and/or overlaid on) a virtual portal or boundary associated with the media player application, and another portion of the content provided by the media player application can be displayed in locations outside of the virtual portal or boundary (e.g., beside the virtual portal or boundary, in front of the virtual portal or boundary, and/or behind the virtual portal or boundary) from a viewpoint of the user. In some embodiments, if the first application is presented in a different mode of operation (e.g., a second mode of operation), then the content presented by the first application in the three-dimensional environment is limited to being displayed at locations within the portal. In some embodiments, even in the first mode of operation, some or all content presented by the first application is located within the portal or boundary.

In some embodiments, while displaying the content from the first application presented in accordance with the first mode of operation, the computer system detects (802b), via the one or more input devices, a first user input of a first type, such as input from hand 703a in FIG. 7D. In some embodiments, detecting the first user input of the first type includes interaction with one or more user interface elements in the three-dimensional environment. In some embodiments, the first user input includes selection of the one or more selectable options and/or the user interface object, such as an option to increase immersion level, an option to decrease immersion level, and/or an option to re-center the content in the three-dimensional environment. For example, the computer system detects an air pinch gesture (e.g., in which an index finger and thumb of a hand of the user come together to make contact) directed toward the one or more selectable options and/or the user interface object in the three-dimensional environment (e.g., while attention of the user is directed to a selectable option or a user interface object). In some embodiments, the computer system detects the first user input via a hardware input device (e.g., a controller) in communication with the computer system (e.g., press of a button on the controller). In some embodiments, the first user input has one or more characteristics of inputs described with reference to methods 1000 and/or 1200. In some embodiments, the first user input of the first type corresponds to movement of the user relative to the content from the respective application as described with respect step 806, a request for changing an immersion level as described with respect to step 808, and/or a request for re-centering as described with respect to step 810.

In some embodiments, in response to detecting the first user input of the first type, the computer system changes (802c) a visual appearance of the content from the first application in a first manner, such as increasing level of immersion of content from the first application (e.g., virtual environment 745a in FIG. 7E) (e.g., corresponding to the first user input of the first type). In some embodiments, if the first application is a media playback application and the first user input includes a request to change the immersion level, then the computer system changes the amount of content corresponding to the media playback application displayed within the portal and outside the portal. For example, if the first input includes a request to increase (e.g., or decrease) the immersion level, then the amount of content corresponding to the media playback application displayed within the portal and/or the amount of content displayed outside the portal is optionally increased (e.g., or decreased). In some embodiments, if all content presented by the first application is displayed within the portal based on the first mode of operation, then the computer system changes the amount of content corresponding to the media playback application displayed within the portal in accordance with the request to change the immersion level. In some embodiments, if content from the first application (e.g., virtual environment) is displayed in accordance with the second mode of operation (e.g., no content displayed outside the portal), then the computer system changes the amount of the virtual environment that occupies or is displayed within the portal. For example, if the first input includes a request to increase (e.g., or decrease) the immersion level, then the virtual environment is optionally displayed within the portal with an (e.g., or decreased) immersion level. In some embodiments, as the level of immersion increases or decreases, the portal increases or decreases in size. In some embodiments, a level of immersion includes an associated degree to which a virtual environment or other virtual content displayed by the computer system (e.g., content from the respective application) obscures background content (e.g., the three-dimensional environment including the physical environment) around/behind the virtual environment or the other virtual content, optionally including the number of items of background content displayed and the visual characteristics (e.g., colors, contrast, and/or opacity) with which the background content is displayed, and/or the angular range of the content displayed via the display generation component (e.g., 60 degrees of content displayed at low immersion, 120 degrees of content displayed at medium immersion, and/or 180 degrees of content displayed at high immersion), and/or the proportion of the field of view displayed via the display generation occupied by the virtual environment or the other virtual content (e.g., 33% of the field of view occupied by the virtual environment at low immersion, 66% of the field of view occupied by the virtual environment at medium immersion, and/or 100% of the field of view occupied by the virtual environment at high immersion). In some embodiments, at a first (e.g., high) level of immersion, the background, virtual and/or real objects are displayed in an obscured manner. For example, the content presented by the respective application in the first mode of operation with a high level of immersion is displayed without concurrently displaying the background content (e.g., in a full screen or fully immersive mode). In some embodiments, at a second (e.g., low) level of immersion, the background, virtual and/or real objects are displayed in an obscured manner (e.g., dimmed, blurred, and/or removed from display). For example, the content presented by the respective application in the first mode of operation with a low level of immersion is optionally displayed concurrently with the background content, which is optionally displayed with full brightness, color, and/or translucency. As another example, a virtual environment or the content presented by the respective application in the first mode of operation displayed with a medium level of immersion is optionally displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed.

In some embodiments, after changing the visual appearance of the content from the first application in the first manner, the computer system displays (802d), via the display generation component, content from a second application presented in accordance with the first mode of operation in the three-dimensional environment, such as displaying content from a second application in accordance with a first mode of operation in FIG. 7G, wherein the first mode of operation is a mode in which the second application (e.g., the active application and/or different from the first application) is permitted to display content that is spatially distributed throughout the available display area (e.g., a volume or region that is optionally constrained by a portal or other boundary) of the three-dimensional environment. In some embodiments, the second application includes one or more characteristics of the first application. In some embodiments, the second application is different from the first application.

In some embodiments, while displaying the content from the second application presented in accordance with the first mode of operation, the computer system detects (802e), via the one or more input devices, a second user input of the first type, such as input from hand 703d in FIG. 7G. In some embodiments, the second user input has one or more characteristics of inputs described with reference to methods 1000 and/or 1200. In some embodiments, the second user input of the first type is the same as and/or has one or more of the characteristics of the first user input of the first type.

In some embodiments, in response to detecting the second user input of the first type, the computer system changes (802f) a visual appearance of the content from the second application in the first manner, such as increasing level of immersion of content from the second application (e.g., virtual environment 746a) in FIG. 7H (e.g., corresponding to the second user input of the first type). In some embodiments, if the second application is a gaming application and the second user input includes the request to change the immersion level, then computer system changes the amount of content corresponding to gaming displayed within the portal and outside the portal similarly to and/or in the same way as the change in amount of content corresponding to the media playback application. Similar to and/or in the same way as the manner in which the immersion level corresponding to the media playback application is adjusted, the amount of content corresponding to the gaming displayed within the portal and the amount of content displayed outside the portal is optionally increased (e.g., or decreased). In some embodiments, if all content presented by the second application is displayed within the portal or boundary based on the first mode of operation, then the computer system changes the amount of content corresponding to the gaming application displayed within the portal or boundary in accordance with the request to change the immersion level. In some embodiments, the computer system does not change the visual appearances of the first application and/or the second application in the first manner before receiving the first user input or the second user input. Changing a visual appearance of an application based on the type of input allows different applications to also be adjusted in the same manner according to the type of input without the need for user input to do so, and ensures consistently of interaction between the user and different applications, which reduces errors in interaction, thereby improving user-device interactions.

In some embodiments, while displaying the content from the first application presented in accordance with the first mode of operation, the computer system detects (804a), via the one or more input devices, a third user input of a second type different from the first type, such as input corresponding to movement of the user 706 in FIG. 7C. In some embodiments, the third user input has one or more characteristics of inputs described with reference to methods 1000 and/or 1200. For example, the first user input of the second type corresponds to movement of the user relative to the content from the first application in the three-dimensional environment.

In some embodiments, in response to detecting the third user input of the second type, the computer system changes (804b) a visual appearance of the content from the first application in a second manner different from the first manner, such as changing the visual appearance of the content from the first application in the second manner includes the portal 750a shrinking. In some embodiments, when the computer system changes the visual appearance of the content from the first application in the second manner, the portal or boundary shrinks or appears farther away from the viewpoint of the user as described further with respect to step 806.

In some embodiments, after changing the visual appearance of the content from the first application in the second manner, the computer system displays (804c), via the display generation component, content from the second application presented in accordance with the first mode of operation, such as optionally displaying content from the first application in accordance with the first mode of operation in FIG. 7C (e.g., as described above with respect to step(s) 802).

In some embodiments, while displaying the content from the second application presented in accordance with the first mode of operation, the computer system detects (804d), via the one or more input devices, a fourth user input of the second type, such as input corresponding to movement of the user 706 in FIG. 7C. In some embodiments, the fourth user input has one or more characteristics of inputs described with reference to methods 1000 and/or 1200. In some embodiments, the fourth user input of the second type is the same as and/or has one or more of the characteristics of the third user input of the second type.

In some embodiments, in response to detecting the fourth user input of the second type, the computer system changes (804c) a visual appearance of the content from the second application in the second manner, such as optionally changing the visual appearance of the content from the second application in the second manner includes the portal 750a shrinking. In some embodiments, when the computer system changes the visual appearance of the content from the second application in the second manner, the portal or boundary shrinks or appears farther away from the viewpoint of the user as described further with respect to step 806. In some embodiments, the computer system does not change the visual appearances of the first application and/or the second application in the second manner before receiving the third user input or the fourth user input. Changing a visual appearance of an application based on the type of input allows different applications to also be adjusted in the same manner according to the type of input without the need for user input to do so, and ensures consistently of interaction between the user and different applications, which reduces errors in interaction, thereby improving user-device interactions.

In some embodiments, detecting, via the one or more input devices, the first user input of the first type (and/or the second user input of the first type) includes detecting movement of a viewpoint of a user, such as movement of the viewpoint of the user 706 in FIG. 7C (e.g., the head position and/or orientation of the user has changed) of the computer system relative to the three-dimensional environment (806). For example, the computer system detects that the user holding the electronic device and/or wearing the electronic device gets up from a seated position and/or walks around the physical environment of the three-dimensional environment. In some embodiments, detecting the movement of the electronic device is performed via one or more sensors of the electronic device (e.g., individually or in combination), such as a visible light sensor (e.g., camera), a depth sensor (e.g., time of flight sensor), a gyroscope, an accelerometer, etc.). In some embodiments, based on the user moving relative to the three-dimensional environment, the portal or boundary shrinks or appears farther away from the viewpoint of the user. For example, if the user moves from a first location to a second location different from the first location in the three-dimensional environment, then the boundary is moved away (e.g., retracted) from the second location of the user such that the physical environment around the second location is viewable. In some embodiments, a greater change in movement of the viewpoint results in the boundary moving (e.g., retracting) further away from the viewpoint of the user such that a greater portion of the physical environment is viewable and not obscured (e.g., background, virtual, and/or real objects from the three-dimensional environment are displayed with full brightness, color, and/or opacity). In some embodiments, as the boundary shrinks retracts from the viewpoint of the user, less of the content from a respective application (e.g., the first or second application) is displayed within the boundary compared to outside the boundary. In some embodiments, if the viewpoint moves away to a third location, even further from the original location of the user, the boundary is shifted (e.g., retracted) again and/or even more based on the third location. In some embodiments, if the user moved right relative to the three-dimensional environment, then virtual content (e.g., content from the first application) and/or physical objects from the three-dimensional environment appear to the left of the three-dimensional environment from the viewpoint of the user. In some embodiments, if the user moved left relative to the three-dimensional environment, then virtual content (e.g., content from the first application) and/or physical objects from the three-dimensional environment appear to the right of the three-dimensional environment from the viewpoint of the user. Changing a visual appearance of an application based on detecting movement of a viewpoint of a user relative to the three-dimensional environment allows different applications to also be adjusted in the same manner according to the movement of the viewpoint of the user without the need for user input to do so, and ensures consistently of interaction between the user and different applications, which reduces errors in interaction, thereby improving user-device interactions.

In some embodiments, detecting, via the one or more input devices, the first user input of the first type (and/or the second user input of the first type) includes detecting an input, such as input from hand 703a in FIG. 7D, corresponding to a request to change a level of immersion of the content from the first application (and/or the second application) in the three-dimensional environment (808) (e.g., as described in more detail with reference to method 1000). For example, the computer system increases or decreases the level of immersion of the content from a respective application in response to the request to the change the level of immersion. In some embodiments, as similarly described above, an increase in the level of immersion increases the proportion of the field of view visible via the display generation component that is occupied by the respective three-dimensional environment or content from the respective application. For example, portions of a three-dimensional environment (including the physical environment surrounding the display generation component) in the field of view of the user are obscured (e.g., no longer displayed/visible) when the level of immersion increases for the three-dimensional environment. In some embodiments, a maximum level of immersion includes displaying content from the first application with full immersion (e.g., 360 degrees of content displayed). Additionally, in some embodiments, a decrease in the level of immersion decreases the proportion of the field of view visible via the display generation component that is occupied by the three-dimensional environment or content from the respective application. For example, portions of the three-dimensional environment (including the physical environment surrounding the display generation component) in the field of view of the user are unobscured (e.g., displayed/visible) when the level of immersion decreases for the three-dimensional environment. In some embodiments, a minimum level of immersion includes displaying content from the first application with partial immersion (e.g., 15, 30, or less than 360 degrees of content displayed). Changing a visual appearance of an application based on a request for changing immersion level allows different applications to also be adjusted in the same manner according to the request for changing the immersion level without the need for user input to do so, and ensures consistently of interaction between the user and different applications, which reduces errors in interaction, thereby improving user-device interactions.

In some embodiments, the first user input of the first type is directed to a mechanical input element, such as physical button 741 in FIG. 7D, in communication with the computer system and configured to change the level of immersion of the content from the first application in the three-dimensional environment (810). In some embodiments, the first user input of the first type to change the level of immersion of content from the first application includes a manipulation of a rotational element, such as a mechanical dial or a virtual dial, of or in communication with the computer system. In some embodiments, the magnitude and/or direction of the change in the level of immersion corresponds to the magnitude and/or direction of rotation of the rotational element. In some embodiments, the first user input of the first type includes a selection of a selectable option displayed in the three-dimensional environment and/or a manipulation of a displayed control element to change the immersion level of the content from the first application. In some embodiments, the first user input of the first type includes a predetermined gesture (e.g., an air gesture) recognized as a request to change the immersion level of the content from the first application. For example, the first user input of the first type optionally includes a hand of a user of the computer system performing a pinch air gesture in which the index finger and thumb of the hand of the user come together and touch while attention of the user is directed to the selectable option for changing (e.g., increasing or decreasing) the level of immersion. In some embodiments, the control element is a slider-bar where a finger of the user can contact the slider-bar and manually adjust the immersion level. In another example, attention directed at the slider-bar and an air tap in space followed by movement of the hand of the user optionally causes adjustment of the slider bar for immersion. In another example, attention directed at the slider-bar and an air pinch gesture performed by a hand of the user, followed by movement of the hand while maintaining the air pinch hand shape, optionally causes adjustment of the slider-bar for immersion. Adjusting the level of immersion using a mechanical input element provides for a quick and efficient method of adjusting immersion, which enhances the operability of the computer system and makes the user-device interface more efficient.

In some embodiments, detecting, via the one or more input devices, the first user input of the first type (and/or the second user input of the first type) includes detecting an input corresponding to a request to arrange (e.g., recenter) a plurality of virtual objects (e.g., including content from the first application and/or the second application) in the three-dimensional environment relative to a viewpoint of a user of the computer system (812), such as arranging virtual palette 742 and virtual paintbrush 744a relative to a viewpoint of the user 706 in FIG. 7D in response to optionally detecting input corresponding to rearrange virtual objects in FIG. 7C. The input corresponds to a request to update a spatial arrangement of the plurality of virtual objects relative to the current viewpoint of the user to satisfy a set of one or more criteria that specify a range of distances or a range of orientations of the plurality of virtual objects relative to the current viewpoint of the user, such as a “recentering” input. For example, the input optionally includes detecting a portion of the user's body contacting a surface (e.g., a touch sensitive surface) detected by and/or in communication with the computer system, detecting an air gesture (e.g., an air pinch gesture including contacting of the user's fingers, an air swiping gesture including movement of the user's finger(s) and/or hand(s), an air de-pinch of the user's fingers (e.g., movement of the user's fingers and/or finger tips away from each other), an air first including curling of the user's finger(s), and/or an air pointing gesture including a pointing of a finger) optionally while attention is directed to a respective virtual object or a position in the environment not including virtual content, an actuation of a physical and/or virtual button, and/or movement and/or selections of selectable options (e.g., buttons) detected at a second computer system, such as a stylus or other pointing device. Additionally or alternatively, the plurality of objects are rearranged when virtual object(s) are presenting and/or have presented an apparent spatial conflict (e.g., when a first and a second virtual object occupy an overlapping portion of the three-dimensional environment) for greater than a threshold amount of time (e.g., 0.001, 0.1, 0.1, 1, 10, 100, 500, 1000, or 10000 seconds), and/or when the defined behavior of the virtual object is to proactively arrange itself relative to the user's current viewpoint (e.g., defined by an application developer of content included in the virtual object requesting that the virtual object follows the current user's viewpoint, avoids apparent collisions with other physical and/or virtual objects, and/or proactively arranges itself to improve visibility of the content). The input optionally corresponds to an automatic requesting of the arranging, such as an automatic arranging when the first and/or second one more virtual objects are initially displayed and/or when the user initially begins to view the three-dimensional environment via the display generation component. In some embodiments, the input corresponding to the request to arrange the one or more virtual objects is or includes an input to arrange the virtual objects to satisfy one or more arrangement criteria. In some embodiments, the one or more arrangement criteria include criteria satisfied when an interactive portion of the virtual objects are oriented towards the viewpoint of the user, the virtual objects do not obstruct the view of other virtual objects from the viewpoint of the user, the virtual objects are within a threshold distance (e.g., 10, 20, 30, 40, 50, 100, 200, 300, 400, 500, 1000 or 2000 centimeters) of the viewpoint of the user, the virtual objects are within a threshold angle (e.g., 1, 3, 5, 10, 15, 30, 45, 60, 75, or 85 degrees) relative to a vector extending from the viewpoint of the user (e.g., a center of the user's eyes parallel to a physical ground), and/or the virtual objects are within a threshold distance (e.g., 1, 5, 10, 20, 30, 40, 50, 100, 200, 300, 400, 500, 1000 or 2000 centimeters) of each other. In some embodiments, the input does not specify or define how the virtual objects are moved and/or reoriented other than initiating such movement and/or reorientation. In some embodiments, input includes manually moving the virtual objects in the three-dimensional environment. Changing a visual appearance of an application based on a request for re-centering virtual content allows different applications to also be adjusted in the same manner according to the request for re-centering virtual content without the need for user input to do so, and ensures consistently of interaction between the user and different applications, which reduces errors in interaction, thereby improving user-device interactions.

In some embodiments, changing the visual appearance of the content from the first application (and/or the second application) in the first manner includes changing the visual appearance (e.g., immersion level, brightness, transparency, size, color, and/or location) of the content from the first application (e.g., or second application) in a manner as defined by an operating system of the computer system (814), such as changing the immersion level of the content from the first application as defined by an operating system of the computer system 101 in FIG. 7D (and optionally not defined by the first or second applications). In some embodiments, the visual appearance of the content from a respective application is changed in response to a user input (e.g., first user input of the first type and/or second user input of the first type), where the user input does not define or otherwise indicate how to change the visual appearance of the content from the respective application. Automatically adjusting the visual appearance of the content from a respective application as defined by an operating system of the computer system reduces the number of inputs needed to set the visual appearance of the content from the respective application, thereby improving user-device interactions.

In some embodiments, the computer system displays (816a), via the display generation component, a first virtual environment, such as virtual environment 760a in FIG. 7I. In some embodiments, the first virtual environment represents a simulated physical space. Some examples of the first virtual environment include a lake environment, a mountain environment, a sunset scene, a sunrise scene, a nighttime environment, a grassland environment, and/or a concert scene. In some embodiments, the first virtual environment is based on a real physical location, such as a museum, and/or an aquarium. In some embodiments, the first virtual environment is an artist-designed location. Thus, displaying the first virtual environment optionally provides the user with a virtual experience as if the user is physically located in the first virtual environment. In some embodiments, the first virtual environment serves as a three-dimensional background while simultaneously displaying media content (e.g., movies or television shows), displaying an application user interface (e.g., a photos application or a messages application), and/or presenting or participating in a real-time communication session. In some embodiments, the first virtual environment has one or more characteristics of the environments described with reference to methods 1000 and/or 1200.

In some embodiments, while displaying the first virtual environment, the computer system detects (816b), via the one or more input devices, a third user input of the first type, such as input from hand 703f in FIG. 7I. In some embodiments, the third user input has one or more characteristics of inputs described with reference to methods 1000 and/or 1200. In some embodiments, the third user input of the first type corresponds to movement of the user relative to the three-dimensional environment as described with respect step 806, a request for changing an immersion level as described with respect to step 808, and/or a request for re-centering as described with respect to step 810. In some embodiments, the third user input of the first type has one or more characteristics of the first user input of the first type and/or the second user input of the first type.

In some embodiments, in response to detecting the third user input of the first type, the computer system changes (816c) a visual appearance of the first virtual environment in the first manner, such as increasing the level of immersion of the virtual environment 760a in FIG. 7J. In some embodiments, if the first virtual environment is displayed within the portal (e.g., no portion of the first virtual environment is displayed outside the portal), then the computer system changes the amount of the virtual environment that occupies or is displayed within the portal. For example, if the third input of the first type includes a request to increase (e.g., or decrease) the immersion level, then the virtual environment is optionally displayed within the portal with an (e.g., or decreased) immersion level. In some embodiments, as the level of immersion increases or decreases, the portal increases or decreases in size. For example, if the third input of the first type includes movement of the user relative to the three-dimensional environment, then the portal or boundary shrinks, retracts, or appears farther away from the viewpoint of the user. For example, if the third input of the first type includes a re-centering request, then the computer system optionally moves the first virtual environment and/or corresponding virtual objects such that the first virtual environment and/or corresponding virtual objects appear centered relative the viewpoint of the user. Changing a visual appearance of a virtual environment based on the type of input allows different virtual environments to also be adjusted in the same manner according to the type of input without the need for user input to do so, and ensures consistently of interaction between the user and different applications, which reduces errors in interaction, thereby improving user-device interactions.

In some embodiments, detecting, via the one or more input devices, the first user input of the first type includes detecting an input, such as input from hand 703b in FIG. 7E, corresponding to a request to change a level of immersion of the content from the first application (and/or the second application) to a respective immersion level (818a) (e.g., as described with respect to step 808).

In some embodiments, in response to the first user input of the first type (818b), in accordance with a determination that the first application (and/or the second application) defines an immersion limit of the content from the first application (and/or the second application) as a first range of immersion levels and the respective immersion level is outside the first range of immersion levels, the computer system displays (818c), via the display generation component, the content from the first application (and/or the second application) at a first immersion level within the first range of immersion levels, such as displaying content from the first application at a maximum immersion level in FIGS. 7F and 7F1, wherein the first immersion level is different from the respective immersion level. In some embodiments, the immersion limit of the content from a respective application (e.g., the first range of immersion levels or second range of immersion levels described below) is not defined by user input (e.g., first user input of the first type). In some embodiments, the first range of immersion levels defined by a respective application defines a first maximum immersion level and/or a first minimum immersion level of the content from the respective application. In some embodiments, if the user input corresponds to changing the content from the respective application to a respective immersion level that exceeds the first maximum immersion level, then the computer system displays content from the respective application at the first maximum immersion level despite the user input requesting display of the content from the respective application at the respective immersion level. In some embodiments, if the user input corresponds to changing the content from the respective application to a respective immersion level that is below the first minimum immersion level, then the computer system displays content from the respective application at the first minimum immersion level despite the user input requesting display of the content from the respective application as the respective immersion level. In some embodiments, the first maximum immersion level of the first range of immersion levels includes 30%, 50%, 75%, or 100% of the field of view occupied by the content from the respective application or other virtual content. In some embodiments, the first minimum immersion level of the first range of immersion levels includes 1%, 5%, 10%, or 30% of the field of view occupied by the content from the respective application or other virtual content. In some embodiments, if the user input corresponds to changing the content from the respective application to a respective immersion level that is below the first minimum immersion level, then the computer system ceases display of the content from the respective application. In contrast, in some embodiments, if the user input corresponds to changing the content from the respective application to a respective immersion level that exceeds the first maximum immersion level, then the computer system maintains display of content from the respective application at the first maximum immersion level.

In some embodiments, in response to the first user input of the first type (818b), in accordance with a determination that the first application (and/or the second application) defines the immersion limit of the content from the first application (and/or the second application) as a second range of immersion levels different from the first range of immersion levels, and the respective immersion level is within the second range of immersion levels, the computer system displays (818d), via the display generation component, the content from the first application (and/or the second application) at the respective immersion level, such as optionally displaying content from the first application at a respective immersion level in FIGS. 7F and 7F1 if the respective immersion level is within the range of immersion levels. In some embodiments, the second range of immersion levels defined by a respective application defines a second maximum immersion level and/or a second minimum immersion level of the content from the respective application. In some embodiments, if the user input corresponds to changing the content from the respective application to a respective immersion level that is less than the second maximum immersion level but above the second minimum immersion level, then the computer system displays content from the respective application at the respective immersion level. In some embodiments, the second maximum immersion level of the second range of immersion levels includes 30%, 50%, 75%, or 100% of the field of view occupied by the content from the respective application or other virtual content. In some embodiments, the second minimum immersion level of the second range of immersion levels includes 1%, 5%, 10%, or 30% of the field of view occupied by the content from the respective application or other virtual content. In some embodiments, different applications define their own (optionally different) respective ranges of immersion levels including minimum immersion level and maximum immersion level. For example, both the first application and a second application optionally define the immersion limit of the content from the first application or the second application as the first range of immersion levels. For example, the first application optionally defines the immersion limit of the content from the first application as the first range of immersion levels while the second application optionally defines the immersion limit of the content from the second application as the second range of immersion levels. Automatically adjusting the visual appearance (e.g., immersion level) of the content from a respective application as defined by respective application reduces the number of inputs needed to set the visual appearance of the content from the respective application, thereby improving user-device interactions.

In some embodiments, in response to the first user input of the first type in accordance with the determination that the first application defines the immersion limit of the content from the first application (and/or the second application) as the first range of immersion levels and the respective immersion level is outside the first range of immersion levels, the computer system provides (820) feedback, such as blurring the edges of the portal 750a in FIG. 7F (e.g., haptic, audio and/or visual feedback) that the respective immersion level is outside the first range of immersion levels. In some embodiments, if the user input (e.g., the first user input of the first type or second user input of the first type) corresponds to changing the content from the respective application to a respective immersion level that exceeds the first maximum immersion level of the first range of immersion levels, then the computer system displays a visual indication as described with respect to step(s) 822 and/or outputs an audio indication indicating that the respective immersion level is outside the first range of immersion levels (e.g., exceeds the first maximum immersion level). In some embodiments, if the user input (e.g., the first user input of the first type or second user input of the first type) corresponds to changing the content from the respective application to a respective immersion level that is below the first minimum immersion level of the first range of immersion levels, then the computer system displays a visual indication as described with respect to step(s) 822 and/or outputs an audio indication indicating that the respective immersion level is outside the first range of immersion levels (e.g., below the first minimum immersion level). Displaying information when a request for changing an immersion level is outside a range of immersion levels provides feedback when the request for a respective immersion level is outside maximum or minimum immersion limits and prevents future erroneous user inputs for changing the immersion level, thereby improving user-device interactions.

In some embodiments, the computer system displays (822a), via the display generation component, the visual indication that the respective immersion level is outside the first range of immersion levels includes while detecting the first user input of the first type but before detecting an end of the first user input of the first type (and/or the second user input of the first type), displays (822b), via the display generation component, the content from the first application (and/or the second application) with a first visual appearance, such as displaying a first visual appearance (e.g., transient immersion level) in FIGS. 7F and 7F1. In some embodiments, when the first user input of the first type includes a request for changing the immersion level to a respective immersion level that is outside the first range of immersion levels as described with respect to step 820, the computer system displays the content from the respective application with a transient immersion level different from the first immersion level of the first range of immersion levels. In some embodiments, when the respective immersion level is outside the first range of immersion levels, the computer system displays content from the respective application with the first visual appearance that includes blurring edges, darkening edges, and/or increasing transparency of edges of content from the respective application constrained by the boundary (e.g., portal). In some embodiments, the blurring of edges, darkening of edges, and/or transparency of edges of the content from the respective application increase in magnitude as the input controlling the respective immersion level corresponds to a level of immersion further below the first minimum immersion level or further exceeds the first maximum level. In some embodiments, the first visual appearance is maintained until the end of the first input of the first type. While the first visual appearance is maintained, the first input of the first type includes a pinching air gesture in which a thumb and index finger of the hand are in touching each other (e.g., pinch hand shape) or the hand of the user is air tapping a selectable option for changing the immersion level of the content from the respective application. In some embodiments, the blurriness, darkening, and/or transparency of the edges of content from the respective application constrained by the boundary (e.g., portal) increases as first user input of the first type progresses (e.g., as magnitude of the first user input of the first type increases or as the end of the first user input of the first type is being approached) and optionally the blurriness, darkening, and/or transparency of the edges of content increases by smaller amounts or more slowly relative to the magnitude of the first user input of the first type as the (and/or the more that the) magnitude of the first user input of the first type exceeds the immersion limit.

In some embodiments, in response to detecting the end of the first user input of the first type (and/or the second user input of the first type), the computer system displays (822c), via the display generation component, the content from the first application (and/or the second application) with a second visual appearance, different from the first visual appearance, at the first immersion level, such as optionally displaying a second visual appearance in FIG. 7F after detecting the end of input from hand 703b of FIG. 7E. In some embodiments, the computer system displays an animation (e.g., a gradual animation) of the transition between displaying the respective application from the first visual appearance to the second visual appearance. In some embodiments, after blurring and/or vignetting the boundary and edges of the content displayed from the respective application, the computer displays the content from the respective application at the first immersion level within the first range of immersion levels and/or with a second visual appearance (e.g., edges of content from the respective application are brighter, less blurred, and/or less transparent). In some embodiments, the end of the first input of the first type includes the thumb and index finger of the hand no longer touching each other (e.g., no longer in the pinch hand shape). In some embodiments, the end of the first input of the first type includes the hand of the user no longer in direct interaction with the selectable option for changing the immersion level of the content from the respective application. Blurring or vignetting edges of content from a respective application provides visual feedback that the request for a respective immersion level is outside maximum or minimum immersion limits and prevents future erroneous user inputs for changing the immersion level, thereby improving user-device interactions.

In some embodiments, displaying, via the display generation component, the content from the first application (and/or the second application) includes displaying the content from the first application (and/or the second application) with a first level of immersion and a first visual appearance (824a), such as displaying content from the first application at an immersion level in FIG. 7D (e.g., a first amount of content from the respective application displayed within the portal versus outside the portal, a first brightness, a first transparency, a first size, and/or a first color).

In some embodiments, while displaying the content from the first application (and/or the second application) with the first level of immersion and the first visual appearance, the computer system detects (824b), via the one or more input devices, the first user input of the first type including an input, such as input from hand 703b in FIG. 7E, corresponding to a request to change a level of immersion of the content from the first application (and/or the second application) (e.g., as described with respect to step 808).

In some embodiments, in response to the first user input of the first type, the computer system displays (824c), via the display generation component, the content from the first application (and/or the second application) with a second level of immersion different from the first level of immersion and a second visual appearance, such as the visual appearance in FIGS. 7F and 7F1 (e.g., a second amount of content from the respective application displayed within the portal versus outside the portal, second brightness, a second transparency, a second size, and/or a second color) different from the first visual appearance, wherein changing the visual appearance of the content from the first application (and/or the second application) from the first visual appearance to the second visual appearance includes displaying an animation of an area occupied by the content from the first application in the available display area changing, wherein the animation is defined by an operating system of the computer system (e.g., and optionally not defined by the first application or the second application). In some embodiments, as the level of immersion increases or decreases from the first level of immersion to the second level of immersion, the portal increases or decreases in size (e.g., expands or shrinks) as defined by the operating system of the computer system. For example, as the level of immersion increases, the portal optionally moves closer the viewpoint, and as the level of immersion decreases, the portal optionally moves farther away (e.g., retracts) from the viewpoint of the user. The direction that the portal moves or changes in size optionally corresponds to the direction of change in the level of immersion (e.g., increased immersion corresponding to increased portal size, and decreased immersion corresponding to decreased portal size). In some embodiments, the visual appearance of the content from a respective application is changed in response to a user input (e.g., first user input of the first type or second user input of the first type), where the user input does not define or otherwise indicate how to change the visual appearance of the content from the respective application. Automatically animating (e.g., expanding or shrinking) a boundary constraining content from a respective application when changing a visual appearance of the content according to an operating system of the computer system provides consistency when animating the boundary for different applications and respective content because the animation is defined by the operating system, thereby reducing errors in interaction with the computer system.

In some embodiments, the first user input of the first input includes an input to display a system user interface overlaid on the content from the first application (and/or the second application), and changing the visual appearance of the content from first application (and/or the second application) includes reducing a visual fidelity of the content from the first application (826 (and/or the second application), such as optionally reducing visual fidelity of the virtual environment 745a in FIGS. 7F and 7F1 when displaying user interface 770a. In some embodiments, the system user interface includes one or more controls for displaying available applications on the computer system (e.g., displaying application icons for applications available at the computer system), one or more controls for changing immersion level of content from respective applications, one or more controls for adjusting system settings (e.g., wireless network settings, privacy settings and/or notification settings) for the computer system, and/or one or more selectable options for displaying and/or sharing different corresponding virtual environments. Reducing a visual fidelity of the content from a respective application optionally includes displaying the content from the first application with increased blur, increased transparency, decreased resolution, decreased brightness, reduced size, and/or a different color. Reducing a visual fidelity of the content from a respective applications reduces consumption of computing resources by the computer system when displaying the system user interface and provides visual feedback indicating that the system user interface is the target of interaction, thereby reducing errors in interaction with the computer system. In some embodiments, the first user input of the first type includes an input to change one or more characteristics of a boundary (e.g., portal as described above in step(s) 802) around the available display area for the content from the first application, such as optionally an input to change size of the portal 750b in FIG. 7B, and in response to the first user input of the first type, changing the one or more characteristics of the boundary around the available display area as defined by an operating system of the computer system, such changing portal size 750a in FIG. 7C (and optionally not defined by the first or second applications) in accordance with the first user input of the first type (828). In some embodiments, characteristics of the portal are changed in response to a number of different user inputs (e.g., input to change a size of the portal, input to change immersion optionally beyond an immersion limit, and/or input to move the portal). In some embodiments, the user input indicates the direction and/or the magnitude of the change of the characteristics of the portal; however, the operating system (and optionally not the first or second applications) optionally defines or otherwise indicates how those characteristics change in response to the user input (e.g., defining a minimum or maximum operating system limit on the size of the portal, or defining a minimum or maximum operating system limit on the opacity or translucency of edges of the portal, such as described with reference to step(s) 822). In some embodiments, the operating system of the computer system defines a size (e.g., minimum or maximum size) of the boundary or the portal and/or the transparency of the boundary or the portal. Automatically adjusting characteristics of a portal as defined by an operating system of the computer system provides consistency when adjusting characteristics of the portal when displaying different applications, which reduces errors in interaction with the computer system, thereby improving user-device interactions.

In some embodiments, displaying, via the display generation component, the content from the first application (and/or the second application) includes displaying the content from the first application within a boundary, such as portal 750a in FIG. 7D, around the available display area of the three-dimensional environment (830a) (e.g., a volume or region where the content from first application is displayed is optionally constrained by a portal or other boundary).

In some embodiments, before displaying the content from the first application, the computer system receives (830b), via the one or more input devices, a third user input corresponding to a request to display the content from the first application (and/or the second application), such as an input to display content from the first application prior to displaying the content from the first application in FIG. 7A. In some embodiments, the third user input has one or more characteristics of inputs described with reference to methods 1000 and/or 1200, the first user input of the first type, and/or the second user input of the first type. In some embodiments, the third user input includes a selection of a selectable option displayed in the three-dimensional environment and/or a manipulation of a displayed control element to display content from the first application. For example, the third user input optionally includes a hand of a user of the computer system performing a pinch air gesture in which the index finger and thumb of the hand of the user come together and touch while attention of the user is directed to the selectable option for displaying content from the first application. In another example, the third user input optionally includes an index finger of the hand of the user air tapping the selectable option for displaying content from the first application.

In some embodiments, in response to the third user input, the computer system displays (830c), with a first animation (e.g., a depth-based animation), the boundary around the available display area of the three-dimensional environment and the content from the first application (and/or the second application) within the boundary, such as displaying the portal 750a with an animation in FIGS. 7A-7B. In some embodiments, the computer system displays the boundary (e.g., portal) including the content from the first application with a first animation in response to receiving the third user input. In some embodiments, displaying the boundary with the first animation includes gradually expanding the portal/boundary and/or moving the portal/boundary closer to the viewpoint of the user such that more of the content from the first application is displayed within the portal and/or more of the physical environment is obscured by the content from the first application and/or other virtual content. In some embodiments, the movement of the boundary closer to the viewpoint has one or more characteristics of increasing the level of immersion as described with reference to step(s) 802 and 808. For example, the boundary moving closer to the viewpoint of the user increases the proportion of the field of view visible via the display generation component that is occupied by the content from the first application and/or other virtual content. In some embodiments, the boundary around the available display area of the three-dimensional environment is not displayed with the first animation before receiving the third user input.

In some embodiments, while displaying the content from the first application within the boundary around the available display area of the three-dimensional environment, the computer system receives (830d), via the one or more input devices, a fourth user input corresponding to a request to cease display of the content from the first application, such as optionally receiving an input to cease display of the virtual environment 860a in FIG. 7J. In some embodiments, the fourth user input has one or more characteristics of inputs described with reference to methods 1000 and/or 1200. In some embodiments, the fourth user input has one or more characteristics of the third user input described above. In some embodiments, the fourth user input corresponding to a request to cease display of the content from the first application includes a user input directed to a selectable option that, when selected, causes the electronic device to display content from a second application different from the first application and cease display of the content from the first application. In some embodiments, the fourth user input corresponding to a request to cease display of the content from the first application includes a user input directed to a user interface and/or selectable option outside the displayed content from the first application.

In some embodiments, in response to the fourth user input, the computer system ceases (830e), with a second animation different from the first animation, display of the boundary around the available display area of the three-dimensional environment and the content from the first application within the boundary, such as ceasing display of the portal 750a in FIG. 7L. In some embodiments, the second animation is a depth-based animation. For example, ceasing display of the boundary (e.g., portal) including the content with a second animation optionally includes gradually shrinking the portal and/or moving the boundary away from the viewpoint of the user such that less of the content from the first application is displayed within the portal and/or more of the physical environment is viewable until ceasing display of the portal and/or the content. In some embodiments, the movement of the boundary farther away from the viewpoint (e.g., retracting the portal) has one or more characteristics of decreasing the level of immersion as described with reference to step(s) 802 and 808. For example, the boundary moving farther away from the viewpoint of the user decreases the proportion of the field of view visible via the display generation component that is occupied by the content from the first application and/or other virtual content. In some embodiments, the second animation is not a depth-based animation. For example, ceasing display of the boundary (e.g., portal) including the content from the first application with a second animation optionally includes gradually fading out the boundary and/or the content from the first application until the boundary and/or the content from the first application is no longer visible (e.g., without retracting the boundary from the viewpoint of the user). In some embodiments, the computer system does not cease, with the second animation, displaying the boundary around the available display area of the three-dimensional environment before receiving the fourth user input. Displaying with a first animation a boundary that constrains display of content from the first application but ceasing with a second animation display of the boundary with a second animation provides visual feedback regarding whether a current state includes initiating display of the content from the respective application or ceasing display of the content from the respective application, which reduces errors in interaction with the computer system, and thereby improving user-device interactions.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-9I illustrate examples of a computer system facilitating display of immersive mixed reality (MR) content in a three-dimensional environment in accordance with some embodiments.

FIG. 9A illustrates a computer system 101 (e.g., an electronic device) displaying, via a display generation component (e.g., display generation component 120 of FIG. 1), a three-dimensional environment 902 from a viewpoint of a user 926 (e.g., facing the back wall of the physical environment in which computer system 101 is located, as shown in the overhead view). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user).

As shown in FIG. 9A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 902. For example, three-dimensional environment 902 includes a representation 922a of a coffee table (e.g., corresponding to representation 922b in the overhead view), which is optionally a representation of a physical coffee table in the physical environment.

In FIG. 9A, three-dimensional environment 902 also includes virtual objects 906a (e.g., “Window 1,” corresponding to virtual object 906b in the overhead view) and 908a (e.g., “Window 2,” corresponding to virtual object 908b in the overhead view). In some embodiments, virtual objects 906a and 908a are optionally one or more of user interfaces of applications containing content (e.g., a plurality of selectable options), three-dimensional objects (e.g., virtual clocks, virtual balls, virtual cars, etc.) or any other element displayed by computer system 101 that is not included in the physical environment of display generation component 120. In FIG. 9A, virtual object 906a is optionally a user interface of a web-browsing application. For example, as shown in FIG. 9A, the virtual object 906a includes content (e.g., “website content”), such as text, images, video, hyperlinks, and/or audio content, from the website “www.URL1.com”. Additionally, in FIG. 9A, virtual object 908a is optionally a user interface of an audio playback application. For example, as shown in FIG. 9A, virtual object 908a includes a list 910 of selectable categories of music and a plurality of selectable user interface objects corresponding to a plurality of albums of music. As an example, the list 910 of selectable categories of music is selectable to display albums, songs, and/or artists in an alphabetized manner, a first user interface object (e.g., corresponding to “Album A”) that is selectable to cause the computer system 101 to display one or more songs belonging to “Album A”, and a second user interface object (e.g., corresponding to “Album B”) that is selectable to cause the computer system 101 to display one or more songs belonging to “Album B”.

In some embodiments, in FIG. 9A, the content displayed by the and/or within the virtual objects 906a and 908a are being displayed in a first mode of operation. For example, the content of the virtual objects 906a and 908a discussed above are presented in the three-dimensional environment 902 in a windowed mode, such that the content (e.g., the website content and/or the music content) is confined to being displayed within confines (e.g., boundaries) of the virtual objects 906a and 908a (e.g., content is not displayed in locations in the three-dimensional environment 902 that are outside of (e.g., in front of, behind, or adjacent to) locations of Windows 1 and 2). Accordingly, a portal, as defined herein, of the virtual objects 906a and 908a are limited by the physical confines of the virtual objects 906a and 908a in the three-dimensional environment 902 while the content of the virtual objects 906a and 908a are being displayed in the first mode of operation discussed above. Additional details regarding the display of content in the first mode of operation in the three-dimensional environment 902 are provided below with reference to method 1000.

In FIG. 9A, the computer system 101 detects an input provided by hand 903a corresponding to a request to display system controls for the three-dimensional environment 902. For example, as shown in FIG. 9A, the computer system 101 detects hand 903a provide an air gesture, such as an air pinch gesture in which an index finger and thumb of the hand of the user come together to make contact, while a gaze 921 of the user 926 is directed to a predefined portion of the three-dimensional environment 902. As an example, in FIG. 9A, the predefined portion of the three-dimensional environment 902 is a portion or region of the three-dimensional environment 902 in which the system controls are displayed, such as the upper right edge of the three-dimensional environment 902 in the field of view of the user 926.

In some embodiments, as shown in FIG. 9B, in response to detecting the input provided by the hand 903a in FIG. 9A, the computer system 101 displays toolbar 912 including a plurality of system controls 913 for the three-dimensional environment 902. For example, the plurality of system controls 913 include one or more options for controlling a brightness of display of the three-dimensional environment 902, for controlling a volume of audio content that is being outputted in the three-dimensional environment 902, and/or for causing display of a home screen user interface and/or an applications library of the computer system 101. In some embodiments, as similarly discussed above, the computer system 101 displays the toolbar 912 in the predefined portion of the three-dimensional environment 902. It should be understood that, though the predefined portion is illustrated as being the upper right edge of the three-dimensional environment 902, the predefined portion is alternatively other portions of the three-dimensional environment 902, such as an upper center, a bottom center, and/or an upper left edge of the three-dimensional environment 902.

In some embodiments, as shown in FIG. 9B, when the computer system 101 displays the toolbar 912 including the plurality of system controls 913, the computer system 101 changes a focus of the content of the virtual objects 906a and 908a in the three-dimensional environment 902. For example, as shown in FIG. 9B, the computer system 101 dims, fades, blurs, and/or darkens a display of the user interfaces of the virtual objects 906a and 908a to draw attention of the user 926 toward the plurality of system controls 913 in the three-dimensional environment 902. As discussed in more detail herein later, because the content of the virtual objects 906a and 908a are being displayed in the first mode of operation (e.g., windowed mode) when the plurality of system controls 913 is displayed in the three-dimensional environment 902, the computer system 101 optionally changes the focus of the content in a first manner (e.g., applies a first amount of dimming, fading, blurring, and/or darkening).

In FIG. 9B, the computer system 101 detects an input corresponding to a request to display a virtual environment within the three-dimensional environment 902. For example, as shown in FIG. 9A, the computer system 101 detects selection of physical button 941 or knob or other rotatable input mechanism (e.g., a depressible and rotatable input mechanism) of the computer system 101 provided by hand 903b. In some embodiments, the selection of the physical button 941 includes one or more presses of the physical button 941. In some embodiments, the selection of the physical button 941 includes a press and hold of the physical button 941. In some embodiments, the selection of the physical button 941 includes a rotation/swipe of the physical button 941. In some embodiments, the manner of interaction with the physical button 941 (e.g., the number of presses, the duration of the press and hold, or the amount of rotation) determines an immersion level of the virtual environment that is displayed, which controls an amount (e.g., a percentage) of the three-dimensional environment 902 in the field of view of the user 926 that is occluded by the virtual environment relative to the viewpoint of the user 926.

In some embodiments, in response to detecting the selection of the physical button 941 provided by the hand 903b in FIG. 9B, the computer system 101 displays virtual environment 928 in the three-dimensional environment 902, as shown in FIG. 9C. In some embodiments, displaying the virtual environment 928 includes (optionally displaying an animation of) gradually revealing the virtual environment 928 in the three-dimensional environment 902 based on the immersion level selected by the input in FIG. 9A. For example, the immersion level of the virtual environment 928 is increased from no immersion (e.g., no virtual environment 928 in FIG. 13A), as shown in FIG. 9C, such that the virtual environment 928 occupies a portion of the three-dimensional environment 902 from the viewpoint of the user 926. As shown in the overhead view of FIG. 9C, the virtual environment 928 optionally occupies the portion of the three-dimensional environment 902 that includes the representation of the back wall of the physical environment from the viewpoint of the user 926.

In some embodiments, the virtual environment 928 is a system environment selected for display by the user 926. For example, as shown in FIG. 9C, the virtual environment 928 corresponds to a beach environment during sunset. In some embodiments, the beach environment shown in FIG. 9C was selected for display by the user 926 before display of the virtual environment 928. For example, the beach environment is selected from a library of virtual environments prior to detecting the input for displaying the plurality of system controls 913 in FIG. 9B. Accordingly, in FIG. 9C, the virtual environment 928 is displayed within the three-dimensional environment 902 without detecting input selecting the virtual environment 928 for display.

In some embodiments, as shown in FIG. 9C, when the computer system 101 displays the virtual environment 928 in the three-dimensional environment 902, the computer system 101 maintains display of the virtual objects 906a and 908a in the three-dimensional environment 902. For example, as shown in FIG. 9C, the content of the virtual objects 906a and 908a is concurrently displayed in the three-dimensional environment 902 with the virtual environment 928. In some embodiments, the virtual objects 906a and 908a remain displayed in the three-dimensional environment 902 when the virtual environment 928 is displayed because the content of the virtual objects 906a and 908a is displayed in the first mode of operation discussed above. For example, displaying the user interfaces of the virtual objects 906a and 908a in the windowed mode is compatible with the display of the virtual environment 928 in the three-dimensional environment 902.

In some embodiments, as discussed herein, the computer system 101 provides for displaying immersive MR content in the three-dimensional environment 902. As discussed above, the virtual objects 906a and 908a are optionally displaying content in the first mode of operation (e.g., windowed mode) in the three-dimensional environment 902. In some embodiments, immersive MR content is displayed in the three-dimensional environment 902 in a second mode of operation, different from the first mode of operation, as discussed in more detail below. In FIG. 9C, the computer system 101 detects input provided by the hand 903c corresponding to a request to display immersive MR content in the three-dimensional environment 902. For example, as shown in FIG. 9C, the three-dimensional environment 902 includes a user interface object 911a (e.g., corresponding to user interface object 911b in the overhead view) that is associated with a respective application (e.g., “Application A”). As shown in FIG. 9C, the user interface object 911a optionally includes a selectable option 915 that is selectable for displaying immersive MR content from the respective application in the three-dimensional environment 902. In FIG. 9C, the input provided by the hand 903c optionally corresponds to a selection of the selectable option 915. For example, the computer system 101 detects an air pinch gesture or an air tap or touch gesture performed by the hand 903c while the gaze 921 of the user is directed toward the selectable option 915.

FIG. 9C1 illustrates similar and/or the same concepts as those shown in FIG. 9C (with many of the same reference numbers). It is understood that unless indicated below, elements shown in FIG. 9C1 that have the same reference numbers as elements shown in FIGS. 9A-9I have one or more or all of the same characteristics. FIG. 9C1 includes computer system 101, which includes (or is the same as) display generation component 120. In some embodiments, computer system 101 and display generation component 120 have one or more of the characteristics of computer system 101 shown in FIGS. 9C and 9A-9I and display generation component 120 shown in FIGS. 1 and 3, respectively, and in some embodiments, computer system 101 and display generation component 120 shown in FIGS. 9A-9I have one or more of the characteristics of computer system 101 and display generation component 120 shown in FIG. 9C1.

In FIG. 9C1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 9A-9I.

In FIG. 9C1, display generation component 120 is illustrated as displaying content that optionally corresponds to the content that is described as being displayed and/or visible via display generation component 120 with reference to FIGS. 9A-9I. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 9C1.

Display generation component 120 has a field of view (e.g., a field of view captured by external image sensors 314b and 314c and/or visible to the user via display generation component 120, indicated by dashed lines in the overhead view) that corresponds to the content shown in FIG. 9C1. Because display generation component 120 is optionally a head-mounted device, the field of view of display generation component 120 is optionally the same as or similar to the field of view of the user.

In FIG. 9C1, the user is depicted as performing an air pinch gesture (e.g., with hand 903c) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 9A-9I.

In some embodiments, computer system 101 responds to user inputs as described with reference to FIGS. 9A-9I.

In the example of FIG. 9C1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 9A-9I and/or described with reference to the corresponding method(s) are optionally implemented on computer system 101 and display generation unit 120 in a manner similar or analogous to that shown in FIG. 9C1.

In some embodiments, in response to detecting the input corresponding to the request to display the immersive MR content from the respective application, the computer system transitions to displaying the immersive MR content in the three-dimensional environment 902. In some embodiments, transitioning to displaying the immersive MR content in the three-dimensional environment 902 includes displaying a cross fade between the already-displayed objects in the three-dimensional environment 902 and the immersive MR content, as shown in FIG. 9D. For example, as shown in FIG. 9D, the computer system 101 increases a translucency of the virtual object 906a, the virtual object 908a, and the virtual environment 928 and initiates display of (e.g., fades in display of) immersive MR content 935a (e.g., corresponding to immersive MR content 935b in the overhead view) from the respective application in the three-dimensional environment 902. In some embodiments, as shown in FIG. 9D, because the translucency of the virtual environment 928 increases during the transition to the display of the immersive MR content 935a, portions of the physical environment in the three-dimensional environment 902 that were previously occluded by the virtual environment 928 become (e.g., at least partially) visible again through the virtual environment 928 (e.g., such as the back wall of the physical environment).

Additionally or alternatively, in some embodiments, transitioning to displaying the immersive MR content in the three-dimensional environment 902 includes displaying a visual effect that is based on a gradient of the immersive MR content in the three-dimensional environment 902, as shown in FIG. 9E. For example, as shown in FIG. 9E, the computer system 101 transitions to displaying the immersive MR content from the respective application by displaying a visual effect that is based on a color, brightness, opacity, and/or saturation of the immersive MR content. In some embodiments, as shown in FIG. 9E, the visual effect is displayed overlaid on the portion of the three-dimensional environment 902 in the field of view of the user 926, including the virtual objects 906a and 908a and the virtual environment 928.

In some embodiments, as shown in FIG. 9F, when the computer system 101 completes the transition to displaying the immersive MR content from the respective application, the three-dimensional environment 902 includes the immersive MR content 935a (e.g., corresponding to the immersive MR content 935b in the overhead view). Examples of MR content are provided below with reference to method 1000. In some embodiments, as mentioned above, the computer system displays the immersive MR content 935a in a second mode of operation, different from the first mode of operation discussed previously. For example, the immersive MR content 935a from the respective application (e.g., Application A) discussed above is presented in the three-dimensional environment 902 such that the MR content is confined to being displayed without being confined to a boundary of a window or other container, such as the virtual objects 906a and 908a discussed above (e.g., the MR content is able to be displayed in locations in the three-dimensional environment 902 that are outside of (e.g., in front of, behind, or adjacent to) a portal of the MR content). Accordingly, as shown in FIG. 9F, secondary portions 937a of the immersive MR content extend outside of (e.g., in front of) the portal of the immersive MR content 935a, such that the display of the immersive MR content 935a is not limited by the physical confines of a window or container in the three-dimensional environment 902 while the MR content is being displayed in the second mode of operation discussed above. Additional details regarding the display of content in the second mode of operation in the three-dimensional environment 902 are provided below with reference to method 1000.

In some embodiments, as shown in FIG. 9F, when the computer system 101 displays the immersive MR content 935a in the three-dimensional environment 902, the computer system 101 ceases display of the virtual environment 928 and the virtual objects 906a and 908a in the three-dimensional environment 902. In some embodiments, the computer system 101 ceases displaying the virtual environment 928 and the virtual objects 906a and 908a because the immersive MR content 935a is being displayed in the second mode of operation discussed above. In some embodiments, as similarly discussed above, the second mode of operation is a restricted display mode that restricts concurrent display of the immersive MR content 935a with other virtual objects and/or environments in the three-dimensional environment 902. For example, because portions of the immersive MR content 935a are able to extend beyond the portal of the immersive MR content 935a, such as the secondary portions 937a, while displaying the immersive MR content 935a in the second mode of operation, the computer system 101 ceases display of other virtual objects and/or environments to avoid and/or prevent an occurrence of depth conflict in the three-dimensional environment 902 (e.g., in which portions of the immersive MR content 935a contact and/or intersect with other virtual object and/or environments).

In FIG. 9F, the computer system 101 detects an input corresponding to a request to change an immersion level of the immersive MR content 935a within the three-dimensional environment 902. For example, as shown in FIG. 9F and as similarly described above, the computer system 101 detects selection of physical button 941 or knob or other rotatable input mechanism (e.g., a depressible and rotatable input mechanism) of the computer system 101 provided by hand 903d. In some embodiments, as similarly discussed above with reference to the virtual environment 928, the immersion level of the immersive MR content 935a controls the amount (e.g., a percentage) of the three-dimensional environment 902 in the field of view of the user 926 that is occluded by the immersive MR content 935a relative to the viewpoint of the user 926. For example, the immersion level controls a size of the portal of the immersive MR content 935a in the three-dimensional environment 902. In some embodiments, an amount by which the immersion level is changed in the three-dimensional environment 902 is based on (e.g., is equal to or is proportional to) an amount of rotation of the knob or other rotatable input mechanism discussed above. In some embodiments, whether the immersion level is increased or decreased in the three-dimensional environment 902 is based on a direction of the rotation of the knob or other rotatable input mechanism discussed above. For example, if the input detected by the computer system 101 includes rotation of the knob or other rotatable input mechanism in a first direction, the computer system 101 increases the immersion level of the immersive MR content 935a. In some embodiments, if the input detected by the computer system 101 includes rotation of the knob or other rotatable input mechanism in a second direction, opposite the first direction, the computer system 101 decreases the immersion level of the immersive MR content 935a. In FIG. 9F, the input optionally corresponds to a request to increase the immersion level of the immersive MR content 935a.

In some embodiments, as shown in FIG. 9G, in response to detecting the input provided by the hand 903d corresponding to a request to increase the immersion level of the MR content 935a, the computer system 101 increases the immersion level of the MR content 935a in the three-dimensional environment 902 in accordance with the input. For example, as shown in FIG. 9G, the computer system 101 increases the size of the portal of the immersive MR content 935a in the three-dimensional environment 902, such that a larger amount (e.g., a percentage) of the three-dimensional environment 902 in the field of view of the user 926 is occluded by the immersive MR content 935a relative to the viewpoint of the user 926. In some embodiments, as shown in FIG. 9G, when the computer system 101 increases the level of immersion of the immersive MR content 935a in the three-dimensional environment 902, the computer system 101 displays one or more virtual objects associated with the MR content 935a in the three-dimensional environment 902. For example, in FIG. 9G, the computer system 101 displays a first virtual object 939a (e.g., corresponding to virtual object 939b in the overhead view) and a second virtual object 940a (e.g., corresponding to virtual object 940b in the overhead view) that are associated with the MR content 935a. In some embodiments, as shown in FIG. 9G, like the secondary portions 937a, the display of the first virtual object 939a and the second virtual object 940a is not limited to the portal of the immersive MR content 935a. For example, in FIG. 9G, the first virtual object 939a and the second virtual object 940a are displayed in front of the portal of the immersive MR content 935a in the three-dimensional environment 902.

In FIG. 9G, the computer system 101 detects hand 905 of the user 926 within the three-dimensional environment 902. In some embodiments, while the hand 905 is positioned in the three-dimensional environment 902 (e.g., in the field of view of the user 926), the computer system 101 applies a visual effect to the hand 905 in the three-dimensional environment 902 in accordance with a determination that the immersion level of the immersive MR content 935a is above an immersion threshold (e.g., 20, 25, 30, 45, 50, 60, 70, or 80% immersion), as indicated by threshold 909 in tracker bar 907 of FIG. 9G. As shown in FIG. 9G, the current immersion level of the immersive MR content 935a is below the immersion threshold 909 in the tracker bar 907, so the computer system 101 forgoes applying a visual effect to the hand 905 while the hand is positioned in the three-dimensional environment 902.

In FIG. 9G, the computer system 101 detects an input corresponding to a request to change the immersion level of the immersive MR content 935a within the three-dimensional environment 902. For example, as shown in FIG. 9G and as similarly described above, the computer system 101 detects selection of physical button 941 or knob or other rotatable input mechanism (e.g., a depressible and rotatable input mechanism) of the computer system 101 provided by hand 903e. In FIG. 9G, the input optionally corresponds to a request to increase the immersion level of the immersive MR content 935a in the three-dimensional environment 902.

In some embodiments, as shown in FIG. 9H, in response to detecting the input corresponding to the request to increase the immersion level of the immersive MR content 935a, the computer system 101 increases the immersion level of the immersive MR content 935a in accordance with the input. For example, as shown in FIG. 9H, the computer system 101 increases the immersion level of the immersive MR content 935a to full immersion (e.g., a maximum immersion level for the MR content 935a, which is optionally 100% immersion), such that the three-dimensional environment 902 in the field of view of the user 926 is fully occluded by the immersive MR content 935a relative to the viewpoint of the user 926, as reflected in the overhead view. It should be understood that, in some embodiments, the full immersion level of the immersive MR content 935a is alternatively less than the 100% immersion shown in FIG. 9H. For example, the maximum immersion level of immersive MR content that is displayed in the three-dimensional environment 902 is based on the MR content (e.g., display capabilities of the MR content).

Additionally, in some embodiments, as shown in FIG. 9H, the computer system 101 determines that the immersion level of the immersive MR content 935a exceeds the immersion threshold 909, as indicated in the tracker bar 907. For example, the immersion level exceeds the immersion threshold 909 because the immersion level is full immersion in FIG. 9H, which is greater than the immersion threshold 909, as indicated in the tracker bar 907. Accordingly, as similarly discussed above, because the immersion level of the immersive MR content 935a is above the immersion threshold 909 in FIG. 9H, the computer system 101 applies a visual effect to the portion of the hand 905 that is positioned in the field of view of the user 926 in the three-dimensional environment 902. In some embodiments, applying the visual effect to the portion of the hand 905 includes transposing a virtual representation 938 over the portion of the hand 905 that is positioned in the three-dimensional environment 902, as shown in FIG. 9H. For example, the computer system 101 replaces display of the representation of the hand 905 (e.g., based on a captured image of the hand 905) with the virtual representation 938. In some embodiments, while the visual effect is applied to the hand 905 of the user 926 in the three-dimensional environment 902, detected changes in position of the hand 905 of the user cause the computer system 101 to update display of the visual effect in the three-dimensional environment 902. For example, if the computer system 101 detects movement of the hand 905 in space, which causes a position of the portion of the hand 905 that is in the three-dimensional environment 902 to change, the computer system 101 changes a position of the virtual representation 938 in the three-dimensional environment 902 accordingly.

Additionally or alternatively, in some embodiments, applying the visual effect to the portion of the hand 905 that is positioned in the three-dimensional environment 902 includes displaying a respective virtual object with the portion of the hand 905. For example, the computer system 101 displays a respective virtual object (e.g., similar to the first virtual object 939a and/or the second virtual object 940a) at a location in the three-dimensional environment 902 that is based on the position of the portion of the hand 905. As an example, the computer system 101 places the respective virtual object in a palm of the hand 905 or at a fingertip of the hand 905 in the three-dimensional environment 902. In some embodiments, if the computer system 101 detects a change in immersion level of the immersive MR content 935a that causes the immersion level to decrease below the immersion threshold 909, the computer system 101 ceases applying the visual effect to the portion of the hand 905 in the three-dimensional environment 902.

In FIG. 9H, the computer system 101 detects an input provided by hand 903f corresponding to a request to display system controls for the three-dimensional environment 902. For example, as shown in FIG. 9H, the computer system 101 detects hand 903f provide an air gesture, such as an air pinch gesture in which an index finger and thumb of the hand of the user come together to make contact, while the gaze 921 of the user 926 is directed to the predefined portion of the three-dimensional environment 902 as previously discussed above. As an example, in FIG. 9H, the predefined portion of the three-dimensional environment 902 is a portion or region of the three-dimensional environment 902 in which the system controls are displayed, such as the upper right edge of the three-dimensional environment 902 in the field of view of the user 926, as previously discussed above.

In some embodiments, as shown in FIG. 9I, in response to detecting the input provided by the hand 903f in FIG. 9H, the computer system 101 displays the toolbar 912 including the plurality of system controls 913 for the three-dimensional environment 902 previously discussed above. In some embodiments, as shown in FIG. 9I, when the computer system 101 displays the toolbar 912 including the plurality of system controls 913, the computer system 101 changes a focus of the immersive MR content 935a in the three-dimensional environment 902. For example, as shown in FIG. 9I, the computer system 101 dims, fades, blurs, and/or darkens a display of the immersive MR content 935a, including the first virtual object 939a, the second virtual object 940a, and the virtual representation 938, to draw attention of the user 926 toward the plurality of system controls 913 in the three-dimensional environment 902. In some embodiments, because the immersive MR content 935a is being displayed in the second mode of operation discussed above when the plurality of system controls 913 is displayed in the three-dimensional environment 902, the computer system 101 optionally changes the focus of the MR content in a second manner (e.g., applies a second amount of dimming, fading, blurring, and/or darkening), different from the first manner discussed previously above. For example, in FIG. 9I, when the computer system 101 changes the focus of the immersive MR content 935a that is being displayed in the second mode of operation, the computer system 101 dims, fades, blurs, and/or darkens the MR content by an amount or degree that is less than the dimming, fading, blurring, and/or darkening of the content of the virtual objects 906a and 908a that was displayed in the first mode of operation in FIG. 9B.

Additionally, in some embodiments, when the computer system 101 displays the toolbar 912 in the three-dimensional environment 902, the computer system 101 displays control element 942 that is associated with the respective application displaying the immersive MR content 935a. In some embodiments, as shown in FIG. 9I, the control element 942 includes an exit option 943 that is selectable to close the respective application and cease display of the immersive MR content 935a, including the first virtual object 939a, the second virtual object 940a, and the virtual representation 938, in the three-dimensional environment 902. Additional details regarding the control element 942 and/or exiting the respective application are provided below with reference to methods 1000 and/or 1200.

FIGS. 10A-10J is a flowchart illustrating a method 1000 of facilitating display of immersive mixed reality (MR) content in a three-dimensional environment in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at a computer system (e.g., 101) in communication with a display generation component (e.g., 120) and one or more input devices (e.g., 314). For example, the computer system has one or more characteristics of the computer system described with reference to methods 800 and/or 1200. In some embodiments, the display generation component has one or more characteristics of the display generation component described with reference to methods 800 and/or 1200. In some embodiments, the one or more input devices have one or more characteristics of the one or more input devices described with reference to methods 800 and/or 1200.

In some embodiments, while a three-dimensional environment is visible via the display generation component, the computer system displays (1002a), via the display generation component, a plurality of application containers including application content from different applications displayed in a first mode of operation, such as virtual objects 906a and 908a as shown in FIG. 9A. In some embodiments, content of an application displayed in a first mode of operation is restricted to being displayed in one or more application containers (1002b) (e.g., application windows or other 2D or 3D bounding regions to which content of the application is constrained). In some embodiments, the application containers are spatially distributed (e.g., in three dimensions) throughout the three-dimensional environment based on prior user inputs directed to the application containers independently of interaction with the corresponding applications (1002c) (e.g., inputs placing and/or moving the application containers to their respective locations in the three-dimensional environment and/or inputs launching (e.g., causing display of) the application containers). For example, the three-dimensional environment is generated, displayed, or otherwise caused to be viewable by the computer system (e.g., an extended reality (XR) environment such as a virtual reality (VR) environment, a mixed reality (MR) environment, or an augmented reality (AR) environment). In some embodiments, a physical environment surrounding the display generation component is visible through a transparent portion of the display generation component (e.g., true or real passthrough). In some embodiments, the three-dimensional environment has one or more characteristics of the three-dimensional environments described with reference to methods 800 and/or 1200. In some embodiments, the plurality of application containers is a plurality of virtual objects that is generated by the computer system and/or is or includes content, such as one of a window of a web browsing application displaying content (e.g., text, images, or video), a window displaying a photograph or video clip, a media player window for controlling playback of content items on the computer system, a contact card in a contacts application displaying contact information (e.g., phone number email address, and/or birthday) and/or a virtual boardgame of a gaming application. In some embodiments, the plurality of application containers has one or more characteristics of objects described with reference to methods 800 and/or 1200. In some embodiments, a user interface of an application that is displayed in the first mode is a portal into content associated with and/or provided by the application that is displayed in the first mode (e.g., similar to the herein described portals into simulated and/or virtual environments). For example, a user interface of an application that is displayed in the first mode is optionally a “window virtual object” of the application or a “portal virtual object” of the application, as described with reference to method 800. Accordingly, because the plurality of application containers is displaying content in the first mode of operation, the different applications are a plurality of portals via which their respective content is visible from the viewpoint of the user. In some embodiments, because the applications are operating in the first mode of operation, the content presented by the different applications in the three-dimensional environment is limited to being displayed at locations in the three-dimensional environment corresponding to the plurality of application containers that is displaying content from the different applications (e.g., within the plurality of portals discussed above).

In some embodiments, while displaying the plurality of application containers in the first mode of operation, the computer system detects (1002d), via the one or more input devices, a first input corresponding to a request to display additional application content for a respective application, such as selection of option 921 associated with Application A provided by hand 903c as shown in FIGS. 9C and 9C1. In some embodiments, receiving the first input corresponding to the request to display additional application content for the respective application includes interaction with one or more user interface elements in the three-dimensional environment. For example the three-dimensional environment includes one or more selectable options (e.g., displayed within a toolbar element, an applications window, and/or other object) that are selectable to cause the computer system to display application content from the respective application in the three-dimensional environment. In some embodiments, the three-dimensional environment includes a user interface object that is selectable to cause the computer system to display the additional application content from the respective application in the three-dimensional environment. For example, the user interface object corresponds to an application icon that is selectable to display a user interface associated with the application in the three-dimensional environment, and/or a representation of an image (e.g., a photograph) that is selectable to display the image in the three-dimensional environment. In some embodiments, the input includes selection of the one or more selectable options and/or the user interface object in the three-dimensional environment. For example, the computer system detects an air pinch gesture (e.g., in which an index finger and thumb of a hand of the user come together to make contact) directed toward the one or more selectable options and/or the user interface object in the three-dimensional environment (e.g., while attention of the user is directed to a selectable option or a user interface object). In some embodiments, the computer system detects the first input via a hardware input device (e.g., a controller) in communication with the computer system (e.g., press of a button on the controller). In some embodiments, the respective application is one of the different applications described above that is displaying content in an application container in the first mode of operation. For example, the input corresponds to a request to transition display of the application content to being displayed in a second mode of operation, different from the first mode of operation, which optionally includes displaying additional application content from the respective application in the three-dimensional environment. In some embodiments, the respective application is not one of the different applications described above. For example, the input corresponds to a request to launch and/or open the respective application in the three-dimensional environment, which includes displaying application content from the respective application in the three-dimensional environment, where the application content is being displayed in the three-dimensional environment for the first time (e.g., for the current display session). In some embodiments, the input has one or more characteristics of inputs described with reference to methods 800 and/or 1200.

In some embodiments, in response to detecting the first input, in accordance with a determination that the request is to display the additional application content in a second mode of operation in which content of the respective application is not restricted to being displayed in one or more application containers (1002c), the computer system displays (1002f), via the display generation component, application content for the respective application in the second mode of operation that is spatially distributed (e.g., in three dimensions) throughout the three-dimensional environment and can be repositioned throughout the three-dimensional environment (e.g., in locations that were previously occupied by the plurality of application containers) based on inputs directed to the respective application (e.g., and cannot be repositioned by inputs directed to application containers or cannot be independently repositioned by inputs directed to application containers), such as display of immersive MR content 935a and 937a as shown in FIG. 9F. For example, as similarly described above, the computer system displays content associated with the respective application in the second mode of operation in the three-dimensional environment, wherein the content is displayed in a virtual container or portal and is optionally displayed at locations outside of the virtual container (e.g., in portions of the three-dimensional environment surrounding the virtual container and/or outside of a portal of the respective application). In some embodiments, the content provided by the respective application in the second mode of operation is displayed at the location in the environment that is within the virtual container or portal associated with the respective application in the second mode of operation before or after content for the respective application is displayed at the location in the three-dimensional environment that is outside the virtual container or portal. For example, when the application content is displayed, the content need not be concurrently displayed with content for the respective application at locations outside the virtual container or portal. In some embodiments, the content provided by the respective application in the second mode of operation is concurrently displayed with content at locations outside the virtual container or portal. In some embodiments, the locations outside the virtual container or portal correspond to portions of the three-dimensional environment in which the physical environment of the user is visible. In some embodiments, the content associated with the respective application in the second mode of operation corresponds to a virtual video game experience. In some embodiments, the content associated with the respective application in the second mode of operation corresponds to two-dimensional content (e.g., user interfaces including images, video, text, selectable options, and/or models) that is displayed in a virtual environment. For example, the content includes a virtual rendering of a live performance of a play that is performed in a virtual theater or a virtual rendering of a concert performance in a virtual stadium. In some embodiments, while the application content for the respective application is displayed in the second mode of operation in the three-dimensional environment, the application content is able to be moved within the three-dimensional environment (e.g., via an input for changing the spatial distribution of the application content in the three-dimensional environment) but individual elements (e.g., virtual objects) of the application content are not able to be moved relative to each other without interacting with the respective application. For example, the portal of the application content in the second mode of operation cannot be moved individually without interacting with (e.g., moving) the application content as well. In some embodiments, while the application content for the respective application is displayed in the second mode of operation in the three-dimensional environment, the application content is able to be scaled within the three-dimensional environment (e.g., via an input for changing a size of the application content in the three-dimensional environment) but individual elements (e.g., virtual objects) of the application content are not able to be scaled relative to each other without interacting with the respective application. For example, the portal of the application content in the second mode of operation cannot be scaled individually without interacting with (e.g., scaling) the application content as well.

In some embodiments, the computer system ceases (1002g) display of the plurality of application containers including the application content from the different applications, such as ceasing display of virtual objects 906a and 908a as shown in FIG. 9F. In some embodiments, the application content associated with the respective application is displayed in the second mode of operation in the three-dimensional environment that includes or does not include locations at which the plurality of application containers was displayed in the three-dimensional environment. For example, the content associated with the respective application is displayed in the second mode of operation in place of one or more of the plurality of application containers when the plurality of application containers ceases to be displayed or the content associated with the respective application is displayed in the second mode of operation at one or more locations that do not correspond to (e.g., do not overlap with) the locations of the plurality of application containers (when the plurality of application containers were displayed). In some embodiments, when the computer system ceases display of the plurality of application containers, the computer system closes (e.g., ceases operating) the different applications that were displaying content in the first mode of operation. In some embodiments, when the computer system ceases display of the plurality of application containers, the computer system maintains a context or progress of the content included in the plurality of application containers (e.g., the images displayed, the video being played back, and/or the text or websites displayed), so that if/when the plurality of application containers is redisplayed in the three-dimensional environment (e.g., at a later time, such as when the application content for the respective application is no longer displayed), the context or progress of the content is preserved and the content is reinstated in the plurality of application containers. Ceasing display of objects in a first mode of operation in which display of content is limited to locations of the objects in a three-dimensional environment when content is displayed in a second mode of operation in which the display of content is not limited to a location of the corresponding object in the three-dimensional environment facilitates discovery that an object is displayed in the second mode of operation in the three-dimensional environment, and/or avoids or reduces potential depth conflict that can be encountered between content of the application that is displayed in the second mode of operation and one or more of the objects that are displayed in the first mode of operation when the object is displayed in the second mode of operation in the three-dimensional environment, thereby improving user-device interaction.

In some embodiments, in response to detecting the first input, in accordance with a determination that the request is to display the additional application content in the first mode of operation in which content of the respective application is restricted to being displayed in one or more application containers, the computer system displays (1004), via the display generation component, a respective object (e.g., a virtual window or portal including content) associated with the respective application in the three-dimensional environment (e.g., the computer system displays a virtual window or portal that includes content from the respective application that is displayed in the first mode of operation in the three-dimensional environment, without displaying the content in locations of the three-dimensional environment that are outside of the virtual window, as similarly described above with reference to step(s) 1002. In some embodiments, the content is similar to the exemplary content discussed above with reference to the plurality of application containers associated with the different applications that are displayed in the first mode of operation), while maintaining display of the plurality of application containers from the different applications displayed in the first mode of operation, as similarly described with reference to FIG. 9F. For example, the computer system concurrently displays the respective object associated with the respective application in the first mode of operation and the plurality of application containers associated with the different applications in the first mode of operation in the three-dimensional environment. Maintaining display of objects in a first mode of operation in which display of content is limited to locations of the objects in a three-dimensional environment when an object is displayed in the first mode of operation in the three-dimensional environment enables the user to concurrently view the objects displayed in the first mode of operation in the three-dimensional environment, which enables the user to interact with the objects in the three-dimensional environment while avoiding or reducing potential depth conflict that can be encountered between one or more of the objects that are displayed in the first mode of operation, thereby improving user-device interaction.

In some embodiments, while displaying the application content for the respective application in the second mode of operation in accordance with the determination that the request is to display the additional application content in the second mode of operation in response to detecting the first input (1006a), in accordance with a determination that a portion of a physical environment of the display generation component (and/or of the user) is not occluded by the application content, the portion of the physical environment of the display generation component (and/or of the user) is visible relative to a viewpoint of the user (1006b), such as portion of coffee table 922a that is not occluded by immersive MR content 937a in three-dimensional environment 902 as shown in FIG. 9F. For example, as similarly described above with reference to step(s) 1002, the three-dimensional environment includes a portion of the physical environment of the user (e.g., and the computer system) that is visible as passthrough via a transparent or translucent portion of the display generation component. In some embodiments, when the application content for the respective application is displayed in the three-dimensional environment, if the portion of the three-dimensional environment that is not occupied by the application content (e.g., portions of the three-dimensional environment surrounding the application content and/or in front of the application content) includes portions of the physical environment, those portions of the physical environment remain visible in the three-dimensional environment while the application content is displayed. In some embodiments, in accordance with a determination that the portion of the physical environment of the display generation component that is visible in the three-dimensional environment is occluded by the application content, the portion of the physical environment of the display generation component is not visible relative to the viewpoint of the user. Allowing a portion of a physical environment of a three-dimensional environment that is not occluded by content that is displayed in a second mode of operation to remain visible in the three-dimensional environment visually facilitates a spatial understanding of the content relative to the physical environment, and/or enables the user to maintain a spatial understanding the physical environment relative to the viewpoint of the user, which helps avoid unintentional physical contact or conflict with the physical environment, thereby improving user-device interaction.

In some embodiments, displaying content of an application displayed in the first mode of operation that is restricted to being displayed in one or more application containers includes restricting display of the content to one or more predefined locations in the three-dimensional environment (1008), such as locations of the virtual objects 906a and 908a as shown in FIG. 9A. For example, as similarly described above with reference to step(s) 1002, the content that is displayed in the first mode of operation is constrained to being displayed within the one or more application containers. In some embodiments, the one or more predefined locations correspond to one or more locations (and/or areas and/or volumes) of the one or more application containers in the three-dimensional environment. For example, displaying the content at the one or more predefined locations of the three-dimensional environment includes displaying the content in and/or on the one or more application containers (e.g., within a window or on a surface of the window). In some embodiments, the display of the application content from the respective application in the second mode of operation is not restricted to a predefined location in the three-dimensional environment. For example, the application content that is displayed in the second mode of operation is able to be displayed at a first location that corresponds to a location of the one or more predefined locations at which the content of the application displayed in the first mode of operation is restricted, but also a second location that is not one of the one or more predefined locations Constraining display of content to predefined locations in a three-dimensional environment when the content is displayed in a first mode of operation in the three-dimensional environment helps reduce clutter in the field of view of the user while the content is being displayed in the first mode of operation, and/or avoids or reduces potential depth conflict that can be encountered between one or more of the objects that are displayed in the first mode of operation in the three-dimensional environment, thereby improving user-device interaction.

In some embodiments, displaying the application content for the respective application in the second mode of operation that is spatially distributed throughout the three-dimensional environment in accordance with the determination that the request is to display the additional application content in the second mode of operation in response to detecting the first input includes (1010a) displaying at least a first portion of the application content within a respective object occupying a first location (and/or area and/or volume) in the three-dimensional environment (1010b), such as display of immersive MR content 935a within a portal as shown in FIG. 9F. For example, at least a first portion of the application content is displayed within a portal of the respective application at the first location in the three-dimensional environment, as similarly described above with reference to step(s) 1002.

In some embodiments, the computer system displays a second portion of the application content (e.g., different from the at least the first portion of the application content) at a second location (and/or area and/or volume), different from the first location, that is outside the respective object in the three-dimensional environment (1010c), such as display of immersive MR content 937a outside of the portal as shown in FIG. 9F. For example, as similarly described above with reference to step(s) 1002, the second portion of the application content is displayed at a location in the three-dimensional environment that is outside of a boundary of the portal of the respective application. In some embodiments, the second location is in front of the first location in the three-dimensional environment relative to the viewpoint of the user. In some embodiments, the second location is to a side of (e.g., to the left or to the right of) of the first location in the three-dimensional environment relative to the viewpoint of the user. In some embodiments, the second location is above or below the first location in the three-dimensional environment relative to the viewpoint of the user. Forgoing constraining display of content to predefined locations in a three-dimensional environment when the content is displayed in a second mode of operation in the three-dimensional environment facilitates discovery that an object is displayed in the second mode of operation in the three-dimensional environment, and/or enhances user experience of the content displayed in the second mode of operation, thereby improving user-device interaction.

In some embodiments, while displaying the application content for the respective application in the second mode of operation that is spatially distributed throughout the three-dimensional environment in accordance with the determination that the request is to display the additional application content in the second mode of operation in response to detecting the first input, the application content occupies an entirety of a field of view of a user of the computer system from a viewpoint of the user in the three-dimensional environment (1012), such as immersive MR content occupying the field of view of the user 926 as shown in FIG. 9H. For example, when the application content for the respective application is displayed in the second mode of operation, the application content is displayed over the portion of the three-dimensional environment that is displayed in the user's field of view, including a physical environment of the display generation component that would otherwise be visible in the portion of the three-dimensional environment. In some embodiments, when the application content occupies the entirety of the field of view of the user of the computer system, the application content occupies an entirety of a standard field of view of a human (e.g., range of the physical world observed through the human eye). In some embodiments, when the application content occupies the entirety of the field of view of the user of the computer system, the occupancy of the entirety of the field of view of the user of the computer system is based on a full (e.g., maximum) angular amount/extent of content that is able to be displayed via the display generation component. In some embodiments, while the application content for the respective application is displayed in the second mode of operation in the three-dimensional environment, no portion of the physical environment of the display generation component is visible in the field of view of the user in the three-dimensional environment relative to the viewpoint of the user. In some embodiments, the application content from the respective application occupies a plurality of locations at which the plurality of application containers were displayed prior to displaying the application content. Enabling display of content in a three-dimensional environment that consumes the field of view of the user when the content is displayed in a second mode of operation in the three-dimensional environment facilitates discovery that an object is displayed in the second mode of operation in the three-dimensional environment, and/or avoids or reduces potential depth conflict that can be encountered between the content of the application that is displayed in the second mode of operation and one or more physical objects that would otherwise be visible in the three-dimensional environment, thereby improving user-device interaction.

In some embodiments, displaying the application content for the respective application in the second mode of operation that is spatially distributed throughout the three-dimensional environment includes (1014a) displaying at least a first portion of the application content within a respective object that occupies a first location in the three-dimensional environment (1014b) (e.g., at least a first portion of the application content is displayed within a portal of the respective application at the first location in the three-dimensional environment, as similarly described above with reference to step(s) 1002), and displaying a first virtual object associated with the application content within the respective object (1014c), such as virtual object 939a as shown in FIG. 9G. For example, displaying the application content includes displaying one or more virtual objects associated with the application content in the three-dimensional environment. In some embodiments, the one or more virtual objects, including the first virtual object, correspond to selectable options, text, images, or other two-dimensional content or three-dimensional shapes, models, renderings, or other three-dimensional content that is provided for display by the respective application. In some embodiments, the one or more virtual objects are configured to be displayed within the portal of the respective application as well as outside a boundary of the portal in the three-dimensional environment.

In some embodiments, while displaying the application content for the respective application in the second mode of operation that is spatially distributed throughout the three-dimensional environment, the computer system detects (1014d) that a respective event has occurred, such as selection of button 941 provided by hand 903e as shown in FIG. 9G. For example, the computer system receives display data provided by the respective application corresponding to a request to update display of the application content for the respective application. In some embodiments, the request to update display of the application content for the respective application corresponds to a request to change a position of the first virtual object in the three-dimensional environment. In some embodiments, detecting the respective event has occurred includes detecting user input. For example, the computer system detects a selection of the first virtual object in the three-dimensional environment (e.g., via an air pinch gesture or hardware-based input as similarly discussed above with reference to step(s) 1002). In some embodiments, the computer system detects an input corresponding to a request to change (e.g., increase) an immersion level of the application content in the three-dimensional environment, as discussed in more detail below with reference to step(s) 1016-1020.

In some embodiments, in response to detecting the respective event (1014c), the computer system displays (1014f), via the display generation component, the first virtual object associated with the application content at a second location, different from the first location, that is outside the respective object in the three-dimensional environment, such as display of virtual object 940a as shown in FIG. 9H. In some embodiments, the second location is in front of the first location in the three-dimensional environment relative to the viewpoint of the user. In some embodiments, the second location is to a side of (e.g., to the left or to the right of) of the first location in the three-dimensional environment relative to the viewpoint of the user. In some embodiments, the second location is above or below the first location in the three-dimensional environment relative to the viewpoint of the user. In some embodiments, while displaying the application content in the three-dimensional environment, in response to detecting the respective event discussed above, the first virtual object is transitioned from being displayed within the respective object to being displayed outside of the respective object in the three-dimensional environment. In some embodiments, displaying the first virtual object at the second location in the three-dimensional environment includes displaying an animation of the movement of the first virtual object from within the respective object (e.g., the portal) to the second location that is outside the respective object in the three-dimensional environment. Transitioning display of a virtual object associated with an application that is displayed in a portal of the application in a second mode of operation in which display of the content is not limited to predefined locations in a three-dimensional environment to displaying the virtual object outside the portal facilitates discovery that the virtual object is displayed in the second mode of operation in the three-dimensional environment, and/or enhances user experience of the virtual object displayed in the second mode of operation, thereby improving user-device interaction.

In some embodiments, the application content for the respective application is displayed in the second mode of operation at a first level of immersion in response to detecting the first input (1016a), such as the immersion level of the immersive MR content 935a in FIG. 9F (e.g., a level of immersion includes an associated degree to which the application content displayed by the computer system obscures background content (e.g., the three-dimensional environment including the portion of the physical environment) around/behind the application content while displayed in the second mode of operation, optionally including the number of items of background content displayed and the visual characteristics (e.g., colors, contrast, and/or opacity) with which the background content is displayed, and/or the angular range of the content displayed via the display generation component (e.g., 60 degrees of content displayed at low immersion, 120 degrees of content displayed at medium immersion, and/or 180 degrees of content displayed at high immersion), and/or the proportion of the field of view displayed via the display generation occupied by the application content (e.g., 33% of the field of view occupied by the application content at low immersion, 66% of the field of view occupied by the application content at medium immersion, and/or 100% of the field of view occupied by the application content at high immersion). In some embodiments, at a first (e.g., high) level of immersion, the background, virtual and/or real objects are displayed in an obscured manner. For example, a respective content with a high level of immersion is displayed without concurrently displaying the background content (e.g., in a full screen or fully immersive mode). In some embodiments, at a second (e.g., low) level of immersion, the background, virtual and/or real objects are displayed in an obscured manner (e.g., dimmed, blurred, and/or removed from display). For example, application content with a low level of immersion is optionally displayed concurrently with the background content, which is optionally displayed with full brightness, color, and/or translucency. As another example, application content displayed with a medium level of immersion is optionally displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, the level of immersion controls a size of the portal of the application content for the respective application).

In some embodiments, while displaying the application content for the respective application in the second mode of operation that is spatially distributed throughout the three-dimensional environment, the computer system detects (1016b), via the one or more input devices, a second input including manipulation of one or more system controls of the computer system that corresponds to a request to change a level of immersion of the application content for the respective application, such as selection of button 941 provided by hand 903d as shown in FIG. 9F. In some embodiments, the request to change the level of immersion of the application content includes a manipulation of a rotational element, such as a mechanical dial or a virtual dial, of or in communication with the computer system. In some embodiments, the manipulation of the rotational element includes a physical press and/or scroll of the rotational element by a finger of the user. In some embodiments, rotation of the rotational element in a first direction (e.g., a clockwise direction) corresponds to a request to increase the level of immersion of the application content. In some embodiments, rotation of the rotational element in a second direction (e.g., a counterclockwise direction), opposite the first direction, corresponds to a request to decrease the level of immersion of the application content. In some embodiments, a magnitude of the rotation (e.g., an angular rotation) of the rotational element controls an amount by which the computer system changes the level of immersion of the application content. For example, the amount by which the computer system increases or decreases the level of immersion of the application content is based on (e.g., is proportional to) the angular amount that the rotational element is rotated. In some embodiments, the second input includes a selection of a selectable option displayed in the three-dimensional environment and/or a manipulation of a displayed control element to change the immersion level of the computer system and/or the application content. In some embodiments, the second input includes a predetermined gesture (e.g., an air gesture) recognized as a request to change the immersion level of the computer system and/or the application content.

In some embodiments, in response to detecting the second input (1016c), the computer system displays (1016d), via the display generation component, the application content for the respective application at a second level of immersion, different from the first level of immersion, within the three-dimensional environment in accordance with the second input, such as increasing the level of immersion of the immersive MR content 935a as shown in FIG. 9G. For example, the computer system increases or decreases the level of immersion of the computer system and/or the application content (e.g., increases or decreases the size of the portal of the respective application in the three-dimensional environment). In some embodiments, as similarly described above, an increase in the level of immersion increases the proportion of the field of view visible via the display generation that is occupied by the application content. For example, additional portions of the three-dimensional environment (including the physical environment surrounding the display generation component) in the field of view of the user are obscured (e.g., no longer displayed/visible) when the level of immersion increases for the application content (e.g., because the size of the portal of the respective application increases and/or more of the application content is displayed in the three-dimensional environment in the field of view). Additionally, in some embodiments, a decrease in the level of immersion decreases the proportion of the field of view visible via the display generation component that is occupied by the application content. For example, additional portions of the three-dimensional environment (including the physical environment surrounding the display generation component) in the field of view of the user are unobscured (e.g., displayed/visible) when the level of immersion decreases for the application content (e.g., because the size of the portal of the respective application decreases and/or less of the application content is displayed in the three-dimensional environment in the field of view). In some embodiments, changing the level of immersion of the application content to the second level of immersion in the three-dimensional environment includes updating display of one or more virtual objects associated with the application content. For example, as previously discussed above with reference to step(s) 1014, displaying the application content includes displaying one or more virtual objects in the three-dimensional environment, optionally within the portal of the respective application and/or outside of the portal of the respective application. In some embodiments, displaying the application content at the second level of immersion causes a number of the one or more virtual objects to change (e.g., additional or fewer or alternative virtual objects are displayed in the three-dimensional environment) and/or causes the one or more virtual objects to be displayed at different locations in the three-dimensional environment (e.g., a respective virtual object is moved from within the portal to outside the portal if the immersion level increases or vice versa if the immersion level decreases). Changing a level of immersion of content that is displayed in a three-dimensional environment in response to user input enables an amount of the content that is displayed in a field of view of the user to be selectively changed and prevents conflict between the content and other portions of the three-dimensional environment, thereby improving user-device interaction and experience.

In some embodiments, a first portion (e.g., a first hand) of a user of the computer system is positioned within the three-dimensional environment relative to the viewpoint of the user and is visible in the three-dimensional environment when the second input is detected (1018a), such as hand 905 as shown in FIG. 9G (e.g., the second input is provided by a second hand, different from the first hand, of the user while the first hand is positioned within the three-dimensional environment in the field of view of the user relative to the viewpoint, such that the first hand is visible via the display generation component or a representation of the first hand is visible via the display generation component). In some embodiments, while the first portion of the user is visible in the three-dimensional environment, a size and/or shape of the first portion of the user (e.g., and/or the representation of the first portion of the user) is not determined and/or controlled by the respective application in the three-dimensional environment.

In some embodiments, in response to detecting the second input (1018b), in accordance with a determination that displaying the application content at the second level of immersion causes the level of immersion of the application content to exceed a threshold immersion level (e.g., 20, 25, 30, 35, 40, 45, 50, 60, 75, or 90% immersion), represented by threshold 909 in FIG. 9H, the computer system applies (1018c) a visual effect to the first portion of the user that causes the first portion of the user to be displayed as a respective virtual representation, different from a representation of the first portion of the user, in the three-dimensional environment relative to the viewpoint of the user, such as displaying virtual object 938 overlaid over the hand 905 as shown in FIG. 9H. For example, the computer system displays a virtual representation associated with the application content, such as a virtual object (e.g., a three-dimensional object, shape, model, or rendering), at a location in the three-dimensional environment that corresponds to a location of the first portion of the user (e.g., the hand of the user) in the three-dimensional environment, such that the virtual representation visually appears to replace (e.g., or consume or occupy) the first portion of the user relative to the viewpoint of the user. In some embodiments, the computer system updates display of the virtual representation in the three-dimensional environment based on movement of the first portion of the user within the three-dimensional environment relative to the viewpoint of the user. For example, if the computer system detects the hand of the user move leftward or rightward in the three-dimensional environment relative to the viewpoint of the user, the computer system updates a location at which the virtual representation is displayed in the three-dimensional environment and moves the virtual representation leftward or rightward relative to the viewpoint of the user in accordance with the movement of the hand, such that the virtual representation continues to visually appear to replace the first portion of the user relative to the viewpoint of the user. In some embodiments, if the computer system detects the hand of the user move upward or downward in the three-dimensional environment relative to the viewpoint of the user, the computer system updates the location at which the virtual representation is displayed in the three-dimensional environment and moves the virtual representation upward or downward relative to the viewpoint of the user in accordance with the movement of the hand, optionally changing a size of the virtual representation to account for any changes in an amount of the hand of the user that is positioned within the three-dimensional environment as a result of the upward or downward hand movement. As another example, if the computer system detects the hand of the user move toward or away from the viewpoint of the user in the three-dimensional environment relative to the viewpoint, the computer system optionally updates the location at which the virtual representation is displayed in the three-dimensional environment and moves the virtual representation toward or away from the viewpoint of the user in accordance with the movement of the hand, optionally changing a size of the virtual representation to account for increases or decreases in size of the hand relative to the viewpoint as the hand is moved toward or away from the viewpoint. In some embodiments, while the visual effect is applied to the first portion of the user in the three-dimensional environment, a shape and/or size of the respective virtual representation is determined and/or controlled by the respective application (e.g., the respective virtual representation is considered a portion of the content that is associated with the respective application in the three-dimensional environment). In some embodiments, the threshold immersion is relative to a maximum immersion level for the application content. For example, the maximum immersion level for the application content for the respective application is not necessarily full/high immersion (e.g., 100% immersion in which 100% of the field of view of the user is occupied by the application content, as similarly described above with reference to step(s) 1016). Accordingly, in some embodiments, the threshold immersion percentages provided above are relative to the maximum immersion level for the application content (e.g., a 50% immersion threshold for content that has a 75% maximum immersion level corresponds to 50% of 75%, or 37.5% of the maximum immersion level). In some embodiments, in accordance with a determination that displaying the application content at the second level of immersion does not cause the level of immersion of the application content to exceed the threshold immersion, the computer system forgoes applying the visual effect to the first portion of the user, and the first portion of the user and/or the representation of the first portion of the user remains visible in the three-dimensional environment. Applying a visual effect to a first portion of the user when a level of immersion of content that is displayed in a three-dimensional environment is increased above an immersion threshold enables the visual effect to be applied to the first portion of the user automatically, which helps reduce or avoid potential depth conflict between the first portion of the user and the content in the three-dimensional environment, and/or facilitates discovery that increasing the level of immersion of the content above the immersion threshold causes the visual effect to be applied to the first portion of the user, thereby improving user-device interaction and experience.

In some embodiments, a first portion (e.g., a first hand) of a user of the computer system is positioned within the three-dimensional environment relative to the viewpoint of the user when the second input is detected (1020a) (e.g., the second input is provided by a second hand, different from the first hand, of the user while the first hand is positioned within the three-dimensional environment in the field of view of the user relative to the viewpoint, such that the first hand is visible via the display generation component or a representation of the first hand is visible via the display generation component), such as the hand 905 as shown in FIG. 9G.

In some embodiments, in response to detecting the second input (1020b), in accordance with a determination that displaying the application content at the second level of immersion causes the level of immersion of the application content to exceed a threshold immersion level (e.g., 20, 25, 30, 35, 40, 45, 50, 60, 75, or 90% immersion), the computer system applies (1020c) a visual effect to the first portion of the user that causes the first portion of the user to be concurrently displayed with a respective virtual object (e.g., virtual object 938 in FIG. 9H) in the three-dimensional environment, wherein the respective virtual object is displayed based on a position of the first portion of the user relative to the viewpoint of the user. For example, the computer system displays a respective virtual object associated with the application content, such as a three-dimensional object, shape, model, or rendering associated with the application content, at a location in the three-dimensional environment that is based on a location of the first portion of the user (e.g., the hand of the user) in the three-dimensional environment, such that the respective virtual object visually appears to be displayed relative to the first portion of the user (e.g., in a palm of the hand, at a fingertip of the hand, hovering above the hand, and/or hanging below the hand (e.g., attached to a finger of the hand)) relative to the viewpoint of the user. In some embodiments, the computer system updates display of the respective virtual object in the three-dimensional environment based on movement of the first portion of the user within the three-dimensional environment relative to the viewpoint of the user. For example, if the computer system detects the hand of the user move leftward or rightward in the three-dimensional environment relative to the viewpoint of the user, the computer system updates a location at which the respective virtual object is displayed in the three-dimensional environment and moves the respective virtual object leftward or rightward relative to the viewpoint of the user in accordance with the movement of the hand, such that the respective virtual object continues to visually appear to be displayed with the first portion of the user relative to the viewpoint of the user. In some embodiments, if the computer system detects the hand of the user move upward or downward in the three-dimensional environment relative to the viewpoint of the user, the computer system updates the location at which the respective virtual object is displayed in the three-dimensional environment and moves the respective virtual object upward or downward relative to the viewpoint of the user in accordance with the movement of the hand. As another example, if the computer system detects the hand of the user move toward or away from the viewpoint of the user in the three-dimensional environment relative to the viewpoint, the computer system optionally updates the location at which the respective virtual object is displayed in the three-dimensional environment and moves the respective virtual object toward or away from the viewpoint of the user in accordance with the movement of the hand, optionally changing a size of the respective virtual object to account for increases or decreases in size of the hand “holding” the respective virtual object relative to the viewpoint as the hand is moved toward or away from the viewpoint. In some embodiments, while the visual effect is applied to the first portion of the user in the three-dimensional environment, a shape and/or size of the respective virtual object is determined and/or controlled by the respective application (e.g., the respective virtual object is considered a portion of the content that is associated with the respective application in the three-dimensional environment). In some embodiments, the display of (e.g., a behavior of) the respective virtual object in the three-dimensional environment obeys one or more real-world laws of physics the are applied virtually to (e.g., simulated by the computer system for display of) the respective virtual object. For example, if the computer system detects an input provided by the hand corresponding to a throwing/tossing motion, the computer system updates display of the respective virtual object such that the respective virtual object visually appears to have been thrown or tossed in a respective direction and/or with a respective magnitude (e.g., of speed or distance) that is based on the input. In some embodiments, the threshold immersion is relative to a maximum immersion level for the application content, as similarly described above with reference to step(s) 1018. In some embodiments, in accordance with a determination that displaying the application content at the second level of immersion does not cause the level of immersion of the application content to exceed the threshold immersion, the computer system forgoes applying the visual effect to the first portion of the user, and the first portion of the user and/or the representation of the first portion of the user remains visible in the three-dimensional environment. Applying a visual effect to a first portion of the user when a level of immersion of content that is displayed in a three-dimensional environment is increased above an immersion threshold enables the visual effect to be applied to the first portion of the user automatically, which helps reduce or avoid potential depth conflict between the first portion of the user and the content in the three-dimensional environment, and/or facilitates discovery that increasing the level of immersion of the content above the immersion threshold causes the visual effect to be applied to the first portion of the user, thereby improving user-device interaction and experience.

In some embodiments, while displaying the plurality of application containers in the first mode of operation and before receiving the input corresponding to the request to display additional application content for the respective application, the computer system detects (1022a), via the one or more input devices, a second input corresponding to a request to display a virtual environment (e.g., described in more detail below) in the three-dimensional environment, wherein the virtual environment is an operating system virtual environment of the computer system, such as selection of button 941 provided by hand 903b as shown in FIG. 9B. For example, while displaying the plurality of application containers from the different applications and before displaying the application content for the respective application in the second mode of operation, the computer system detects the second input. In some embodiments, the second input includes selection of a respective option displayed in the three-dimensional environment that is selectable to cause the computer system to display a virtual environment in the three-dimensional environment. In some embodiments, the second input includes interaction with a hardware input device in communication with the computer system. For example, the computer system detects a selection (e.g., a physical press) and/or scrolling or rotation of a hardware button of the computer system that corresponds to the request to display the virtual environment in the three-dimensional environment, as similarly described above with reference to step(s) 1016.

In some embodiments, in response to detecting the second input (1022b), the computer system displays (1022c), via the display generation component, the virtual environment within the three-dimensional environment while maintaining display of the plurality of application containers in the first mode of operation in the three-dimensional environment, such as concurrently displaying the virtual environment 928 and the virtual objects 906a and 908a as shown in FIGS. 9C and 9C1. For example, the computer system displays an immersive virtual environment that occupies all or portions of the three-dimensional environment (e.g., portions of the three-dimensional environment that include the physical environment) in the field of view of the user. In some embodiments, the virtual environment includes a scene that at least partially veils at least a part of the three-dimensional environment (and/or the physical environment surrounding the display generation component) such that it appears as if the user were located in the scene (e.g., and optionally no longer located in the three-dimensional environment). Some examples of a virtual environment include a simulated lake environment, a simulated mountain environment, a simulated sunset scene, a simulated sunrise scene, a simulated nighttime environment, a simulated grassland environment, and/or a simulated concert scene. In some embodiments, a virtual environment is based on a real physical location, such as a museum, and/or an aquarium. In some embodiments, a virtual environment is an artist-designed location. In some embodiments, the virtual environment is an atmospheric transformation that modifies one or more visual characteristics of the three-dimensional environment such that it appears as if the three-dimensional environment is located at a different time, place, and/or condition (e.g., morning lighting instead of afternoon lighting, sunny instead of overcast, and/or evening instead of morning). In some embodiments, the virtual environment has one or more characteristics of virtual environments in methods 800 and/or 1200. In some embodiments, the computer system concurrently displays the plurality of application containers in the first mode of operation with the virtual environment. For example, the plurality of application containers is displayed in front of and/or within the virtual environment, such that a portion of the virtual environment is displayed in the background of and/or behind the plurality of application containers relative to the viewpoint of the user in the three-dimensional environment. In some embodiments, the computer system maintains display of the plurality of application containers in the three-dimensional environment when the virtual environment is displayed because displaying content in the first mode of operation is compatible with the display of a virtual environment in the three-dimensional environment. For example, because the display of content in the first mode of operation is restricted to one or more application containers, as previously discussed above with reference to step(s) 1002, the content that is being displayed in the first mode of operation will not conflict with (e.g., contact or intersect) the virtual environment. Accordingly, the computer system optionally allows content that is displayed in the first mode of operation to be concurrently displayed with a virtual environment in the three-dimensional environment. Maintaining display of objects in a first mode of operation in which display of content is limited to locations of the objects in a three-dimensional environment when a virtual environment is displayed in the three-dimensional environment enables the user to continue interacting with the objects in the first mode of operation while the virtual environment is displayed, while maintaining the avoidance or reduction of potential depth conflict in the three-dimensional environment, thereby improving user-device interaction.

In some embodiments, before detecting the first input, the three-dimensional environment further includes a virtual environment (1024a) (e.g., such as a virtual environment described above with reference to step(s) 1022), such as the virtual environment 928 as shown in FIGS. 9C and 9C1. For example, as similarly discussed above with reference to step(s) 1022, the computer system is concurrently displaying the plurality of application containers from the different applications in the first mode of operation and the virtual environment in the three-dimensional environment when the first input is detected.

In some embodiments, in response to detecting the first input, in accordance with the determination that the request is to display the additional application content in the second mode of operation in which content of the respective application is not restricted to being displayed in one or more application containers (1024b) (e.g., as similarly described above with reference to step(s) 1002), the computer system ceases (1024c) display of the virtual environment in the three-dimensional environment, such as ceasing display of the virtual environment 928 as shown in FIG. 9F. For example, the computer system ceases display of the plurality of application containers and the virtual environment when the application content for the respective application is displayed in the three-dimensional environment. In some embodiments, as similarly described above with reference to step(s) 1002, the display of the application content in the second mode of operation is not compatible with the display of other content (e.g., background content or virtual objects) in the three-dimensional environment. For example, the computer system prevents concurrent display of application content that is being displayed in the second mode of operation and the plurality of application containers and the virtual environment because the display of the application content could encounter a depth conflict with (e.g., contact or intersect a portion of) the plurality of application containers and/or a portion of the virtual environment. Accordingly, in some embodiments, the computer system ceases display of the virtual environment when the application content for the respective application is displayed in the second mode of operation in the three-dimensional environment. In some embodiments, in response to detecting the first input, in accordance with a determination that the request is not to display the additional application content in the second mode of operation, the computer system maintains display of the virtual environment (e.g., and the plurality of application containers) in the three-dimensional environment. Ceasing display of a virtual environment in a three-dimensional environment when content is displayed in a second mode of operation in which the display of content is not limited to a location of the corresponding object in the three-dimensional environment facilitates discovery that an object is displayed in the second mode of operation in the three-dimensional environment, and/or avoids or reduces potential depth conflict that can be encountered between content of the application that is displayed in the second mode of operation and a portion of the virtual environment, thereby improving user-device interaction.

In some embodiments, ceasing display of the virtual environment in the three-dimensional environment in accordance with the determination that the request is to display the additional application content in the second mode of operation in response to detecting the first input includes (1026a) transitioning from displaying the virtual environment in the three-dimensional environment to displaying the application content for the respective application in the three-dimensional environment by decreasing a visual prominence of the virtual environment while concurrently increasing a visual prominence of the application content (1026b) (e.g., the computer system transitions using a visual crossfade transition), such as increasing a translucency of the virtual environment 928 as shown in FIG. 9D. For example, when ceasing display of the virtual environment (e.g., and the plurality of application containers) in the three-dimensional environment, the computer system displays a visual crossfade between the virtual environment (e.g., and the plurality of application containers) and the application content from the respective application. In some embodiments, during the visual crossfade transition, decreasing the visual prominence of the virtual environment includes increasing a translucency (e.g., and/or decreasing a brightness and/or coloration) of the virtual environment (e.g., and the plurality of application containers) and increasing the visual prominence of the virtual environment includes initiating display of the application content such that the application content visually appears to fade into the three-dimensional environment (e.g., from a predetermined portion of the three-dimensional environment relative to the viewpoint of the user, such as a center of the three-dimensional environment, a left or right side of the three-dimensional environment (e.g., such as a sweeping crossfade transition), and/or a top or bottom portion of the three-dimensional environment). For example, the computer system decreases a transparency (e.g., and/or increases a brightness and/or coloration) of the application content when increasing the visual prominence of the application content. In some embodiments, the transition occurs gradually in the three-dimensional environment (e.g., over a predetermined amount of time, such as 0.1, 0.5, 0.75, 1, 1.5, 2, 3, 5, 8, or 10 seconds). In some embodiments, when the visual crossfade transition is completed, the virtual environment (e.g., and the plurality of application containers) is no longer displayed in the three-dimensional environment and is replaced by the application content for the respective application. Using a visual crossfade transition when ceasing display of a virtual environment in a three-dimensional environment when content is displayed in a second mode of operation facilitates discovery that an object is going to be displayed in the second mode of operation in the three-dimensional environment, which provides visual feedback about a progress of the display of the object and maintains presentation of at least a portion of the virtual environment, thereby helping reduce errors in interaction with the virtual environment, and/or helps avoid eye strain that could be caused by a direct display of the content of the application that is displayed in the second mode of operation after ceasing display of the virtual environment when the object is displayed in the second mode of operation in the three-dimensional environment, thereby improving user-device interaction.

In some embodiments, ceasing display of the virtual environment in the three-dimensional environment in accordance with the determination that the request is to display the additional application content in the second mode of operation in response to detecting the first input includes (1028a) transitioning from displaying the virtual environment in the three-dimensional environment to displaying the application content for the respective application in the three-dimensional environment by decreasing a visual prominence of the virtual environment while concurrently displaying an increasing amount of the application content that is displayed (1028b) (e.g., the computer system transitions using a visual gradient transition), such as displaying a portion of the immersive MR content 935a as shown in FIG. 9D. For example, when ceasing display of the virtual environment (e.g., and the plurality of application containers) in the three-dimensional environment, the computer system displays a visual gradient (e.g., such as a tint or filter) of the application content from the respective application with an animation effect that is overlaid on the three-dimensional environment (e.g., including the virtual environment and the plurality of application containers) that grows in size and/or depth to consume larger portions of the three-dimensional environment, including portions of the three-dimensional environment occupied by the virtual environment. In some embodiments, as discussed below with reference to step(s) 1030-1032, the gradient is displayed/generated based on visual characteristics of the application content, such as a visual appearance (e.g., color) of the application content, that is going to be displayed in the three-dimensional environment. In some embodiments, the transition occurs gradually in the three-dimensional environment (e.g., over a predetermined amount of time, such as 0.5, 0.75, 1, 1.5, 2, 3, 5, 8, or 10 seconds). In some embodiments, when the visual gradient transition is completed, the virtual environment (e.g., and the plurality of application containers) is no longer displayed in the three-dimensional environment and is replaced by the application content for the respective application. Using a visual gradient transition when ceasing display of a virtual environment in a three-dimensional environment when content is displayed in a second mode of operation facilitates discovery that an object is going to be displayed in the second mode of operation in the three-dimensional environment, which provides visual feedback about a progress of the display of the object and maintains presentation of at least a portion of the virtual environment, thereby helping reduce errors in interaction with the virtual environment, and/or helps avoid eye strain that could be caused by a direct display of the content of the application that is displayed in the second mode of operation after ceasing display of the virtual environment when the object is displayed in the second mode of operation in the three-dimensional environment, thereby improving user-device interaction.

In some embodiments, the transition from displaying the virtual environment in the three-dimensional environment to displaying the application content for the respective application in the three-dimensional environment is based on one or more colors associated with the application content (1030), as similarly described with reference to FIG. 9E. For example, the one or more colors are selected based on a color of the application content itself, such as the color of user interface elements (e.g., images, buttons, text, and/or other content), and/or a color of one or more virtual objects associated with the application content (e.g., such as the virtual objects described above with reference to step(s) 1014). In some embodiments, the increasing amount of the application content (e.g., the gradient (e.g., tint or filter)) that is displayed in the three-dimensional environment (e.g., including the virtual environment and the plurality of application containers) during the transition causes the three-dimensional environment to visually appear to reflect the one or more colors discussed above. In some embodiments, data regarding the one or more colors associated with the application content is provided by the respective application that enables the computer system to generate and display the visual gradient transition that is based on the one or more colors when transitioning to displaying the application content for the respective application. In some embodiments, when the transition is completed, and the virtual environment and the plurality of application containers are no longer displayed, only the portions of the three-dimensional environment associated with the application content appear to visually reflect the one or more colors. For example, during the transition, portions of the physical environment of the display generation component that are visible in the three-dimensional environment are tinted/filtered using the one or more colors, and after the transition is completed, the portions of the physical environment that are not occluded by the application content are no longer tinted/filtered using the one or more colors. Using a visual gradient transition that is based on a color associated with content when ceasing display of a virtual environment in a three-dimensional environment when the content is displayed in a second mode of operation provides a visual preview of the content that is going to be displayed and/or helps avoid eye strain that could be caused by a direct display of the content of the application that is displayed in the second mode of operation after ceasing display of the virtual environment when the object is displayed in the second mode of operation in the three-dimensional environment, thereby improving user-device interaction.

In some embodiments, the transition from displaying the virtual environment in the three-dimensional environment to displaying the application content for the respective application in the three-dimensional environment is based on a visual appearance of the application content for the respective application (1032), as similarly described with reference to FIG. 9E. For example, the visual appearance of the application content is selected based on one or more colors associated with the application content (e.g., as similarly described above with reference to step(s) 1030), an amount of brightness associated with the application content (e.g., a brightness of the application content when the content is displayed in the second mode of operation), and/or an amount of saturation associated with the application content (e.g., a saturation of the application content when the content is displayed in the second mode of operation). In some embodiments, the visual appearance of the application content includes or corresponds to a visual appearance (e.g., color, brightness, and/or saturation) of one or more virtual objects associated with the application content (e.g., such as the virtual objects described above with reference to step(s) 1014) that will be or are able to be displayed in the three-dimensional environment when the application content is displayed in the second mode of operation. In some embodiments, the increasing amount of the application content (e.g., the gradient (e.g., tint or filter)) displayed in the three-dimensional environment (e.g., including the virtual environment and the plurality of application containers) during the transition causes the three-dimensional environment to visually appear to reflect the visual appearance discussed above. In some embodiments, data regarding the visual appearance of the application content is provided by the respective application that enables the computer system to generate and display the visual gradient transition that is based on the visual appearance when transitioning to displaying the application content for the respective application. In some embodiments, when the transition is completed, and the virtual environment and the plurality of application containers are no longer displayed, only the portions of the three-dimensional environment associated with the application content appear to visually reflect the visual appearance of the application content. For example, during the transition, portions of the physical environment of the display generation component that are visible in the three-dimensional environment are tinted/filtered based on the visual appearance of the application content, and after the transition is completed, the portions of the physical environment that are not occluded by the application content are no longer tinted/filtered based on the visual appearance. Using a visual gradient transition that is based on a visual appearance of content when ceasing display of a virtual environment in a three-dimensional environment when the content is displayed in a second mode of operation provides a visual preview of the content that is going to be displayed and/or helps avoid eye strain that could be caused by a direct display of the content of the application that is displayed in the second mode of operation after ceasing display of the virtual environment when the object is displayed in the second mode of operation in the three-dimensional environment, thereby improving user-device interaction.

In some embodiments, while displaying the virtual environment in the three-dimensional environment before detecting the first input (e.g., while concurrently displaying the plurality of application containers from the different applications in the first mode of operation and the virtual environment in the three-dimensional environment before the first input is detected), a portion of a physical environment of the display generation component is at least partially occluded by the virtual environment relative to a viewpoint of a user of the computer system (1034a), such as back wall of the physical environment being occluded by the virtual environment 928 as shown in FIGS. 9C and 9C1. For example, as similarly described above with reference to step(s) 1006, the three-dimensional environment includes a portion of the physical environment of the user (e.g., and the computer system) that would otherwise be fully visible as passthrough via a transparent or translucent portion of the display generation component. In some embodiments, while the virtual environment is displayed in the three-dimensional environment, the portion of the physical environment is at least partially occluded by (e.g., occupied by) the virtual environment in the three-dimensional environment relative to the viewpoint of the user. Additionally, in some embodiments, the plurality of application containers is at least partially occluding one or more portions of the physical environment, such as in addition to or including the portion of the physical environment that is occluded by the virtual environment in the three-dimensional environment relative to the viewpoint of the user.

In some embodiments, while transitioning from displaying the virtual environment in the three-dimensional environment to displaying the application content from the respective application in the three-dimensional environment (e.g., using the visual crossfade transition discussed above with reference to step(s) 1026 or using the visual gradient transition discussed above with reference to step(s) 1028), the computer system increases (1034b) a translucency (e.g., and/or decreasing an opacity) of the virtual environment (e.g., and the plurality of application containers concurrently displayed with the virtual environment) in the three-dimensional environment, such that visibility of the portion of the physical environment is at least partially increased in the three-dimensional environment relative to the viewpoint of the user, such as increasing the translucency of the virtual environment 928 as shown in FIG. 9D. For example, during the transition to displaying the application content, the portion of the physical environment becomes at least partially more visible through the virtual environment and/or the plurality of application containers when the translucency of the virtual environment and the plurality of application containers is increased in the three-dimensional environment relative to the viewpoint of the user. In some embodiments, the computer system gradually increases the translucency of the virtual environment during the transition until the virtual environment is no longer displayed in the three-dimensional environment when the transition is completed and the application content for the respective application is displayed in the second mode in the three-dimensional environment. For example, the computer system increases the translucency of the virtual environment (e.g., and the plurality of application containers) until the virtual environment is completely transparent and no longer visible to the user when the application content is displayed in the three-dimensional environment. In some embodiments, when the virtual environment is no longer displayed after the transition is completed, the portion of the physical environment that was at least partially occluded by the virtual environment is not necessarily visible again in the three-dimensional environment relative to the viewpoint of the user (e.g., because the application content for the respective application at least partially occludes the portion of the physical environment when the application content is displayed). Increasing a translucency of a virtual environment when transitioning to displaying content in a second mode of operation in which the display of the content is not limited to a location of the corresponding object in the three-dimensional environment such that a physical environment surrounding the user is at least partially visible through the virtual environment visually facilitates a spatial understanding of the content relative to the physical environment, and/or enables the user to maintain a spatial understanding the physical environment relative to the viewpoint of the user, which helps avoid unintentional physical contact with the physical environment, thereby improving user-device interaction.

In some embodiments, while displaying the plurality of application containers in the first mode of operation with a first visual appearance (e.g., before detecting the first input described above with reference to step(s) 1002) or the application content for the respective application in the second mode of operation with a second visual appearance (e.g., after detecting the first input described above with reference to step(s) 1002), the computer system detects (1036a), via the one or more input devices, a respective event corresponding to a request to display one or more system objects in the three-dimensional environment, such as input provided by hand 903a as shown in FIG. 9A. For example, the computer system displays the plurality of application containers with the first visual appearance that is based on the content of the plurality of application containers (e.g., the visual appearance, such as color, brightness, translucency, saturation, and/or sharpness, of the content (e.g., selectable options, images, video, user interfaces, and/or other user interface elements). In some embodiments, the computer system displays the application content with the second visual appearance, which is optionally different from the first visual appearance, that is based on a visual appearance of the application content (e.g., color, brightness, translucency, saturation, and/or sharpness, of the application content (e.g., including selectable options, images, video, user interfaces, and/or other user interface elements). In some embodiments, detecting the respective event includes detecting an input provided by the user corresponding to a request to display the one or more system objects in the three-dimensional environment. In some embodiments, the input corresponds to an air pinch gesture, or an air swipe gesture performed by a hand of the user that is detected while attention (e.g., gaze) of the user is directed to a predefined region of the three-dimensional environment for displaying the one or more system objects. For example, the gaze of the user is directed to a top, bottom, or side region of the three-dimensional environment relative to the viewpoint of the user when the input is detected. In some embodiments, the computer system detects a trigger (e.g., an incoming notification event) that causes the one or more system objects to be displayed in the three-dimensional environment. For example, the computer system detects an indication of an incoming message (e.g., text or email) or notification from a second computer system, different from the computer system, a wireless communications terminal, and/or an application running on the computer system. In some embodiments, the one or more system objects correspond to system controls for controlling one or more aspects of the display of the three-dimensional environment, such as a brightness of the three-dimensional environment, a volume of audio being played back that is associated with an application in the three-dimensional environment, communications settings (e.g., cellular or wireless settings, such as network (e.g., Wi-Fi) settings, or Bluetooth connection settings), and/or content sharing options for content in the three-dimensional environment. In some embodiments, the one or more system objects correspond to notifications (e.g., text messages, emails, application notifications, and/or reminders/alarm notifications) that are generated and displayed with or without detecting user input (e.g., in response to the trigger discussed above).

FIG. 9A1 illustrates similar and/or the same concepts as those shown in FIG. 9A (with many of the same reference numbers). It is understood that unless indicated below, elements shown in FIG. 9A1 that have the same reference numbers as elements shown in FIGS. 9A-9J have one or more or all of the same characteristics. FIG. 9A1 includes computer system 101, which includes (or is the same as) display generation component 120. In some embodiments, computer system 101 and display generation component 120 have one or more of the characteristics of computer system 101 shown in FIGS. 9A and 9A-9J and display generation component 120 shown in FIGS. 1 and 3, respectively, and in some embodiments, computer system 101 and display generation component 120 shown in FIGS. 9A-9J have one or more of the characteristics of computer system 101 and display generation component 120 shown in FIG. 9A1.

In FIG. 9A1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 9A-9J.

In FIG. 9A1, display generation component 120 is illustrated as displaying content that optionally corresponds to the content that is described as being displayed and/or visible via display generation component 120 with reference to FIGS. 9A-9J. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 9A1.

Display generation component 120 has a field of view (e.g., a field of view captured by external image sensors 314b and 314c and/or visible to the user via display generation component 120, indicated by dashed lines in the overhead view) that corresponds to the content shown in FIG. 9A1. Because display generation component 120 is optionally a head-mounted device, the field of view of display generation component 120 is optionally the same as or similar to the field of view of the user.

In FIG. 9A1, the user is depicted as performing an air pinch gesture (e.g., with hand 903A) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 9A-9J.

In some embodiments, computer system 101 responds to user inputs as described with reference to FIGS. 9A-9J.

In the example of FIG. 9A1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 9A-9J and/or described with reference to the corresponding method(s) are optionally implemented on computer system 101 and display generation unit 120 in a manner similar or analogous to that shown in FIG. 9A1.

In some embodiments, in response to detecting the respective event (1036b), in accordance with a determination that the plurality of application containers is displayed in the first mode of operation in the three-dimensional environment when the respective event is detected (1036c) (e.g., and the application content for the respective application is not displayed in the second mode of operation in the three-dimensional environment), the computer system displays (1036d), via the display generation component, the one or more system objects (e.g., discussed above) in the three-dimensional environment while displaying the plurality of application containers with a third visual appearance, different from the first visual appearance, wherein the third visual appearance differs from the first visual appearance in a first manner (e.g., changes one or more visual characteristics of the application content by a first amount, as discussed below), such as the display of the system controls 913 while changing the visual appearance of the virtual objects 906a and 908a as shown in FIG. 9B. For example, the computer system displays the one or more system objects in a predefined location of the three-dimensional environment, such as in the predefined region discussed above. In some embodiments, the computer system displays the one or more system objects at a location in the three-dimensional environment that is designated for displaying the one or more system objects (e.g., such as a notifications center). In some embodiments, when the one or more system objects are displayed while the plurality of application containers is being displayed in the first mode of operation in the three-dimensional environment, the computer system visually emphasizes the one or more system objects in a first manner in the three-dimensional environment. For example, displaying the plurality of application containers with third visual appearance in the three-dimensional environment includes decreasing a value of the lighting/brightness of the three-dimensional environment, including the plurality of application containers, by a first amount. As an example, the computer system darkens the passthrough of the physical environment surrounding the one or more system objects in the three-dimensional environment such that the one or more system objects are visually emphasized and displayed with prominence relative to the surrounding portions of the three-dimensional environment, including the plurality of application containers. In some embodiments, displaying the plurality of application containers with the third visual appearance in the three-dimensional environment includes fading and/or blurring the three-dimensional environment, including the plurality of application containers, by a first amount/magnitude to draw attention of the user toward the one or more system objects.

In some embodiments, in accordance with a determination that the application content for the respective application is displayed in the second mode of operation in the three-dimensional environment when the respective event is detected (1036e) (e.g., and the plurality of application containers from the different applications is not displayed in the first mode of operation in the three-dimensional environment), the computer system displays (1036f) the one or more system objects in the three-dimensional environment (e.g., as similarly described above) while displaying the application content for the respective application with a fourth visual appearance, different from the second visual appearance, wherein the fourth visual appearance differs from the second visual appearance in a second manner, different from the first manner (e.g., changes one or more visual characteristics of the application content by a second amount, different than the first amount, as discussed below), such as displaying the system controls 913 while changing the visual appearance of the immersive MR content 937 as shown in FIG. 9I. In some embodiments, when the one or more system objects are displayed while the application content for the respective application is being displayed in the second mode of operation in the three-dimensional environment, the computer system visually emphasizes the one or more system objects in a second manner, different from the first manner above, in the three-dimensional environment. For example, displaying the application content with the fourth visual appearance in the three-dimensional environment includes decreasing a value of the lighting/brightness of the three-dimensional environment, including the application content, by a second amount, less than the first amount discussed above. As an example, the computer system darkens the passthrough of the physical environment surrounding the one or more system objects in the three-dimensional environment such that the one or more system objects are visually emphasized and displayed with prominence relative to the surrounding portions of the three-dimensional environment, including the application content. In some embodiments, displaying the application content with fourth visual appearance in the three-dimensional environment includes fading and/or blurring the three-dimensional environment, including the application content, by a second amount/magnitude, less than the first amount/magnitude above, to draw attention of the user toward the one or more system objects. Accordingly, in some embodiments, when the computer system displays the one or more system objects in the three-dimensional environment, if content is displayed in the first mode of operation in the three-dimensional environment, the computer system changes a focus of the content using a first amount of deemphasis (e.g., a first amount of fading, blurring, and/or darkening), and if content is displayed in the second mode of operation in the three-dimensional environment, the computer system changes a focus of the content using a second amount of deemphasis (e.g., a second amount of fading, blurring, and/or darkening), less than the first amount. In some embodiments, changing the visual appearance of content in a first manner or a second manner depending on a mode of operation in which the content is displayed has one or more characteristics of changing a visual appearance of content in method 1200. Changing a focus of content displayed in a first mode of operation in a first manner when system objects are displayed in the three-dimensional environment and changing a focus of content displayed in a second mode of operation in a second manner, different from the first manner, when the system objects are displayed in the three-dimensional environment accounts for differences in portions of the three-dimensional environment in the field of view of the user that are occupied by the content if the content is displayed in the first mode of operation or the second mode of operation, which helps avoid or reduce potential depth conflict that can be encountered between the content and the system objects when the system objects are displayed in the three-dimensional environment, thereby improving user-device interaction and/or increasing efficiency of power consumption.

In some embodiments, the application content for the respective application is displayed in the second mode of operation at least partially in a respective object (e.g., a portal for the respective application, as similarly described above with reference to step(s) 1002) in the three-dimensional environment, the respective object having one or more characteristics (e.g., a size (e.g., an area or a volume), depth, translucency, and/or brightness) determined by the (optionally by the operating system of the) computer system (1038) (e.g., rather than by the respective application), as similarly described with reference to FIG. 9F. For example, the respective object is associated with an operating system of the computer system. In some embodiments, when the application content for the respective application is displayed in the three-dimensional environment, the computer system does not detect input for designating and/or controlling the one or more characteristics of the respective object in which at least a portion of the application content is displayed. In some embodiments, when the respective object having the one or more characteristics is displayed in the three-dimensional environment, the application content is displayed in the three-dimensional environment according to (e.g., and/or are governed by) the one or more characteristics of the respective object that are determined by the computer system. For example, the size, depth, translucency, and/or brightness of the portal that are determined by the computer system at least partially control and/or affect a size, depth, translucency, and/or brightness of the application content that is at least partially displayed in the portal. Accordingly, because the one or more characteristic of the respective object are determined by the computer system, the computer system optionally displays the respective object having the one or more characteristics until input is provided by the user (e.g., or automatically by the respective application) for changing the one or more characteristics, such as changing an immersion level of the application content (e.g., a size of the portal), as previously discussed above with reference to step(s) 1016-1020). Additionally, in some embodiments, when a virtual system environment (e.g., such as the virtual system environment discussed above with reference to step(s) 1022-1024) is displayed in the three-dimensional environment, the virtual system environment is also displayed according to (e.g., and/or governed by) the one or more characteristics of the respective object that are determined by the computer system. For example, the virtual system environment is displayed in the same or similar portal discussed above, such that a size, depth, translucency, and/or brightness of the application content is at least partially controlled and/or affected by the size, depth, translucency, and/or brightness of the portal discussed above. Accordingly, in some embodiments, as similarly discussed above with reference to step(s) 1024, a virtual system environment ceases to be displayed in the three-dimensional environment when content is displayed in the second mode of operation in the three-dimensional environment because the virtual system environment and the content share the same respective object (e.g., the same portal) in the three-dimensional environment. Controlling display of content that is displayed at least partially based on one or more characteristics of a system portal in which the content is at least partially displayed in the three-dimensional environment ensures consistency in display of and/or interaction with content that is displayed in different modes in the three-dimensional environment, which helps reduce errors in interaction with content that is displayed in the system portal, thereby improving user-device interaction.

It should be understood that the particular order in which the operations in method 1000 have been described is merely exemplary and is not intended to indicate that the described order is the only order in which the operations could be performed. One of ordinary skill in the art would recognize various ways to reorder the operations described herein.

FIGS. 11A-11G illustrate examples of a computer system displaying content of a respective application in a first mode of operation that includes spatially distributing content throughout an available display area of a three-dimensional environment and ceasing display of the content in the first mode of operation in accordance with some embodiments of the disclosure.

FIG. 11A illustrates a computer system (e.g., an electronic device) 101 displaying, via a display generation component (e.g., display generation component 120 of FIG. 1), a three-dimensional environment 1102 from a viewpoint of a user (e.g., user 1138) of the computer system 101 (e.g., facing the back wall of the physical environment in which computer system 101 is located). In some embodiments, computer system 101 includes a display generation component (e.g., a touch screen) and a plurality of image sensors (e.g., image sensors 314 of FIG. 3). The image sensors optionally include one or more of a visible light cameras, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

As shown in FIG. 11A, computer system 101 displays a user interface 1132 in three-dimensional environment 1102. User interface 1132 is associated with a respective application (e.g., “Application A”). In some embodiments, user interface 1132 is a menu for displaying content (e.g., immersive MR content 1104a shown in FIG. 11B) associated with the respective application in three-dimensional environment 1102. User interface 1132 includes a selectable option 1134 that is selectable to display the content associated with the respective application in three-dimensional environment 1102. In some embodiments, selectable option 1134 is selectable through a selection input (e.g., a selection input as described with reference to method 1200). In FIG. 11A, computer system 101 receives a selection input from user 1138. For example, the selection input includes user 1138 directing gaze 1108 toward selectable option 1134 while concurrently performing a hand pose and/or air gesture with hand 1112. In some embodiments, the hand pose and/or air gesture performed by hand 1112 includes an air tap, air pinch, air drag and/or air long pinch (e.g., an air pinch over a duration of time (e.g., 0.1, 0.5, 1, 2, 5 or 10 seconds)). In some embodiments, user interface 1132 is displayed concurrently with an application container that includes content associated with the respective application (e.g., such as application container 1140 including content 1104b displayed in the second mode of operation shown and described with reference to FIG. 11D). In some embodiments, user interface 1132 is displayed in response to a user input (e.g., corresponding to a request by user 1138 to display user interface 1132 in three-dimensional environment 1102, such as through selecting an application in an application library, an audio input (e.g., a voice command) and/or a touch-input provided through a touch-sensitive surface associated with computer system 101). For example, a user input is received by computer system 101 corresponding to a request to display user interface 1132 while content of the respective application is displayed in three-dimensional environment 1102 (e.g., in the second mode of operation shown and described with reference to FIG. 11D), or prior to content of the respective application being displayed in three-dimensional environment 1102 (e.g., prior to content associated with the respective application being displayed in the first mode of operation shown and described with reference to FIG. 11B and/or in the second mode of operation shown and described with reference to FIG. 11D).

In FIG. 11A, a virtual object 1136 is displayed concurrently in three-dimensional environment 1102 with user interface 1132. In FIG. 11A, virtual object 1136 is a virtual window (e.g., a web-browsing window). As shown, virtual object 1136 includes content (e.g., “website content”) from the website www.URL1.com (e.g., the content includes text, images, videos and/or audio content associated with a website). In some embodiments, virtual object 1136 is a user interface of an application different from the respective application associated with user interface 1132 (e.g., including one or more characteristics of the one or more user interfaces described with reference to method 1200). In some embodiments, virtual object 1136 includes one or more characteristics of virtual objects described with reference to methods 800, 1000 and/or 1200.

As shown in FIG. 11A, a table 1110 and a wall photo 1124 are displayed. In some embodiments, table 1110 and wall photo 1124 are representations (e.g., virtual representations) of objects in the physical environment of user 1138 generated by computer system 101. In some embodiments, table 1110 and wall photo 1124 are displayed as passthrough of the user's physical environment through a translucent and/or transparent display (e.g., three-dimensional environment 1102 is a mixed-reality environment including both virtual objects (e.g., user interface 1132 and/or virtual object 1136) generated by computer system 101 and physical objects from the user's physical environment).

An overhead view 1130 of three-dimensional environment 1102 is shown in FIGS. 11A-11G. Overhead view 1130 illustrates user 1138 in three-dimensional environment 1102. In some embodiments, user 1138 in overhead view 1130 represents a location of a viewpoint of the user relative to three-dimensional environment 1102. The locations of user interface 1132, virtual object 1136 and table 1110 relative to three-dimensional environment 1102 (e.g., and/or relative to the location of the viewpoint of user 1138 in three-dimensional environment 1102) are shown in overhead view 1130.

In some embodiments, computer system 101 displays virtual object 1136 with a spatial arrangement (including or more characteristics of the first spatial arrangement described with reference to method 1200) in three-dimensional environment 1102. In some embodiments, computer system 101 displays user interface 1132 with a spatial arrangement relative to one or more objects displayed in three-dimensional environment 1102 (e.g., such as table 1110 and/or wall photo 1124). For example, virtual object 1136 is displayed by computer system 101 at a distance (e.g., relative to three-dimensional environment 1102) from table 1110 and/or wall photo 1124. For example, virtual object 1136 is displayed by computer system 101 with an orientation (e.g., based on spherical or polar coordinates) relative to table 1110 and/or wall photo 1124. In some embodiments, computer system 101 displays virtual object 1136 with a spatial arrangement relative to a reference location in the three-dimensional environment 1102 (e.g., the reference location is a default location stored in a memory of computer system 101, and the virtual object 1136 is displayed at a position relative to the reference location). In some embodiments, the computer system displays virtual object 1136 with a spatial arrangement relative to the viewpoint of user 1138. For example, virtual object 1136 is displayed at a distance from a location of the viewpoint of the user 1138. For example, virtual object 1136 is displayed with an orientation (e.g., based on spherical or polar coordinates) relative to the viewpoint of the user 1138. In some embodiments, the spatial arrangement of virtual object 1136 is a default spatial arrangement established by computer system 101. In some embodiments, the spatial arrangement of virtual object 1136 is set by user 1138 through one or more user inputs (e.g., including one or more characteristics of the input for moving application container 1140 shown and described with reference to FIGS. 11D-11E). In some embodiments, in response to user 1138 selecting selectable option 1134, computer system 101 ceases to display virtual object 1136 in three-dimensional environment 1102. In some embodiments, computer system 101 stores the spatial arrangement of virtual object 1136 in a memory such that computer system 101 is configured to redisplay virtual object 1136 with the same spatial arrangement (e.g., virtual object 1136 is redisplayed with the same spatial arrangement after ceasing to display immersive MR content 1104a as shown in FIG. 11D).

In some embodiments, computer system 101 provides for display of immersive mixed-reality (MR) content associated with user interface 1132 in three-dimensional environment 1102. For example, the immersive MR content includes interactive media such as video game content. In some embodiments, the immersive MR content associated with user interface 1132 is displayed in three-dimensional environment 1102 in response to the selection of selectable option 1134. In some embodiments, the immersive MR content is displayed in a first mode of operation (e.g., including one or more characteristics of the first mode of operation described with reference to method 1200). For example, displaying the content associated with user interface 1132 in the first mode of operation includes displaying the content throughout an available display area of three-dimensional environment 1102 (e.g., as shown and described with reference to FIG. 11B). In some embodiments, the first mode of operation is a restrictive mode of operation that does not permit the concurrent display of content associated with other applications not associated with the immersive MR content in three-dimensional environment 1102. For example, displaying the immersive MR content associated with user interface 1132 in three-dimensional environment 1102 does not include concurrently displaying virtual object 1136 with the immersive MR content in the three-dimensional environment 1102.

FIG. 11B illustrates immersive MR content 1104a associated with user interface 1132 (e.g., shown in FIG. 11A) displayed in a first mode of operation in three-dimensional environment 1102 in response to the selection input shown and described with reference to FIG. 11A. In some embodiments, as shown in FIG. 11B (e.g., in overhead view 1130), immersive MR content 1104a is spatially distributed by computer system 101 throughout an area of three-dimensional environment 1102. In some embodiments, in the first mode of operation, the display of immersive MR content 1104a is not confined to a boundary of a window and/or container (e.g., such as application container 1140 shown in FIGS. 11D-11F) in three-dimensional environment 1102. The area of three-dimensional environment 1102 that is available to display (e.g., including spatial distribution of) the immersive MR content 1104a is optionally constrained by a portal (e.g., a portal as described with reference to claim 1200) into the immersive MR content 1104a. For example, immersive MR content 1104a is permitted to be displayed by computer system 101 in front of, behind and/or adjacent to the portal. As shown in FIG. 11B, immersive MR content 1104a is displayed in an area of three-dimensional environment 1102 behind a portal (e.g., relative to the viewpoint of user 1138 shown in overhead view 1130). Computer system 101 additionally displays secondary portions 1118 of the immersive MR content 1104a in front of to the portal (e.g., relative to the viewpoint of user 1138 shown in overhead view 1130). In some embodiments, secondary portions 1118 of the immersive MR content 1104a are displayed in three-dimensional environment 1102 outside of the portal. Additionally, in some embodiments, the immersive MR content 1104a is not displayed in an area of three-dimensional environment 1104a that is not directly adjacent to the portal (e.g., such as regions of three-dimensional environment 1102 directly adjacent to user 1138) since it is not a region of three-dimensional environment 1102 constrained by the portal.

In some embodiments, as shown in FIG. 11B, when immersive MR content 1104a is displayed in the first mode of operation, computer system 101 ceases display of virtual objects in three-dimensional environment 1102 not associated with immersive MR content 1104a (e.g., virtual object 1136). Particularly, virtual object 1136 is not displayed by computer system 101 in FIG. 11B concurrently with immersive MR content 1104a (e.g., because displaying virtual object 1136 would or could spatially conflict with the display of immersive MR content 1104a throughout the available display area of three-dimensional environment 1102). In some embodiments, in FIG. 11B, computer system 101 ceases display of user interface 1132 because it is not necessary to display user interface 1132 since immersive MR content 1104a is displayed in the first mode of operation (e.g., and because displaying user interface 1132 would or could spatially conflict with the display of immersive MR content 1104a in three-dimensional environment 1102). As shown in FIG. 11B, a portion of table 1110 is visible from the viewpoint of user 1132 (e.g., because a portion of table 1110 is within the available display area of three-dimensional environment 1102 that content 1104a is spatially distributed in, and a portion of table 1110 is not within the available display area of three-dimensional environment 1102 that content 1104a is spatially distributed in).

FIG. 11A1 illustrates similar and/or the same concepts as those shown in FIG. 11A (with many of the same reference numbers). It is understood that unless indicated below, elements shown in FIG. 11A1 that have the same reference numbers as elements shown in FIGS. 11A-11G have one or more or all of the same characteristics. FIG. 11A1 includes computer system 101, which includes (or is the same as) display generation component 120. In some embodiments, computer system 101 and display generation component 120 have one or more of the characteristics of computer system 101 shown in FIGS. 11A and 11A-11G and display generation component 120 shown in FIGS. 1 and 3, respectively, and in some embodiments, computer system 101 and display generation component 120 shown in FIGS. 11A-11G have one or more of the characteristics of computer system 101 and display generation component 120 shown in FIG. 11A1.

In FIG. 11A1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 11A-11G.

In FIG. 11A1, display generation component 120 is illustrated as displaying content that optionally corresponds to the content that is described as being displayed and/or visible via display generation component 120 with reference to FIGS. 11A-11G. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 11A1.

Display generation component 120 has a field of view (e.g., a field of view captured by external image sensors 314b and 314c and/or visible to the user via display generation component 120, indicated by dashed lines in the overhead view) that corresponds to the content shown in FIG. 11A1. Because display generation component 120 is optionally a head-mounted device, the field of view of display generation component 120 is optionally the same as or similar to the field of view of the user.

In FIG. 11A1, the user is depicted as performing an air pinch gesture (e.g., with hand 1112) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 11A-11G.

In some embodiments, computer system 101 responds to user inputs as described with reference to FIGS. 11A-11G.

In the example of FIG. 11A1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 11A-11G and/or described with reference to the corresponding method(s) are optionally implemented on computer system 101 and display generation unit 120 in a manner similar or analogous to that shown in FIG. 11A1.

In FIG. 11B, an input is received by computer system 101 corresponding to a request to display a system user interface (e.g., system user interface 1114 shown and described with reference to FIG. 11C) in three-dimensional environment 1102. In some embodiments, the input includes gaze 1108 (e.g., provided by user 1138) directed toward a region of three-dimensional environment 1102. As shown in FIG. 11B, gaze 1108 is directed toward a rightward region of three-dimensional environment 1102 relative to the current viewpoint of user 1138. In some embodiments, the request to display the system user interface includes gaze 1108 directed toward a different region of three-dimensional environment 1102, such as an upward, leftward, downward, or corner region of three-dimensional environment 1102. Gaze 1108 is optionally directed toward the region of three-dimensional environment 1102 for a threshold period of time (e.g., 0.1, 0.5, 1, 2, 5 or 10 seconds).

FIG. 11C illustrates a system user interface 1114 of an operating system of computer system 101 displayed in three-dimensional environment 1102 in response to the input received by computer system 101 in FIG. 11B. System user interface 1114 includes a plurality of controls for controlling one or more features of three-dimensional environment 1102. For example, in some embodiments, system user interface 1114 includes one or more controls for controlling the brightness of three-dimensional environment 1102, volume of audio content presented in three-dimensional environment 1102 (e.g., audio volume associated with immersive MR content 1104a) and/or for displaying a home screen user interface and/or applications library of computer system 101 in three-dimensional environment 1102. In some embodiments, system user interface 1114 includes one or more characteristics of the system user interface described with reference to method 1200.

As shown in FIG. 11C, the computer system 101 changes the visual appearance of immersive MR content 1104a (e.g., compared to the visual appearance of immersive MR content 1104a in FIG. 11B) when system user interface 1114 is displayed in three-dimensional environment 1102. For example, the visual appearance of immersive MR content 1104a and secondary portions 1118 reduces in visual prominence when system user interface 1114 is displayed (e.g., in order to ensure the attention of user 1138 is directed to system user interface 1114 and limit distractions otherwise caused by immersive MR content 1104a). In some embodiments, changing the visual appearance of immersive MR content 1104a includes blurring, fading, increasing transparency and/or decreasing opacity of immersive MR content 1104a. In some embodiments, if immersive MR content 1104a includes video content and/or interactive content (e.g., video game content), computer system 101 pauses playback of immersive MR content 1104a when system user interface 1114 is displayed. In some embodiments, computer system 101 maintains the visual appearance (e.g., does not change the visual appearance) of visible passthrough of the physical environment of user 1138 (e.g., wall photo 1124 and table 1110) when system user interface 1114 is displayed in three-dimensional environment 1102.

In some embodiments, displaying system user interface 1114 in three-dimensional environment 1102 while concurrently displaying content in the first mode of operation includes displaying a selectable option to cease display of the content in the first mode of operation (e.g., as described with reference to method 1200). In FIG. 11C, a secondary user interface 1126 is displayed adjacent to system user interface 1114. The secondary user interface 1126 is optionally a menu including one or more selectable options to cease display of immersive MR content 1104a in three-dimensional environment 1102. As illustrated in FIG. 11C, a selectable option 1128 is included in secondary user interface 1126. In some embodiments, secondary user interface 1126 is displayed above, below and/or adjacent to system user interface 1114 in three-dimensional environment 1102. In some embodiments, secondary user interface 1126 is included as part of system user interface 1114. In some embodiments, system user interface 1114 is displayed without secondary user interface 1126, and one or more selectable options (e.g., selectable option 1128) to cease display of immersive MR content 1104a in the first mode of operation are displayed in system user interface 1114.

In FIG. 11C, computer system 101 receives an input (e.g., by user 1138) corresponding to a request to cease display of immersive content 1104a in the first mode of operation. The input includes a selection of selectable option 1128 in secondary user interface 1126 As illustrated, gaze 1108 from user 1138 is directed toward selectable option 1128 while user 1138 concurrently performs a hand pose and/or air gesture with hand 1112. For example, the hand pose and/or air gesture performed by hand 1112 includes an air tap, air pinch, air drag and/or air long pinch (e.g., an air pinch over a duration of time (e.g., 0.1, 0.5, 1, 2, 5 or 10 seconds)). In some embodiments, the input includes one or more characteristics of a selection input described with reference to method 1200.

FIG. 11D illustrates content 1104b of the respective application (e.g., “Application A) displayed in three-dimensional environment 1102 in a second mode of operation in response to the input received by computer system 101 shown in FIG. 11C. In some embodiments, content 1104b is associated with immersive MR content 1104a shown and described with reference to FIGS. 11B-11C (e.g., content 1104b is a portion of content 1104a, and/or content 1104b is not immersive content). In some embodiments, the second mode of operation includes one or more characteristics of the second mode of operation described with reference to method 1200. In some embodiments, the second mode of operation includes restricting the display of content to within an application container in three-dimensional environment 1102 (e.g., including one or more characteristics of application containers described with reference to method 1000 and/or 1200). In FIG. 11D, content 1104b is restricted to being displayed within application container 1140. In some embodiments, the second mode of operation does not permit the spatial distribution of content 1104b throughout an available display area of three-dimensional environment 1102 (e.g., such as shown by the display of content 1104a and secondary portions 1118 in FIGS. 11B-11C). In some embodiments, displaying content 1104b in the second mode of operation includes displaying a menu with a selectable option (e.g., such a user interface 1132 including selectable option 1134 shown and described with reference to FIG. 11A) to display the content 1104b in the first mode of operation (e.g., as immersive MR content 1104a). In some embodiments, selectable option 1134 is included within application container 1140 and is not displayed in a separate user interface (e.g., user interface 1132).

As shown in FIG. 11D, table 1110 and wall photo 1124 are displayed in three-dimensional environment 1102. In some embodiments, because the display of content 1104b is restricted to within application container 1140 and is not spatially distributed throughout the available display area in three-dimensional environment 1102 (e.g., in a region of three-dimensional environment 1102 outside of application container 1140), table 1110 and wall photo 1124 are not visually obscured by content 1104b relative to the viewpoint of user 1138 In some embodiments, table 1110 and wall photo 1124 are represented in three-dimensional environment 1102 in the same manner as prior to computer system 101 displaying immersive MR content 1104a in the first mode of operation (e.g., if table 1110 and wall photo 1124 are displayed as virtual representations prior to displaying immersive MR content 1104a, then table 1110 and wall photo 1124 are displayed as virtual representations after ceasing to display content 1104a in the first mode of operation, or if table 1110 and wall photo 1124 are visible as physical objects included in passthrough of the user's physical environment prior to displaying immersive MR content 1104a, then table 1110 and wall photo 1124 are visible as physical objects included in passthrough of the user's physical environment after ceasing to display immersive MR content 1104a).

In some embodiments, when computer system 101 ceases display of immersive MR content 1104a in the first mode of operation, one or more virtual objects that were displayed in three-dimensional environment 1102 prior to displaying immersive MR content 1104a in the first mode of operation are redisplayed in three-dimensional environment 1102. As shown in FIG. 11D, virtual object 1136 (e.g., which was previously displayed in three-dimensional environment 1102 in FIG. 11A prior to displaying immersive MR content 1104a in three-dimensional environment 1102 in FIG. 11B) is displayed concurrently with application container 1140 in three-dimensional environment 1102. In some embodiments, as shown in FIG. 11D, virtual object 1136 is displayed with the same spatial arrangement (e.g., at the same position) in three-dimensional environment 1102 as previously displayed in FIG. 11A (e.g., because the virtual object 1136 was displayed with the spatial arrangement in three-dimensional environment 1102 prior to displaying immersive MR content 1104a). For example, in FIG. 11D, virtual object 1136 is displayed by computer system 101 at the same distance in three-dimensional environment 1102 from table 1110 and/or wall photo 1124 as previously displayed in FIG. 11A. For example, in FIG. 11D, virtual object 1136 is displayed by computer system 101 with the same orientation relative to table 1110 and/or wall photo 1124 as previously displayed in FIG. 11A. For example, virtual object 1136 is displayed at the same position, distance and/or orientation relative to a reference location in three-dimensional environment 1102 as previously displayed in FIG. 11A. For example, virtual object 1136 is displayed at the same position, distance and/or orientation relative to the viewpoint of user 1138 as previously displayed in FIG. 11A. In some embodiments, virtual object 1136 and application container 1140 (including content 1104b) are displayed in three-dimensional environment 1102 prior to the display of immersive MR content 1104a with a spatial relationship (e.g., virtual object 1136 has a spatial arrangement relative to application container 1140, and application container 1140 has a spatial arrangement relative to virtual object 1136). In some embodiments, after ceasing display of the immersive MR content 1104a in three-dimensional environment 1102, virtual object 1136 and application container 1140 are redisplayed with the same spatial relationship in three-dimensional environment 1102.

In some embodiments, in the second mode of operation, content 1104b is permitted to be moved in three-dimensional environment 1102 in response to a user input. In FIG. 11D, computer system 101 receives an input corresponding to a request (e.g., by user 1138) to move application container 1140 (e.g., and thus content 1104b displayed within application container 1140) to a new location in three-dimensional environment 1102. As shown in FIG. 11D, the input includes user 1138 directing gaze 1108 toward application container 1140 while concurrently performing an air gesture with hand 1112. For example, the air gesture includes performing a pose with hand 1112 (e.g., an air pinch) while concurrently moving hand 1112 toward a location of three-dimensional environment 1102 (e.g., FIG. 11D shows hand 1112 moving in a rightward direction relative to the viewpoint of user 1138, as represented by arrow 1142).

FIG. 11E illustrates application container 1140 and content 1104b displayed at a new location in three-dimensional environment 1102 in response to the input received by computer system 101 shown in FIG. 11D. In some embodiments, in response to the user input provided by user 1138, application container 1140 is displayed at a new location that is more rightward relative to the viewpoint of user 1138 compared to the previous location of application container 1140 shown in FIG. 11D. In some embodiments, as a result of the movement of application container 1140 and content 1104b in the three-dimensional environment 1102, application container 1140 and virtual object 1136 have a new spatial relationship (e.g., there is less distance and/or area between application container 1140 and virtual object 1136 in three-dimensional environment 1102 compared to as shown in FIG. 11D). In some embodiments, application container 1140 and virtual object 1136 are redisplayed with the new spatial relationship shown in FIG. 11E if computer system 101 redisplays application container 1140 and virtual object 1136 in three-dimensional environment 1102 after ceasing to display application container 1140 and virtual object 1136 in three-dimensional environment 1102 (e.g., due to the display of content (e.g., immersive MR content 1104a) in the first mode of operation).

In FIG. 11E, an input is received by computer system 101 corresponding to a request to display system user interface 1114 in three-dimensional environment 1102. In some embodiments, the input includes one or more characteristics of the input shown and described with reference to FIG. 11B. For example, user 1138 directs their attention (e.g., by gaze 1108) at the same region in three-dimensional environment 1102 (e.g., and optionally for the same duration of time) as described with reference to FIG. 11B.

FIG. 11F illustrates computer system 101 displaying system user interface 1114 in three-dimensional environment 1102 in response to the input provided by user 1138 shown in FIG. 11E. As shown in FIG. 11F, secondary user interface 1126 and selectable option 1128 are not displayed with system user interface 1114 (e.g., as shown in FIG. 11C) because content 1104b is not displayed in the first mode of operation (e.g., and thus it is not necessary to display a selectable option to cease display of content 1104b in the first mode of operation).

As shown in FIG. 11F, computer system 101 changes the visual appearance of application container 1140 (e.g., and thus content 1104b) and virtual object 1136 (e.g., and thus the website content associated with virtual object 1136) when system user interface 1114 is displayed in three-dimensional environment 1102. For example, the visual appearance of application container 1140 and virtual object 1136 reduces in visual prominence when system user interface 1114 is displayed (e.g., including blurring (e.g., by decreasing sharpness), fading (e.g., by decreasing color and/or brightness), increasing transparency and/or decreasing opacity of content 1104b and the website content associated with virtual object 1136). In some embodiments, the visual appearance of content 1104b is changed differently (e.g., by a different amount) compared to the visual appearance of immersive MR content 1104a when system user interface 1114 is displayed in three-dimensional environment 1102. For example, there is a greater change in visual appearance of content 1104b compared to immersive MR content 1104a (e.g., computer system 101 changes more visual characteristics (e.g., sharpness, transparency, opacity, brightness and/or saturation) of the visual appearance of content 1104b compared to immersive MR content 1104a, and/or computer system 101 changes one or more characteristics of the visual appearance of content 1104b by a greater amount compared to immersive MR content 1104a (e.g., computer system 101 decreases the sharpness, brightness and/or opacity of content 1104b by a greater percentage than the sharpness, brightness and/or opacity of immersive MR content 1104a)). In some embodiments, computer system 101 changes the visual appearance of virtual object 1136 in the same manner as application container 1140 (e.g., computer system 101 decreases the sharpness and opacity, and/or increases the transparency of virtual object 1136 by the same amount compared to application container 1140). In some embodiments, computer system 101 maintains the visual appearance (e.g., does not change the visual appearance) of visible passthrough of the physical environment of user 1138 (e.g., wall photo 1124 and table 1110) when system user interface 1114 is displayed in three-dimensional environment 1102.

In some embodiments, a respective application (e.g., “Application A”) is configured to only display content (e.g., immersive MR content 1104a) in the first mode of operation and not the second mode of operation (e.g., or, optionally, the respective application is configured to display content in the second mode of operation but computer system 101 does not permit the display of the content in the second mode of operation in three-dimensional environment 1102). FIG. 11G illustrates an embodiment of the three-dimensional environment 1102 that is displayed by computer system 101 in response to the input corresponding to the request to cease display of immersive MR content 1104a in FIG. 11C. Particularly, in the embodiment shown in FIG. 11G, the respective application is not configured to display content in the second mode of operation. As illustrated in FIG. 11G, an application container (e.g., application container 1140 including content 1104b shown in FIGS. 11D-11F) is not displayed in three-dimensional environment 1102 because the respective application is not configured to display content in the second mode of operation. Table 1110 and wall photo 1124 are displayed through display generation component 120 because immersive content 1104a is no longer displayed in three-dimensional environment 1102 (e.g., and thus no longer visually obscuring table 1110 and wall photo 1124 relative to the viewpoint of user 1138). In some embodiments, table 1110 and wall photo 1124 are represented in three-dimensional environment 1102 in the same manner as prior to computer system 101 displaying immersive MR content 1104a in the first mode of operation (e.g., as described with reference to FIG. 11D). As shown in FIG. 11G, virtual object 1136 is displayed in three-dimensional environment 1102 with the same spatial arrangement in three-dimensional environment 1102 as previously displayed by computer system 101 in FIG. 11A (e.g., as described with reference to FIG. 11D).

FIGS. 12A-12E is a flowchart for illustrating a method 1200 for displaying content of a respective application in a first mode of operation that includes spatially distributing content throughout an available display area of a three-dimensional environment and ceasing display of the content in the first mode of operation in accordance with some embodiments of the disclosure. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, method 1200 is performed at a computer system (e.g., computer system 101) in communication with a display generation component (e.g., display generation component 120) and one or more input devices (e.g., one or more input devices 314). In some embodiments, the computer system has one or more of the characteristics of the computer systems of methods 800 and/or 1000. In some embodiments, the display generation component has one or more of the characteristics of the display generation component of methods 800 and/or 1000. In some embodiments, the one or more input devices have one or more of the characteristics of the one or more input devices of methods 800 and/or 1000.

In some embodiments, while displaying, via the display generation component, content of a first application (e.g., the first application is associated with the immersive MR content 1104a shown in FIG. 11B) in a three-dimensional environment, the computer system detects (1202a), via the one or more input devices, a first input corresponding to a request to display a system user interface for controlling one or more functionalities of the computer system, such as the input (e.g., through gaze 1108) corresponding to the request to display system user interface 1114 shown in FIG. 11B, wherein the system user interface is a user interface of an operating system of the computer system (e.g., not a user interface of the first application). In some embodiments, the three-dimensional environment has one or more characteristics of the environments described with reference to methods 800 and/or 1000. In some embodiments, the content includes one or more of the characteristics of content described with reference to methods 800 and/or 1000. In some embodiments, the content includes respective media (e.g., such as a video from a web browsing application, video streaming service and/or social media, movie and/or TV shows, text, images and/or video game content). In some embodiments, the first application includes one or more characteristics of applications described with reference to methods 800 and/or 1000. In some embodiments, the first application includes a virtual gaming application, a video streaming service application, a web browsing application and/or a social media application. In some embodiments, the system user interface includes a menu that includes one or more selectable elements to control the one or more functionalities of the computer system. In some embodiments, the one or more functionalities include controlling display characteristics (e.g., such as brightness and/or text size), audio volume, and/or connectivity (e.g., device pairing and/or network connection). In some embodiments, the first input includes a user of the computer system directing gaze toward a location in the three-dimensional environment (e.g., at a location above the current viewpoint of the user relative to the three-dimensional environment). The gaze is optionally maintained at the location in the three-dimensional environment for a threshold period of time (e.g., 0.1, 0.5, 1, 2, 5 or 10 seconds). In some embodiments, the first input includes an air gesture provided by a hand of the user (e.g., an air tap, air drag, air pinch or air long pinch). In some embodiments, the first input includes a verbal input provided by the user (e.g., a voice command).

In some embodiments, in response to detecting the first input, the computer system displays (1202b), via the display generation component, the system user interface in the three-dimensional environment (e.g., such as system user interface 1114 displayed in three-dimensional environment 1102 shown in FIG. 11C), including in accordance with a determination that the first application is configured to display content in a first mode of operation (e.g., as described with reference to method 800), wherein the first mode of operation is a mode in which the first application (e.g., the active application) is permitted to display content that is spatially distributed throughout an available display area (e.g., a volume or region that is optionally constrained by a portal or other boundary) of the three-dimensional environment, displaying, in the system user interface, a first selectable option that is selectable to cease display of the content of the first application in the first mode of operation, such as selectable option 1128 displayed with system user interface 1114 shown in FIG. 11C. In some embodiments, displaying the content in the first mode of operation in the three-dimensional environment includes one or more characteristics of presenting content in accordance with the second mode of operation in the three-dimensional environment as described with reference to method 1000. In some embodiments, if the first input is not detected by the computer system, the system user interface is not displayed in the three-dimensional environment. In some embodiments, displaying the content in the first mode of operation corresponds to displaying the content in an exclusive version of the first application (e.g., the exclusive version of the application is not configured to be operated or displayed concurrently with other applications in the three-dimensional environment). In some embodiments, the available display area is a region of the three-dimensional environment that is constrained by a window virtual object and/or a portal (e.g., including one or more characteristics of portals into simulated and/or virtual environments, and/or window virtual objects as described with reference to method 800 and/or 1000). In some embodiments, displaying content in the first mode of operation includes not restricting the content to being displaying in one or more application containers (e.g., permitting the display of content in a virtual container associated with the respective application and at locations in the three-dimensional environment outside of the virtual container associated with the respective application). In some embodiments, spatially distributing the content throughout the available display area includes displaying the content throughout at least a portion of a volume and/or region of the three-dimensional environment that is constrained by a virtual window, container and/or portal (e.g., a virtual portal as described with reference to methods 800 and/or 1000). In some embodiments, the content occupies all of, or a significant portion of (e.g., 30, 50, 50, 55, 60, 65, 70, 75, 80, 85, 90, 95 or 100 percent), the three-dimensional environment relative to a current field of view of a user of the computer system. In some embodiments, displaying content in the first mode of operation does not include always displaying the content throughout the entire available display area. For example, in some embodiments, displaying content during the first mode of operation includes displaying content associated with the first application throughout the entire available display area during certain operation of the first application (e.g., the first application is a video game, and during a first period of time, operation of the video game does not require content to be displayed throughout the entire available display area, and during a second period of time, operation of the video game requires content to be displayed throughout the entire available display area). In some embodiments, displaying the content in the first mode of operation does not include displaying other content not associated with the first application in the available display area. In some embodiments, displaying the content in the first mode of operation does not include displaying other content not associated with the first application outside of the available display area. In some embodiments, selecting the selectable option to cease display of at least some content of the first application includes ceasing to display content displayed throughout the available display area of the three-dimensional environment. In some embodiments, while displaying content in the first mode of operation, the content is able to be repositioned throughout the three-dimensional environment based on inputs directed to the respective application (e.g., the content can be moved and/or scaled relative to the three-dimensional environment), such as described with reference to the second mode of operation in method 1000. In some embodiments, individual elements of the content are not able to be moved and/or scaled relative to each other without interacting with the respective application, such as described with reference to the second mode of operation in method 1000. In some embodiments, the first selectable option is a virtual element included in the system user interface with other selectable options (e.g., one or more selectable elements displayed in the system user interface). In some embodiments, the first selectable option is displayed by the computer system in the system user interface if content of an application different from the first application is displayed in the three-dimensional environment in the first mode of operation (e.g., the (optionally the same) first selectable option is displayed in the system user interface when or whenever the content of an application is displayed in the three-dimensional environment in the first mode of operation, independent of which particular application is displaying the content).

In some embodiments, while displaying the system user interface that includes the first selectable option, the computer system detects (1202c), via the one or more input devices, a second input corresponding to selection of the first selectable option, such as the input to select selectable option 1128 (e.g., through gaze 1108 and an air gesture performed by hand 1112) shown in FIG. 11C. In some embodiments, the second input includes a selection input directed at the first selectable option in the system user interface. For example, the selection input includes the user directing attention toward the first selectable option (e.g., by gazing at the first selectable option for a threshold period of time (e.g., 0.1, 0.5, 1, 2, 5, or 10 seconds)) and/or performing a respective air gesture (e.g., an air tap, air drag, air pinch or air long pinch). For example, the second input includes an air pinch of the thumb and a finger (for example for a threshold period of time), an input on a touch-sensitive display (e.g., a touchpad) of the computer system (e.g., a force-sensitive input (e.g., a click of a touchpad) or a capacitive touch input (e.g., a swipe of a finger on a touch-sensitive display)) and/or a verbal input (e.g., a voice command).

In some embodiments, in response to detecting the second input, the computer systems ceases (1202d) to display the content in the first mode of operation, such as shown by ceasing to display respective content 1104a in the first mode of operation in FIGS. 11D and 11G in response to the input provided by user 1138 in FIG. 11C. In some embodiments, if the second input is not detected by the computer system, the computer system maintains display of the content in the first mode of operation. In some embodiments, ceasing to display the content in the first mode includes displaying the content in a second mode of operation that is different from the first mode of operation (e.g., as described with reference to step(s) 1210). In some embodiments, the second mode of operation includes one or more characteristics of the second mode of operation as described with reference to method 800 and/or 1000. For example, ceasing to display the content in the first mode includes displaying the content within an object associated with the first application (e.g., a virtual window and/or application container) and not displaying the content throughout the available display area. In some embodiments, ceasing to display the content in the first mode of operation includes operating the first application as a non-exclusive application (e.g., the application is capable of being operated and/or displayed concurrently with other applications in the three-dimensional environment). In some embodiments, ceasing to display the content in the first mode of operation includes ceasing to operate the first application and/or displaying a virtual environment not associated with the first application or enabling a passthrough view of the user's physical environment. In some embodiments, if content of an application different from the first application is displayed in the three-dimensional environment in the first mode of operation, ceasing display of the content of the application different from the first application includes one or more characteristics of ceasing display of the content of the first application in the first mode of operation. Ceasing display of content associated with a respective application in a first mode of operation in response to detecting an input corresponding to a selection of a selectable option in a system user interface provides a user discretion in controlling where in the three-dimensional environment the content is displayed (e.g., by limiting the display of content to within a virtual container to enable the user to interact with content in the three-dimensional environment not associated with the respective application), case of interaction with the respective application without requiring a separate user interface object to be displayed in the environment, and a consistent method of ceasing display of content in the first mode of operation across a plurality of applications (e.g., different from the respective application) that are permitted to display content in the first mode of operation, thereby improving user device interaction and limiting unnecessary consumption of computing resources.

In some embodiments, in response to detecting the first input, in accordance with a determination that the first application is not configured to display content in the first mode of operation (e.g., is configured to display content in a second mode of operation, different from the first mode of operation), the computer system forgoes (1204) the display of the first selectable option in the system user interface, such as shown by the display of system user interface 1114 while displaying content 1104b in the second mode of operation in FIG. 11F. In some embodiments, if the first application is not configured to display content in the first mode of operation, the first application is only configured to display content in a second mode of operation different from the first mode of operation (e.g., a second mode of operation as described with reference to step(s) 1210, the first mode of operation described with reference to method 800, and the second mode of operation described with reference to method 1000). In some embodiments, the first application includes one or more selectable options (e.g., displayed within a toolbar element, an application window, and/or other object) that are selectable to cause the computer system to cease display of the content in the three-dimensional environment when displaying content in the second mode of operation (e.g., as described with reference to step(s) 1212). In some embodiments, in accordance with a determination that the first application is not configured to display content in the first mode of operation, the system user interface is displayed in the three-dimensional environment in response to detecting the first input without the first selectable option included in the system user interface. Displaying a selectable option in a three-dimensional environment to cease display of content in a first mode of operation when a respective application associated with the content is configured to display the content in the first mode of operation and not displaying the selectable option when the respective application is not configured to display the content in the first operation ensures that the selectable option is not displayed when displaying the selectable option is not necessary, thereby limiting unnecessary consumption of computing resources.

In some embodiments, displaying the content of the first application in the first mode of operation includes preventing concurrent display of content of other applications in the three-dimensional environment while the first application is displaying content in the first mode of operation (1206), such as shown by the display of immersive MR content 1104a in the first mode of operation in FIG. 11C. In some embodiments, the content from the other application in the three-dimensional environment include one or more characteristics of the content described with reference to step(s) 1202. In some embodiments, the other applications include one or more characteristics of the first application as described with reference to step(s) 1202. In some embodiments, if the content of the first application is not being displayed in the first mode of operation, the content of the other applications can be displayed in the three-dimensional environment concurrently with the content of the first application (e.g., such as described with reference to the second mode of operation in method 1000). In some embodiments, if content of other applications is displayed in the three-dimensional environment prior to displaying the content of the first application in the first mode of operation, the computer system ceases display of the content of the other applications in the three-dimensional environment (e.g., as described with reference to step(s) 1208 and to the second mode of operation in method 1000). Preventing concurrent display of content of other applications in a three-dimensional environment when content of a first application is displaying content in a first mode of operation that includes displaying content that is spatially distributed throughout an available display area of the three-dimensional environment prevents content of other applications from interfering (e.g., through spatial conflicts) with the display of the content of the first application in the three-dimensional environment, thereby improving user device interaction.

In some embodiments, ceasing to display the content in the first mode of operation includes ceasing to display content of the first application (e.g., ceasing to display all content of the first application) in the three-dimensional environment (1208), such as shown by ceasing to display immersive MR content 1104a in FIG. 11G in response to the input provided by user 1138 in FIG. 11C. In some embodiments, ceasing to display all content of the first application in the first mode of operation includes ceasing to display all content of the first application in the available display area of the three-dimensional environment. In some embodiments, ceasing to display the content in the first mode of operation includes displaying one or more portions of a physical environment of the user that are visible as passthrough via a transparent or translucent display of the display generation component (and that were not visible prior to ceasing display of the content in the first mode of operation, because such content was obscuring the one or more portions of the physical environment). In some embodiments, ceasing to display the content in the first mode of operation includes redisplaying one or more virtual objects (e.g., user interfaces of the one or more applications as described with reference to step(s) 1218) that were displayed in the three-dimensional environment prior to displaying the content of the first application in the first mode of operation. In some embodiments, ceasing to display the content in the first mode of operation includes displaying a transition (e.g., an animation) of the content ceasing to be displaying in the three-dimensional environment. For example, the visual prominence of the content gradually changes when ceasing to display the content in the first mode of operation (e.g., the content gradually gains transparency, reduces in brightness and/or reduces in color saturation). Ceasing to display all content of a respective application displayed in a first mode of operation that includes spatially distributing the content throughout an available display area of a three-dimensional environment in response to a user input corresponding to a request to cease display of the content in the first mode of operation enables the user to remove all of the content of the respective application from the available display area and interact with other applications in the available display area that cannot be interacted with when the content of the respective application is displayed in the first mode of operation through minimal inputs, thereby improving user device interaction

In some embodiments, ceasing to display the content in the first mode of operation includes displaying the content of the first application in a second mode of operation, different from the first mode of operation, wherein the second mode of operation is a mode in which the content of the first application is restricted to being displayed in one or more application containers (1210), such as shown by the display of content 1104b in the second mode of operation in FIG. 11D. In some embodiments, the second mode of operation includes one or more characteristics of the first mode of operation as described with reference to method 1000. In some embodiments, displaying the content of the first application in the second mode of operation includes not permitting the display of the content of the first application throughout the available display area of the three-dimensional environment. In some embodiments, the one or more application containers include one or more characteristics of the one or more application containers described with reference to method 1000. In some embodiments, the application containers are spatially distributed throughout the three-dimensional environment based on prior user inputs directed to the application containers (e.g., as described with reference to method 1000). Ceasing to display content of a respective application in a first mode of operation that includes spatially distributing the content throughout an available display area of a three-dimensional environment and displaying the content in a second mode of operation that includes restricting the content to being displayed in one or more application containers in response to detecting a user input provides a user discretion in deciding whether to interact with the content of the respective application exclusively throughout the available display area or non-exclusively in the available display area (e.g., by restricting the content to an application container that can be displayed concurrently with content of other applications within the available display area), and does not require an additional user input to be provided to redisplay the content of the respective application in the three-dimensional environment after ceasing to display the content in the first mode of operation, thereby improving user device interaction.

In some embodiments, displaying the content of the first application in the second mode of operation includes displaying a second selectable option that is selectable to display the content of the first application in the first mode of operation (1212), such as selectable option 1134 included in user interface 1132 in FIGS. 11A and 11A1. In some embodiments, the second selectable option that is selectable to display the content of the first application in the first mode of operation is a virtual element displayed within a menu, toolbar element, application container, virtual window and/or other virtual object. In some embodiments, selecting the second selectable option to display the content of the first application in the first mode of operation requires an input having one or more characteristics of the second input as described with reference to step(s) 1202. In some embodiments, in response to detecting an input corresponding to selection of the second selectable option, the computer system ceases display of the content in the second mode of operation in the three-dimensional environment and displays the content of the first application in the first mode of operation in the three-dimensional environment (e.g., as described with reference to step(s) 1202). In some embodiments, in response to detecting an input corresponding to selection of the second selectable option, the computer system ceases display of content associated with one or more different applications in the three-dimensional environment. For example, the computer system ceases display of one or more application containers including the content associated with the one or more different applications. In some embodiments, if content of an application different from the first application is displayed in the three-dimensional environment in the second mode of operation, displaying the content of the application different from the first application includes displaying the second selectable option (e.g., the second selectable option is displayed whenever content of a respective application that is permitted to display content in the first mode of operation is displayed in the three-dimensional environment in the second mode of operation). Displaying content of a respective application in a second mode of operation with a selectable option to display the content in a first mode of operation different from the second mode of operation after ceasing to display the content in the first mode of operation provides a method to initiate display of the content of the respective application in the first mode of operation from the second mode of operation that is efficient and consistent across a plurality of applications (e.g., different from the respective application) that are permitted to display content in the first mode of operation, thereby improving user device interaction.

In some embodiments, when the first input is detected, the content of the first application is displayed with a first visual appearance (e.g., such as the visual appearance of immersive MR content 1104a shown in FIG. 11B), and while displaying the system user interface, the visual appearance of the content of the first application is changed from the first visual appearance to a second visual appearance, different from the first visual appearance (1214) (e.g., such as the change in visual appearance of immersive MR content 1104a shown from FIG. 11B to FIG. 11C). For example, the content of the first application is displayed with 100 percent opacity and/or sharpness (e.g., or a different amount, such as 70, 75, 80, 85, 90 or 95 percent opacity and/or sharpness) before the system user interface is displayed in the three-dimensional environment, and the content of the first application is displayed with less than 100 percent opacity and/or sharpness (e.g., or less than the different amount of opacity and/or sharpness) after the system user interface is displayed in the three-dimensional environment. In some embodiments, the second visual appearance includes less visual prominence compared to the first visual appearance (e.g., due to one or more of less opacity, less saturation, less sharpness, less color, less brightness and/or more transparency). In some embodiments, changing the visual appearance of the content of the first application from the first visual appearance to the second visual appearance includes displaying a transition of the change in visual appearance of the content of the first application from the first visual appearance to the second visual appearance. For example, if the change from the first visual appearance to the second visual appearance includes a change in opacity, saturation, sharpness, color, brightness and/or transparency, the change in the opacity, saturation, sharpness, color, brightness and/or transparency occurs gradually (e.g., at a consistent pace over a period of time (e.g., 0.1, 0.2, 0.5, 1, 2, 5, or 10 seconds)). Changing the visual appearance of content of a respective application in a three-dimensional environment when a system user interface is displayed in the three-dimensional environment in response to an input corresponding to a request to display the system user interface in the three-dimensional environment provides visual feedback that the system user interface is displayed, thereby reducing errors in interaction and improving user device interaction.

In some embodiments, changing the visual appearance of the content of the first application from the first visual appearance to the second visual appearance includes changing the visual appearance of the content of the first application by a first amount (1216a), such as shown by the change in visual appearance of immersive MR content 1104a shown from FIG. 11B to FIG. 11C. In some embodiments, the first amount includes a difference in prominence of a visual characteristic (e.g., opacity, saturation, sharpness, color, brightness and/or transparency) between the first visual appearance and the second visual appearance. For example, if the change in visual appearance includes a change in the sharpness of the content of the first application, the first amount includes the amount that the content decreases in sharpness from the first visual appearance to the second visual appearance (e.g., the content includes 100 percent sharpness in the first visual appearance, and the content decreases to less than 100 percent sharpness (e.g., 70, 75, 80, 85, 90 or 95 percent sharpness) in the second visual appearance). For example, if the change in visual appearance includes a change in transparency of the content of the first application, the first amount includes the amount that the content increases in transparency from the first visual appearance to the second visual appearance (e.g., the content includes zero percent transparency in the first visual appearance, and the transparency of the content increase2s to more than zero percent transparency (e.g., 30, 40, 50, 60 or 70 percent) in the second visual appearance).

In some embodiments, in response to detecting the second input, the computer system displays (1216b) the content of the first application in a second mode of operation with a third visual appearance, wherein the second mode of operation is a mode in which the content of the first application is restricted to being displayed in one or more application containers, such as shown by display of content 1104b in application container 1140 in FIG. 11D. In some embodiments, the third visual appearance includes one or more characteristics of displaying the content with the first visual appearance (e.g., as described with reference to step(s) 1214). In some embodiments, the second mode of operation includes one or more characteristics of the second mode of operation as described with reference to step(s) 1210. In some embodiments, the third visual appearance includes restricting the display of the content of the first application to one or more application containers displayed in the three-dimensional environment.

In some embodiments, while displaying the content of the first application in the second mode of operation, the computer system detects (1216c) a third input corresponding to a request to display the system user interface, such as the input (e.g., through gaze 1108) corresponding to a request to display system user interface 1114 in three-dimensional environment 1102 shown in FIG. 11E. In some embodiments, the third input corresponding to a request to display the system user interface includes one or more characteristics of the first input corresponding to a request to display the system user interface as described with reference to step 1202.

In some embodiments, in response to receiving the third input, the computer system displays (1216d) the system user interface in the three-dimensional environment, wherein displaying the system user interface includes changing the visual appearance of the content of the first application from the third visual appearance to a fourth visual appearance different from the third visual appearance, and wherein changing the visual appearance of the content of the first application from the third visual appearance to the fourth visual appearance includes changing the visual appearance of the content of the first application by a second amount, greater than the first amount, such as shown by the difference in the change of appearance of content 1104b in FIG. 11E compared to immersive MR content 1104a in FIG. 11C when system user interface 1114 is displayed in three-dimensional environment 1102. In some embodiments, the second amount includes a difference in prominence of a visual characteristic (e.g., opacity, saturation, sharpness, color, brightness and/or transparency) between the first visual appearance and the second visual appearance, such as described with reference to the first amount. In some embodiments, the fourth visual appearance includes one or more characteristics of the second visual appearance (e.g., as described with reference to step(s) 1214). In some embodiments, the fourth visual appearance includes a greater magnitude of a visual effect compared to a visual effect included in the second visual appearance. For example, the second visual appearance includes a decrease in the opacity, brightness, saturation, and/or color of the content, and the fourth visual appearance includes decreasing the opacity, brightness, saturation and/or color of the content by a greater magnitude. For example, the second visual appearance includes decreasing the sharpness of the content (e.g., blurring the content), and the fourth visual appearance includes decreasing the sharpness of the content by a greater magnitude. In some embodiments, the fourth visual appearance includes one or more additional visual effects compared to the second visual appearance (e.g., the second visual appearance includes decreasing the sharpness of the content and the fourth visual appearance includes decreasing the sharpness and decreasing the opacity of the content). In some embodiments, changing the visual appearance of the content of the first application from the third visual appearance to the fourth visual appearance includes one or more characteristics of changing the visual appearance from the first visual appearance to the second visual appearance (e.g., as described with reference to step 1214). In some embodiments, changing the visual appearance of the content of the first application to the fourth visual appearance includes changing the visual appearance of content of other applications. For example, the visual appearance of content of other applications displayed in the three-dimensional environment changes concurrently with the content of the first application in a similar manner (e.g., if the change from the third visual appearance to the fourth visual appearance includes changing the sharpness of the content of the first application by the second amount, the sharpness of the content of the other applications changes by the second amount). Changing the visual appearance of content in a three-dimensional environment when the content is displayed in a second mode of operation, which includes restricting the display of content to one or more application containers, by a greater amount than when the content is displayed in a first mode of operation, which includes permitting the display of the content throughout an available display area of the three-dimensional environment, in response to receiving an input corresponding to a request to display a system user interface in the three-dimensional environment changes the visual appearance of the content by a greater amount only when it is necessary to provide a more prominent visual indication that the system user interface is displayed (e.g., because when the content is displayed in the second mode of operation, a more prominent visual indication is necessary since the content is displayed in a smaller portion of the three-dimensional environment compared to the first mode of operation), thereby conserving the consumption of computing resources.

In some embodiments, prior to displaying the content of the first application in the three-dimensional environment in the first mode of operation, the computer system displays (1218a), in the three-dimensional environment, one or more user interfaces of one or more applications in a second mode of operation, different from the first mode of operation, wherein the second mode of operation is a mode in which the content of the first application is restricted to being displayed in one or more application containers, such as content 1104b displayed in three-dimensional environment 1102 in the second mode of operation concurrently with virtual object 1136 shown in FIGS. 11D-11F. In some embodiments, the one or more user interfaces of the one or more applications are displayed in the one or more application containers. In some embodiments, the user interfaces include one or more views of the content of the one or more applications. In some embodiments, the second mode of operation includes one or more characteristics of the second mode of operation as described with reference to step 1210. In some embodiments, the one or more user interfaces are moved in the three-dimensional environment in response to an input corresponding to a request to move the one or more application containers in the three-dimensional environment (e.g., the input includes directing attention (e.g., gaze) toward an application container of the one or more application containers and performing a hand gesture (e.g., an air pinch and/or air tap while concurrently moving the hand performing the hand gesture toward a location in the three-dimensional environment).

In some embodiments, while displaying the one or more user interfaces of the one or more applications in the second mode of operation, the computer system receives (1218b), via the one or more input devices, a third input corresponding to a request to display the content of the first application in the three-dimensional environment in the first mode of operation, such as the selection of selectable option 1134 shown in FIGS. 11A and 11A1. In some embodiments, the third input includes one or more characteristics of the first input as described with reference to step(s) 1202. In some embodiments, the third input corresponds to a selection of a selectable option that is selectable to display the content of the first application in the first mode of operation (e.g., as described with reference to step(s) 1212). In some embodiments, the request to display the content of the first application in the three-dimensional environment in the first mode of operation does not include an input to display the system user interface in the three-dimensional environment. In some embodiments, the request to display the content of the first application in the three-dimensional environment does include an input to display the system user interface in the three-dimensional environment (e.g., which modifies the visual appearance of the one or more user interfaces and/or content of the first application displayed in the second mode of operation).

In some embodiments in response to receiving the third input (1218c), the computer system displays (1218d) the content of the first application in the three-dimensional environment in the first mode of operation (e.g., such as shown by the display of immersive MR content 1104a in the first mode of operation in FIG. 11B-11C) and ceases (1218c) to display the one or more user interfaces of the one or more applications in the three-dimensional environment (e.g., such as ceasing to display virtual object 1136 (e.g., as shown in FIGS. 11A and 11A1) in FIG. 11B in response to the input shown in FIGS. 11A and 11A1. In some embodiments, ceasing to display the one or more user interfaces of the one or more applications in the three-dimensional environment includes ceasing to display one or more application containers associated with the one or more applications in the three-dimensional environment (e.g., as described with reference to method 1000). In some embodiments, ceasing to display the one or more user interfaces in the three-dimensional environment includes displaying an animation of the one or more user interfaces ceasing to display in the three-dimensional environment. For example, the visual prominence of the one or more user interfaces gradually changes when ceasing to display the one or more user interfaces in the three-dimensional environment (e.g., the one or more user interfaces gradually fades away in the three-dimensional environment).

In some embodiments, in response to receiving the second input, the computer system redisplays (1218f) the one or more user interfaces of the one or more applications in the three-dimensional environment, such as shown by the redisplay of virtual object 1136 in three-dimensional environment 1102 shown in FIG. 11D after ceasing to display immersive MR content 1104a in the first mode of operation in response to the input shown in FIG. 11C. In some embodiments, the one or more user interfaces of the one or more applications are redisplayed concurrently with the content of the first application in the second mode of operation. In some embodiments, the one or more user interfaces are redisplayed at the same location and/or with the same orientations in the three-dimensional environment as they were displayed prior to receiving the third input. Redisplaying one or more user interfaces in a three-dimensional environment after ceasing to display content of a respective application in a mode of operation that does not permit the display of the one or more user interfaces enables the one or more user interfaces that a user previously interacted with to be available to the user upon ceasing to display the content in the mode of operation without requiring a user to provide an additional input to display the one or more user interfaces, thereby improving user device interaction.

In some embodiments, when the third input was received, the one or more user interfaces were displayed with a first spatial arrangement (e.g., relative to each other), and redisplaying the one or more user interfaces in the three-dimensional environment includes redisplaying the one or more user interfaces with the first spatial arrangement (1220) (e.g., relative to each other), such as shown by the display of virtual object 1136 with the same spatial arrangement in FIG. 11D compared to FIGS. 11A and 11A1. In some embodiments, displaying the one or more user interfaces with a first spatial arrangement includes displaying one or more application containers associated with the one or more user interfaces with the first spatial arrangement. In some embodiments, the first spatial arrangement is a spatial arrangement relative to a current viewpoint of a user. For example, a user interface of the one or more user interfaces includes a spatial arrangement relative to a location of the viewpoint of the user relative to the three-dimensional environment. In some embodiments, the first spatial arrangement is a spatial arrangement relative to the content of the first application displayed in the second mode of operation. For example, a user interface of the one or more user interfaces includes a spatial arrangement relative to an application container of the first application in which the content is displayed in. In some embodiments, the spatial arrangement of a user interface of the one or more user interfaces includes a distance, location and/or orientation value relative to the current viewpoint of the user and/or the content of the first application. Redisplaying one or more user interfaces in a three-dimensional environment after ceasing to display content of a respective application in a mode of operation that does not permit the display of the one or more user interfaces with a same spatial arrangement as prior to displaying the content in the mode of operation enables the one or more user interfaces to be redisplayed with a preferred spatial arrangement without requiring the user to provide an additional input to display the one or more user interfaces with the spatial arrangement and maintains consistency of the display of the one or more user interfaces, thereby reducing errors in interaction and improving user device interaction. In some embodiments, the first spatial arrangement includes a spatial arrangement of the one or more user interfaces relative to each other (1222), such as the spatial arrangement of the virtual object 1136 relative to application container 1140 shown in FIG. 11D. In some embodiments, a first user interface of the one or more user interfaces includes a spatial arrangement relative to a second user interface of the one or more user interfaces. In some embodiments, the spatial arrangement includes a distance, position and/or orientation value (e.g., the location of the first user interface includes a distance from a location of the second user interface relative to the three-dimensional environment, or the first user interface includes a position and/or orientation relative to a location of the second user interface in the three-dimensional environment). In some embodiments, the spatial arrangement is a default spatial arrangement established by the computer system (e.g., the one or more user interfaces are displayed with a default spatial arrangement relative to each other upon launching one or more applications associated with the one or more user interfaces). For example, the default spatial arrangement is stored in a memory of the computer system. In some embodiments, the spatial arrangement is determined by a user of the computer system (e.g., through one or more inputs corresponding to requests to move the one or more user interfaces relative to each other as described with reference to step(s) 1218). Redisplaying one or more user interfaces in a three-dimensional environment after ceasing to display content of a respective application in a mode of operation that does not permit the display of the one or more user interfaces with a same spatial arrangement relative to each other as displayed prior the displaying content in the mode of operation enables the one or more user interfaces to be redisplayed with the spatial arrangement relative to each other that is preferred by a user without requiring the user to provide an additional input to display the one or more user interfaces with the spatial arrangement relative to each other and maintains consistency of the display of the one or more user interfaces, thereby reducing errors and interaction and improving user device interaction.

In some embodiments, the first spatial arrangement includes a spatial arrangement of the one or more user interfaces relative to the three-dimensional environment (1224), such as the spatial arrangement of the virtual object 1136 and application container 1140 relative to three-dimensional environment 1102 shown in FIG. 11D. In some embodiments, the spatial arrangement of the one or more user interfaces is relative to one or more virtual elements (e.g., an application container and/or a virtual window) and/or representations of physical elements (e.g., a representation of a physical object in the user's physical environment) in the three-dimensional environment. In some embodiments, the spatial arrangement includes a distance, location, and/or orientation value (e.g., a location of a first user interface of the one or more user interfaces is at a distance relative to a location of a virtual object in the three-dimensional environment, and/or the first user interface includes an angular position relative to the location of the virtual object in the three-dimensional environment). In some embodiments, the spatial arrangement is a default spatial arrangement established by the computer system (e.g., the one or more user interfaces are displayed with a default spatial arrangement relative to the three-dimensional environment upon launching one or more applications associated with the one or more user interfaces). For example, the one or more user interfaces are displayed at locations and/or orientations in the three-dimensional environment relative to a coordinate system (e.g., a three-dimensional coordinate system (e.g., spherical or polar) relative to a reference location in the three-dimensional environment) that is established by the computer system. In some embodiments, the default spatial arrangement is stored in a memory of the computer system. In some embodiments, the spatial arrangement is determined by a user of the computer system (e.g., through an input corresponding to a request to move the one or more user interfaces as described with reference to step(s) 1218). Redisplaying one or more user interfaces in a three-dimensional environment after ceasing to display content of a respective application in a mode of operation that does not permit the display of the one or more user interfaces with a same spatial arrangement relative to the three-dimensional environment as displayed prior the displaying content in the mode of operation enables the one or more user interfaces to be redisplayed with the spatial arrangement relative to the three-dimensional environment that is preferred by a user without requiring the user to provide an additional input to display the one or more user interfaces with the spatial arrangement relative to the three-dimensional environment and maintains consistency of the display of the one or more user interfaces, thereby reducing errors in interaction and improving user device interaction.

It should be understood that the particular order in which the operations in method 1200 have been described is merely exemplary and is not intended to indicate that the described order is the only order in which the operations could be performed. One of ordinary skill in the art would recognize various ways to reorder the operations described herein. In some embodiments, aspects/operations of methods 800, 1000, and/or 1200 may be interchanged, substituted, and/or added between these methods. For example, various MR manipulation techniques, immersive MR display techniques, and/or immersive MR transition techniques of methods 800, 1000, and/or 1200 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a computer system in communication with a display generation component and one or more input devices:
while displaying, via the display generation component, content of a first application in a three-dimensional environment, detecting, via the one or more input devices, a first input corresponding to a request to display a system user interface for controlling one or more functionalities of the computer system, wherein the system user interface is a user interface of an operating system of the computer system;
in response to detecting the first input, displaying, via the display generation component, the system user interface in the three-dimensional environment, including in accordance with a determination that the first application is configured to display content in a first mode of operation, wherein the first mode of operation is a mode in which the first application is permitted to display content that is spatially distributed throughout an available display area of the three-dimensional environment, displaying, in the system user interface, a first selectable option that is selectable to cease display of the content of the first application in the first mode of operation;
while displaying the system user interface that includes the first selectable option, detecting, via the one or more input devices, a second input corresponding to selection of the first selectable option; and
in response to detecting the second input, ceasing to display the content in the first mode of operation.

2. The method of claim 1, further comprising:
in response to detecting the first input, in accordance with a determination that the first application is not configured to display content in the first mode of operation, forgoing the display of the first selectable option in the system user interface.

3. The method of claim 1, wherein displaying the content of the first application in the first mode of operation includes preventing concurrent display of content of other applications in the three-dimensional environment while the first application is displaying content in the first mode of operation.

4. The method of claim 1, wherein ceasing to display the content in the first mode of operation includes ceasing to display content of the first application in the three-dimensional environment.

5. The method of claim 1, wherein ceasing to display the content in the first mode of operation includes displaying the content of the first application in a second mode of operation, different from the first mode of operation, wherein the second mode of operation is a mode in which the content of the first application is restricted to being displayed in one or more application containers.

6. The method of claim 5, wherein displaying the content of the first application in the second mode of operation includes displaying a second selectable option that is selectable to display the content of the first application in the first mode of operation.

7. The method of claim 1, wherein when the first input is detected, the content of the first application is displayed with a first visual appearance, and while displaying the system user interface, a visual appearance of the content of the first application is changed from the first visual appearance to a second visual appearance different from the first visual appearance.

8. The method of claim 7, wherein changing the visual appearance of the content of the first application from the first visual appearance to the second visual appearance includes changing the visual appearance of the content of the first application by a first amount, the method further comprising:
in response to detecting the second input, displaying the content of the first application in a second mode of operation with a third visual appearance, wherein the second mode of operation is a mode in which the content of the first application is restricted to being displayed in one or more application containers;
while displaying the content of the first application in the second mode of operation, detecting a third input corresponding to a request to display the system user interface; and
in response to receiving the third input, displaying the system user interface in the three-dimensional environment, wherein displaying the system user interface includes changing the visual appearance of the content of the first application from the third visual appearance to a fourth visual appearance different from the third visual appearance, and wherein changing the visual appearance of the content of the first application from the third visual appearance to the fourth visual appearance includes changing the visual appearance of the content of the first application by a second amount, greater than the first amount.

9. The method of claim 1, further comprising:
prior to displaying the content of the first application in the three-dimensional environment in the first mode of operation, displaying, in the three-dimensional environment, one or more user interfaces of one or more applications in a second mode of operation, different from the first mode of operation, wherein the second mode of operation is a mode in which the content of the first application is restricted to being displayed in one or more application containers;
while displaying the one or more user interfaces of the one or more applications in the second mode of operation, receiving, via the one or more input devices, a third input corresponding to a request to display the content of the first application in the three-dimensional environment in the first mode of operation;
in response to receiving the third input:
displaying the content of the first application in the three-dimensional environment in the first mode of operation;
ceasing to display the one or more user interfaces of the one or more applications in the three-dimensional environment; and
in response to receiving the second input, redisplaying the one or more user interfaces of the one or more applications in the three-dimensional environment.

10. The method of claim 9, wherein when the third input was received, the one or more user interfaces were displayed with a first spatial arrangement, and redisplaying the one or more user interfaces in the three-dimensional environment includes redisplaying the one or more user interfaces with the first spatial arrangement.

11. The method of claim 10, wherein the first spatial arrangement includes a spatial arrangement of the one or more user interfaces relative to each other.

12. The method of claim 10, wherein the first spatial arrangement includes a spatial arrangement of the one or more user interfaces relative to the three-dimensional environment.

13. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while displaying, via the display generation component, content of a first application in a three-dimensional environment, detecting, via the one or more input devices, a first input corresponding to a request to display a system user interface for controlling one or more functionalities of the computer system, wherein the system user interface is a user interface of an operating system of the computer system;
in response to detecting the first input, displaying, via the display generation component, the system user interface in the three-dimensional environment, including in accordance with a determination that the first application is configured to display content in a first mode of operation, wherein the first mode of operation is a mode in which the first application is permitted to display content that is spatially distributed throughout an available display area of the three-dimensional environment, displaying, in the system user interface, a first selectable option that is selectable to cease display of the content of the first application in the first mode of operation;
while displaying the system user interface that includes the first selectable option, detecting, via the one or more input devices, a second input corresponding to selection of the first selectable option; and
in response to detecting the second input, ceasing to display the content in the first mode of operation.

14. A non-transitory computer readable storage medium storing one or more programs, the one or more programs comprising instructions, which when executed by one or more processors of a computer system that is in communication with a display generation component and one or more input devices, cause the computer system to perform a method comprising:
while displaying, via the display generation component, content of a first application in a three-dimensional environment, detecting, via the one or more input devices, a first input corresponding to a request to display a system user interface for controlling one or more functionalities of the computer system, wherein the system user interface is a user interface of an operating system of the computer system;
in response to detecting the first input, displaying, via the display generation component, the system user interface in the three-dimensional environment, including in accordance with a determination that the first application is configured to display content in a first mode of operation, wherein the first mode of operation is a mode in which the first application is permitted to display content that is spatially distributed throughout an available display area of the three-dimensional environment, displaying, in the system user interface, a first selectable option that is selectable to cease display of the content of the first application in the first mode of operation;
while displaying the system user interface that includes the first selectable option, detecting, via the one or more input devices, a second input corresponding to selection of the first selectable option; and
in response to detecting the second input, ceasing to display the content in the first mode of operation.
